(19) United States
(12) Patent Application Publication
(10) Pub. No.: US 2013/0339091 A1
(43) Pub. Date: Dec. 19, 2013

(54) INTELLIGENT SOCIAL POLLING PLATFORM

(71) Applicant: Anthony W. Humay, Sammamish, WA (US)

(72) Inventor: Anthony W. Humay, Sammamish, WA (US)

(21) Appl. No.: 13/655,978

(22) Filed: Oct. 19, 2012

Related U.S. Application Data
(60) Provisional application No. 61/660,563, filed on Jun. 15, 2012.

(51) Int. Cl. G06Q 30/02

(52) U.S. Cl. CPC G06Q 30/0203
USPC 705/7.32

(57) ABSTRACT

The subject disclosure relates to targeted polling and creating, responding, managing, publishing, socializing, and/or commercializing targeted polls using a variety of media such as mobile applications, the web, and/or other communication media. In one aspect, the disclosed subject matter facilitates allowing mobile users to respond to and/or promulgate polls. As further advantages, embodiments of the disclosed subject matter allow polls to be created, responded to, published, shared, managed, and/or analyzed within a social polling platform. Further non-limiting embodiments are provided that illustrate the advantages and flexibility of the disclosed subject matter.

### CROSS-REFERENCE TO RELATED APPLICATIONS

This application claims priority to U.S. Provisional Patent Application Ser. No. 61/660,563, filed on Jun. 12, 2012, and entitled INTELLIGENT SOCIAL POLLING PLATFORM, the entirety of which is hereby incorporated by reference.

### FIELD OF THE INVENTION

The subject disclosure is directed to software applications and services and, more specifically, relates to social media, polling, and online polling platforms, such as a platform that enables creating or setting, answering, managing, finding, socializing, organizing or analyzing, and monetizing polling data.

### BACKGROUND OF THE INVENTION

Polls and surveys are often conducted using proprietary methods and/or sample group techniques, which can be closely guarded by the organizations whose business relies on the ability to provide such data at a profit. In effect, these polling organizations act as middlemen between a population willing to freely give its time in answering polls and surveys and the consumers of such information. As a result, information and statistics, such as information and statistics output from polls, are distributed, disorganized, and difficult to access.

By way of illustration, in the context of political polling, a polling organization might use nightly robocalls with a sample size of 1,000 for tracking polls, which results can then be re-weighted using the results of monthly 10,000 sample size partisan identification (ID) polls. These results may be reported whole, or in part, with some details of the studies obscured, including sampling or reweighting methods, which results are then reported to the general population without the ability to understand or with important details obscured.

In another example, a daily tracking poll that polls 500 people per day and focuses on polling likely voters can have much better breakdown on partisan ID in the poll sample, and it can poll a total of 15,000 people per month. But when attempting to correlate such polling data to the prior example, consumers of such data can be left with little useful comparisons. In yet another example, a tracking poll that polls registered voters (e.g., versus likely voters) with partisan ID can lead to oversampling demographics with respect to actual voting turnout or with respect to the partisan makeup of a location that the sample does not fairly represent. On the other hand, an organization that only polls 1,000 people per month (e.g., likely voters with partisan ID) can be misleading if it only polls adult, registered voters, without consideration as to whether they are likely voters, what is the subject's geographic location, etc.

Because such information and statistics output from polls are distributed, disorganized, and difficult to access, if not unreliable, it is not unreasonable for political campaigns to spend large amounts of money on costly internal polling. In such polls, in addition to calling people, such internal polls can include personal interviews, can develop a more reliable representation of a demographic, and so on. As a further example, it may not be unusual for an internal poll to use sample sizes of 5,000 so that a political campaign can assure itself that it really understands how the campaign is doing in a municipality.

As this disclosure relates to applications and services, such as mobile applications, e.g., in application ecosystems enabled by smart phones and devices, such as touch screen devices, tablets, etc., it is important to note the shift from conventional communication technologies (e.g., postal mail, fax, analog land-line service telephone, etc.) to more contemporary digital communication technologies that rely on wireless and digital data communication. At the same time, online presence has become an essential part of business and individual life. With the exponential rate of growth in smart phone and other Internet connected devices, more people are living always-connected lives online. Thus, as some demographics age and as others (e.g., typically the youngest demographics) abandon or forsake outmoded communication technologies, polling methods and samples that rely on the outmoded communication technologies may become further unreliable, such as by oversampling older generations, relative to the younger generations.

For entities that wish to take advantage of the information and statistics resulting from polls and surveys related to a topic of interest, there is no convenient approach for these entities to effectively benefit from this information.

As described, traditionally, polling studies are performed by surveying samples of a population or community, which samples are intended to represent different sections of the population or community (e.g., demographics). However, online polls and surveys can either fail to elicit enough online traffic, which can thwart efforts at capturing representative demographics in the sample, or they can be targeted too indiscriminately so as to fail to achieve anything more useful than an outcome of a popularity contest.

As examples, while some efforts at polling and surveying online have been attempted, such attempts typically require a web browser from which a user completes the poll. The polls created by such methods are typically disseminated by email, online fora, or other forwarding methods, which seek to attract respondents to the poll. Whether the poll is responded to depends, in part, on the one forwarding the poll, on the people receiving the solicitation, etc. In other words, there may be no attempt to craft the sample to capture representative demographics. As a result, sampling bias may result from the systematic error deriving from polling a non-random sample of the population. In addition, such polls are often open only for a limited time, which can lead to unreliable conclusions if the results are relied upon out of context (e.g., outside an applicable time-span associated with the poll), and can be available only to a limited group (e.g., poll creator, participants, etc.), which can further limit the usefulness of the resulting poll information and statistics. Accordingly, conventional online polling platforms appear to suffer from a lack of a sufficient user base that would otherwise allow capturing a proper sample size and determination of representative demographics.

While other examples of contemporary communications technologies (e.g., social media) can allow posting of such surveys or poll questions, such facilities are often limited in scope and/or utility. For example, some may lack the ability to capture or target specific demographics, they may include built-in selection bias as a result of being limited to an existing friends or fans network, and/or they may be tied to existing friends or fans network, for which, depending on the sensitive nature of the poll subject matter, may cause some users to be reluctant to participate (e.g., topics such as politics and religion can be sensitive subject matter even between friends, etc.). Furthermore, the data collected by such contemporary communications technologies may not be available other than in a rudimentary form, which can thwart efforts at analysis and synthesis of information useful in a business or political context. Moreover, given the recent high profile security breaches associated with contemporary communications technologies, users may be understandably reluctant to turn over sensitive information to proprietors of such technologies, which information could prove useful in establishing trustworthy demographics from respondents of polls.

In still other attempts at polling and surveying online, polls may be conducted seemingly at random, without consideration for the user taking the poll or particular attributes of the respondent, which data can be invaluable to consumers of polling data. In yet other attempts that may elicit market research as a condition for access to a resource, there is no assurance that poll responses provided are truthful or valid, nor is there any incentive to provide meaningful data. Whether it results from the lack of a community atmosphere, or whether it results from the randomness of the polling, such oversights can lead to further unreliability in collected poll data and can diminish the value of otherwise valuable market research opportunities.

Thus, while the patchwork efforts at online polling or using contemporary communications technologies for polling can provide rudimentary polling facilities, such efforts fail to provide useful polling data and analysis tools, fail to gain significant poll exposure to ensure truly representative and/or random samples, fail to provide a reliable means to target specific demographics, and/or are subject to sampling and non-sampling errors, etc., among other deficiencies. The above-described deficiencies of conventional polling practices are merely intended to provide an overview of some of the problems of conventional systems and methods, and are not intended to be exhaustive. Other problems with conventional systems and corresponding benefits of the various non-limiting embodiments described herein may become further apparent upon review of the following description.

### SUMMARY OF THE INVENTION

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

Thus, in non-limiting embodiments, the disclosed subject matter relates to software and services and, more specifically, relates to software and services facilitating online polling, online surveys, poll data analysis, customer feedback, and so on. In one non-limiting aspect, the disclosed subject matter facilitates an intelligent social polling platform, such as an exemplary ISPP, as described below regarding FIGS. 1, 10, etc., for example. In further non-limiting aspects, an ISPP can provide a social platform that one or more entities (e.g., commercial entities, non-commercial entities, political interest entities, individuals, etc.) can employ, according to various non-limiting implementations described herein, to leverage polling data and statistics (e.g., customer opinion polls, marketing studies, product advertising, product promotion, personal opinion studies, and/or personalized or other polling activities, and so on, etc.) as well as other activities as described herein. As further advantages, exemplary embodiments of the disclosed subject matter can provide various opportunities for the standardization, organization, and/or proliferation of polling data to facilitate incentivizing and/or monetization of polling and poll data.

For instance, to the foregoing and related ends, systems, devices, and methods are disclosed that can facilitate polling according to various aspects of the disclosed subject matter, among other related functions. According to various non-limiting embodiments, the disclosed subject matter can facilitate polling systems that enable creating a targeted poll based in part on an attribute associated with poll targeting (e.g., where such an attribute can be associated with a user or subscriber of an exemplary ISPP and/or determined by the ISPP, etc.). According to further non-limiting implementations, the disclosed subject matter facilitates providing data associated with the targeted poll to a sponsor of the poll based in part on the sponsorship by the sponsor of the poll.

Accordingly, non-limiting embodiments of the disclosed subject matter can provide exemplary methods that facilitate determining whether an attribute of a potential respondent (e.g., such as a user or subscriber of an exemplary ISPP, etc.) is satisfied by querying a data store of potential respondents. In further non-limiting implementations, exemplary methods can facilitate providing an incentive for responding to the targeted poll, based on determining whether an attribute of a potential respondent (e.g., such as a user or subscriber of an exemplary ISPP, etc.) is satisfied. In addition, further exemplary implementations are directed to devices and/or other articles of manufacture that facilitate targeted polling, as further detailed herein.

These and other features of the disclosed subject matter are described in more detail below.

### BRIEF DESCRIPTION OF THE DRAWINGS

The devices, components, systems, and methods of the disclosed subject matter are further described with reference to the accompanying drawings in which:

FIG. 1 depicts a functional block diagram illustrating an exemplary environment suitable for use with aspects of the disclosed subject matter;

FIGS. 2-5 illustrate exemplary block diagrams showing non-limiting aspects of embodiments of the disclosed subject matter;

FIG. 6 depicts an exemplary block diagram showing further aspects of non-limiting embodiments of the disclosed subject matter;

FIGS. 7-9 depict non-limiting block diagrams illustrating still further aspects of exemplary embodiments of the disclosed subject matter;

FIG. 10 depicts a functional block diagram illustrating exemplary non-limiting devices or systems suitable for use with aspects of the disclosed subject matter;

FIG. 11 illustrates an overview of an exemplary computing environment suitable for incorporation of embodiments of the disclosed subject matter;

FIG. 12 depicts an exemplary non-limiting device or system suitable for performing various aspects of the disclosed subject matter;

FIG. 13 illustrates an exemplary non-limiting flow diagram of methods for performing aspects of embodiments of the disclosed subject matter;

FIG. 14 illustrates a further non-limiting flow diagram of methods for performing aspects of embodiments of the disclosed subject matter;

FIG. 15 depicts an exemplary non-limiting flow diagram illustrating various aspects of exemplary methods of the disclosed subject matter;

FIG. 16 illustrates an exemplary non-limiting device or system suitable for performing various aspects of the disclosed subject matter;

FIGS. 17-26 depict various non-limiting examples of an exemplary graphical user interface (GUI) suitable for use with various aspects of the disclosed subject matter.

FIG. 27 is a block diagram representing exemplary non-limiting networked environments in which various embodiments described herein can be implemented;

FIG. 28 is a block diagram representing an exemplary non-limiting computing system or operating environment in which one or more aspects of various embodiments described herein can be implemented;

FIG. 29 illustrates a schematic diagram of an exemplary mobile device (e.g., a mobile handset) that can facilitate various non-limiting aspects of the disclosed subject matter in accordance with the embodiments described herein; and

FIG. 30 is a block diagram representing an exemplary non-limiting computing system or operating environment in which the disclosed subject matter may be implemented.

### DETAILED DESCRIPTION OF ILLUSTRATIVE EMBODIMENTS

### Overview

As described above, conventional online polling practices may provide only rudimentary polling facilities, which efforts fail to provide useful polling and analysis tools, fail to gain significant poll exposure to ensure truly representative and/or random samples, fail to provide a reliable means to target specific demographics, and/or are subject to sampling and non-sampling errors, etc., among other deficiencies. For instance, ad hoc polling efforts tacked onto existing networks of friends and fans may be met with reluctance or antipathy by network participants (e.g., because of sensitive poll topics, because of user-reluctance to be distracted from the primary purpose of his or her visit, such as connecting with friends and family, because of antipathy toward solicitation, which may be viewed similar to unsolicited email, telemarketer calls, online ads, etc., and so on). As a result, contemporary communications technologies typically are not structured to allow users to share, create, and answer studies and surveys in a useful manner and/or in a manner that preserves such information for useful analysis and synthesis for decision makers (e.g., business managers, political campaigns, individuals, etc.). As a result, determining useful polling statistics or a larger public consensus involves significant difficulty, if the task is not outright impossible, due to the lack of data available from such implementations. As noted above, in order to have a successful social polling platform, such as an ISPP as described herein, the platform has to attract a significant number of users to ensure meaningful sample sizes can be assured. Thus, to the foregoing and related ends, systems, devices, and methods are disclosed that can facilitate polling according to various aspects of the disclosed subject matter, among other related functions.

As used herein, the terms, “user,” “subscriber,” “entity,” and so on can refer, depending on context, to one or more entities (e.g., commercial entities, non-commercial entities, political interest entities, individuals, etc.), and/or one or more automated or semi-automated processes or components operating on behalf of the one or more entities, that can employ an intelligent social polling platform (ISPP), according to various non-limiting implementations, as described herein, to create targeted polls, leverage polling data and statistics (e.g., customer opinion polls, marketing studies, product advertising, product promotion, personal opinion studies, and/or personalized or other polling activities, and so on, etc.), and/or other activities as described herein, for example. It should be noted that, depending on context, a “user” of an ISPP need not be a “subscriber” to the ISPP, and likewise, a “subscriber” of the ISPP need not also be a “user” of the ISPP, as further illustrated herein.

In addition, as further used herein, the term, “poll,” can refer to, depending on context, any thing (e.g., an object, data, information, a picture, text, audio, video, and/or data and/or information relating thereto, and so on, whether as a physical object or a digital object, etc.) for which an opinion can be solicited from a user. Additionally, the terms, “parameter,” “attribute,” “information,” “characteristic,” and so on, as used herein in reference to polls, polling, targeted polling, a user, a respondent, a potential respondent, and so on, depending on context, can refer to information regarding any of the aforementioned (e.g., polls, users, respondents, etc.) that can be useful in directing a poll to the aforementioned (e.g., users, potential respondents, etc.), discriminately, for example, based in part on the parameter, attribute, etc.

Thus, the term “targeted poll,” as used herein, can refer to, depending on context, a poll which employs one or more parameter, attribute, etc. to discriminate in the promulgation of the poll among the aforementioned (e.g., users, potential respondents, etc.) based in part on the one or more parameter, attribute, etc. Accordingly, the term, “potential respondent,” as used herein, depending on context, can refer to a user, and/or a device operating on behalf of the user, that can receive a poll (or notification thereof, information related thereto, etc.), regardless of whether the poll is a targeted poll, or otherwise. In addition, the term “sponsor,” as used herein, can refer to, depending on context, an entity that provides support (e.g., monetary or otherwise) for a sponsored activity (e.g., polling, targeted polling, analysis, promotion, and so on, etc.) carried out by another (e.g., a user, an ISPP, a third party, and so on, etc.).

In various non-limiting embodiments of disclosed subject matter, reference is made to activities occurring in real-time or in near real time. It is to be understood that such activities can occur in a variety of contexts, which context can affect the understanding of meaning of real-time or in near real time, and can change (e.g., context can change over time, over space, with addition of additional context, etc.). Thus, reference herein to activities conducted in real-time or in near real time can refer to a process whereby information concerning an object (e.g., one or more users or subscribers, entities, and so on etc.) can be determined at an instant in time and/or compared to a predetermined interval or a reference for the object (e.g., a comparison between an attribute associated with poll targeting concerning time or space and a characteristic associated with a potential respondent concerning time or space, respectively, etc.), such as an within an interval of when data and/or information was last updated, as further described herein. It can be further understood that such a reference and/or interval can be chosen based in part on relevant context, can be subject to a relevant predetermined tolerance (e.g., margin of error), and/or can be an attribute or parameter for the purpose of poll targeting, as further described herein.

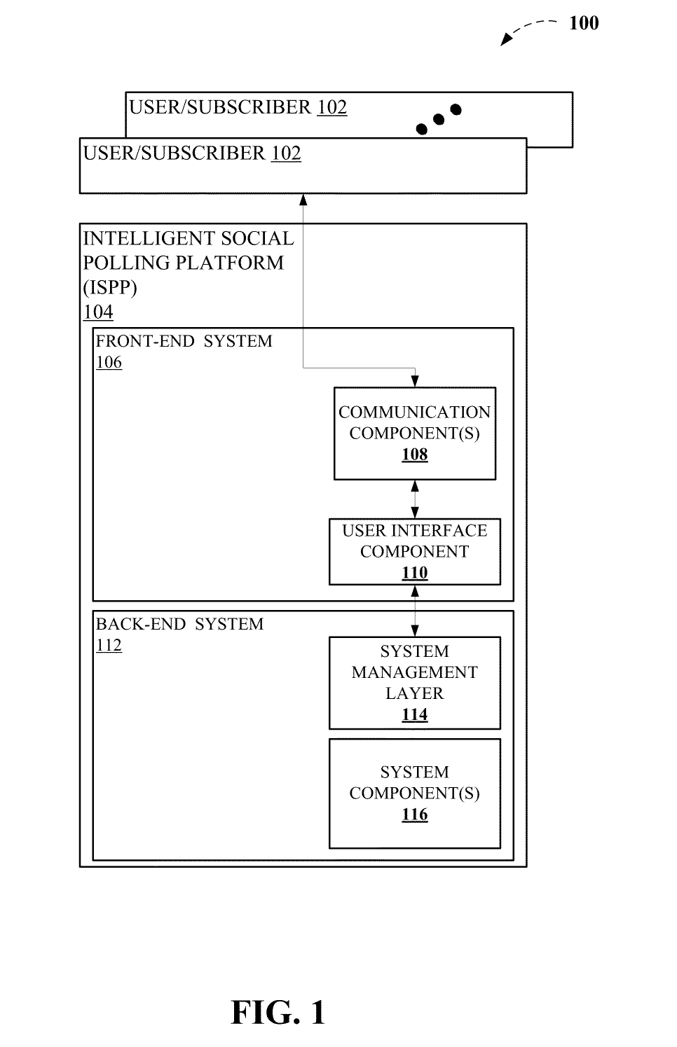

For example, FIG. 1 depicts a functional block diagram illustrating an exemplary environment suitable for use with aspects of the disclosed subject matter. According to various non-limiting embodiments, the disclosed subject matter can facilitate polling systems that enable creating a targeted poll based in part on an attribute associated with poll targeting (e.g., where such an attribute can be associated with a user or subscriber of an exemplary ISPP and/or determined by the ISPP, etc.). According to further non-limiting implementations, the disclosed subject matter facilitates providing data associated with the targeted poll to a sponsor of the poll based in part on the sponsorship by the sponsor of the poll. In addition, non-limiting embodiments of the disclosed subject matter can provide exemplary methods that facilitate determining whether an attribute of a potential respondent (e.g., such as a user or subscriber of an exemplary ISPP, etc.) is satisfied or fulfilled by querying a data store of potential respondents. In further non-limiting implementations, exemplary methods can facilitate providing an incentive for responding to the targeted poll, based in part on determining whether an attribute of a potential respondent (e.g., such as a user or subscriber of an exemplary ISPP, etc.) is satisfied or fulfilled.

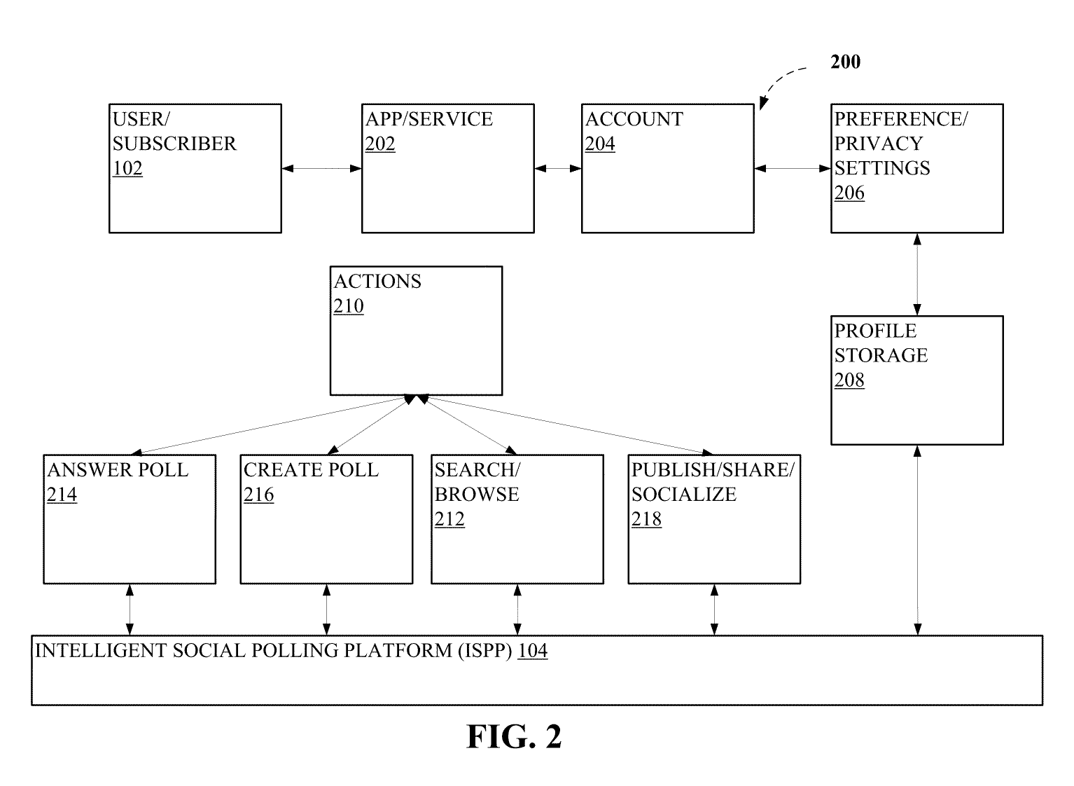

To these and related ends, in non-limiting embodiments of the disclosed subject matter, a user or subscriber 102 can interact with ISPP 104 of FIG. 1, according to various aspects as described herein, via a front-end system 106 that can comprise or be associated with one or more communication components 108 and/or one or more user interface components 110, or portions thereof. For instance, ISPP 104 can facilitate user or subscriber 102 interaction with ISPP 104 via front-end system 106 to enable input of data and/or information into ISPP 104 and receipt of data and/or information from ISPP 104 associated with information processing, handling, and/or transformation occurring within or associated with ISPP 104. As further described herein regarding FIGS. 2-10, for example, user or subscriber 102 interactions with ISPP 104 can be further processed and/or handled via a back-end system 112 that can comprise or be associated with system management layer 114 and/or one or more system components 116.

As described herein, an ISPP 104 according to aspects of the disclosed subject matter can provide an incentive or reward (e.g., for poll completion, submission of information or authenticating credentials that allows identification or verification of a user in a demographic of interest, sharing polls with participants, sharing polls with poll-completing participants, and/or other activities within or associated with ISPP 104, and so on, etc.), which incentive or reward can be provided in various forms, according to non-limiting aspects of the disclosed subject matter. In a non-limiting example, a user of an ISPP 104 in the role of an entity interested in poll results (e.g., one or more of commercial entities, non-commercial entities, political interest entities, individuals, etc.) can offer a good or service, or a coupon, voucher, code, rebate, etc., or other information redeemable therefor, that can be redeemed immediately (or otherwise) over a network such as the Internet, or other network, e.g., such as a free download, and so on.

In yet another non-limiting example, poll participation incentives and/or rewards can be implemented based on a monetary (e.g., currency denominated) system and/or a non-monetary (e.g., non-currency denominated, such as airline miles plans, participating credit card rewards points, etc.) points or rewards system. For instance, non-limiting examples of exemplary points systems can reward a user for answering polls, watching ads, sharing a poll with a predetermined number of other users, sharing a poll with a predetermined number of users, which users subsequently complete the poll, winning a contest based on guidelines and/or objectives related to ISPP 104, identifying and/or sharing insights with poll sponsors and/or other network participants, and so on, etc., as well as other rewards or inventive scenarios. It can be understood that the advantages provided by such monetization and incentivization methods can be vital for an entity, such as a commercial entity, as a means to gather information from their customers or potential customers (or third parties such as stake holders, political campaigns, etc.) about their products (or company standing on environmental issues, political platforms, etc.) and opinions about the entity. As described above, these types of information has heretofore been difficult to gather expeditiously (e.g., in real-time, etc.) and cost-effectively. Moreover, such information is even more difficult to verify (e.g., as to the veracity of responses, demographics information, etc.), analyze, organize, and/or synthesize in a manner useful to decision makers.

As alluded to above, with the increasing use of smart devices (e.g., smart phones, tablet computing devices, etc.) and the consequent demographic shift to an always-connected lifestyle predominantly embraced by the younger demographic, real-time information gathering associated with polling via mobile devices and applications can be a viable and valuable tool. As further described herein, various embodiments can provide a customizable information gathering (e.g., polling) platform (e.g., ISPP 104) that can take advantage of social media concepts, as well as other communication, storage, and analysis techniques that can facilitate various aspects, such as: creating polls; targeting polls to specific population samples, demographics, and/or other predetermined subsets of network participants; socializing polls including, but not limited to sharing polls, sharing results, sharing insights into poll results and analysis (e.g., trends in poll results, identified demographics of interest, etc.), and/or creating personal networks from subsets of the network participants, and so on; conducting personalized polls; intelligent management of poll data, including meaningful but privacy conscious information (e.g., anonymized, etc.) on network participants, poll respondents, etc., temporal and statistical data related to poll results; and/or the ability to analyze poll results based on polling demographics, whether standardized (e.g., location, age, income, sex, partisan ID, registered voter, likely voter, etc.), or otherwise (e.g., customizable, etc.). As can be understood, such data that can be advantageously provided by an ISPP 104 according to aspects of the disclosed subject matter can be valuable to any number of entities (e.g., commercial entities, non-commercial entities, political interest entities, individuals, etc.) for a number of different reasons whether the data is provided to individuals, businesses, intermediaries, and/or other entities (e.g., third parties such as value added transactional entities, promoters, marketing and/or public relations firms, etc.).

Accordingly, various embodiments described in the subject disclosure describe a polling platform (e.g., ISPP 104) that can leverage mobile information gathering (e.g., via mobile devices or otherwise). In further embodiments of an ISPP 104, exemplary implementations can facilitate use of computing resources (e.g., hardware and software) that can be delivered as a service over a network (e.g., the Internet, intranet, mesh network, ad hoc networks, etc.), colloquially referred to as cloud computing, for providing polling data management and that can provide real-time (e.g., periodically as data and/or information associated with ISPP 104 is updated, etc.) or post hoc statistics for entities, as well as or in lieu of local ISPP 104 polling data management.

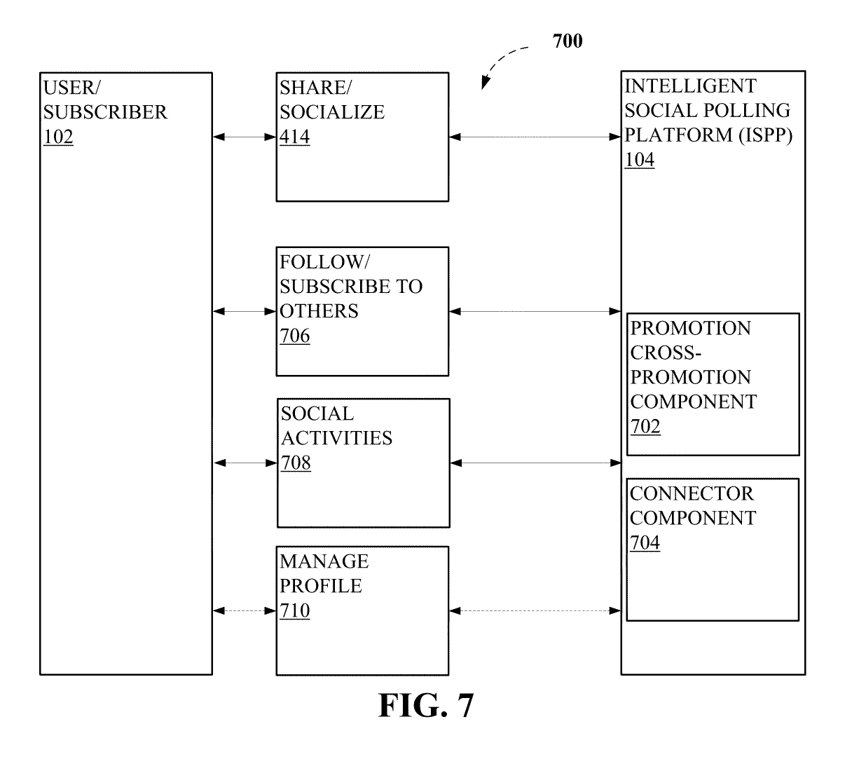

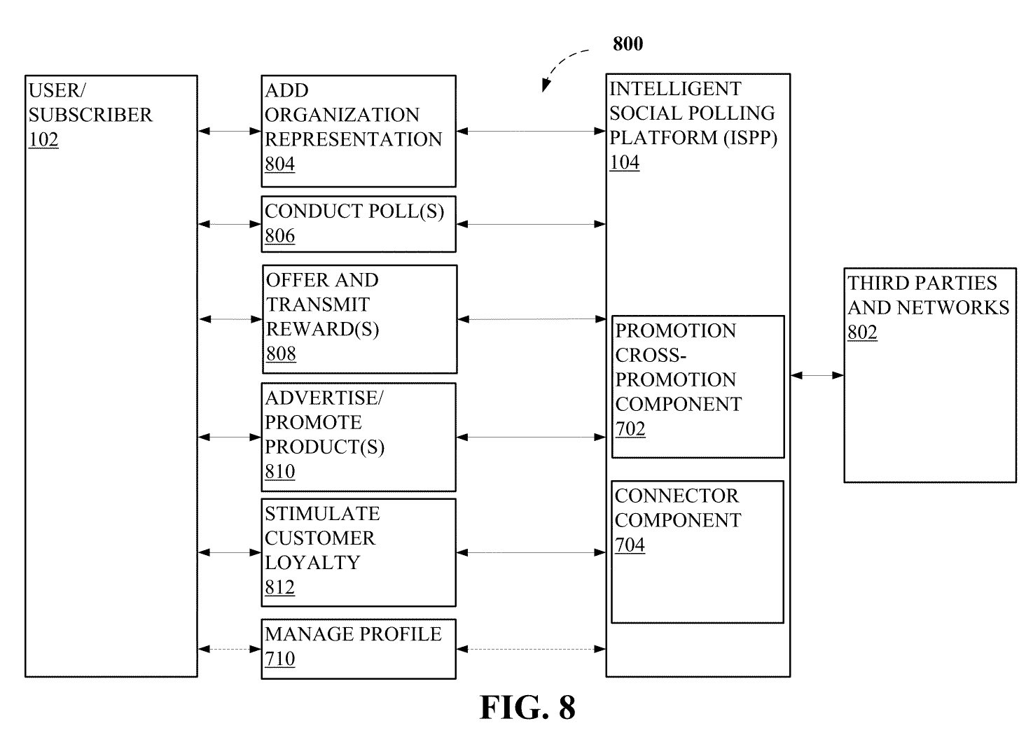

As the process of polling can have inherently social aspects, an ISPP 104, according to further non-limiting aspects, can also provide mechanisms adapted to facilitate entities sharing polling data and/or information, creating cross-marketing campaigns based on ISPP 104 data, and so on, as further described herein regarding FIG. 7, for example. In addition, an exemplary ISPP, according to further non-limiting aspects, can provide as an intermediary, or middleman, between entities of a certain type (e.g., customers, users, subscribers, voters, members of a political party, and so on, etc.), which entities are solicited or desired to give an opinion or poll response and entities of another (e.g., businesses providing a product or service to the customer, providers of the good or service to the user, ISPP 104 third parties, political entity interested in the voters' opinions, political party seeking its members feedback, and so on, etc.) as further described herein, regarding FIG. 8, for example.

FIGS. 2-5 illustrate exemplary block diagrams showing non-limiting aspects of embodiments of the disclosed subject matter. As a non-limiting example, FIG. 2 illustrates a flow diagram of an exemplary interaction 200 of a user or subscriber 102 with an exemplary embodiment of ISPP 104 (e.g., for the purpose of searching for a poll of interest, answering a poll, etc.). For instance, ISPP 104 can facilitate, at 202, user or subscriber 102, or a device on behalf of user or subscriber 102, an appropriately configured application, or app, (e.g., appropriately configured for a specific device, communications service carrier, etc.) registering a user or subscriber 102, or a computer or device on behalf of user or subscriber 102, with ISPP 104, for a service that facilitates interaction with ISPP 104, and the like. Thus, at 204, ISPP 104 can further facilitate account setup for a user or subscriber 102 on the ISPP 104, which account can include or be associated with user preferences, user privacy settings, as well as other user account or profile information (e.g., demographic related information, subscription level information, and so on, etc.) as depicted at 206.

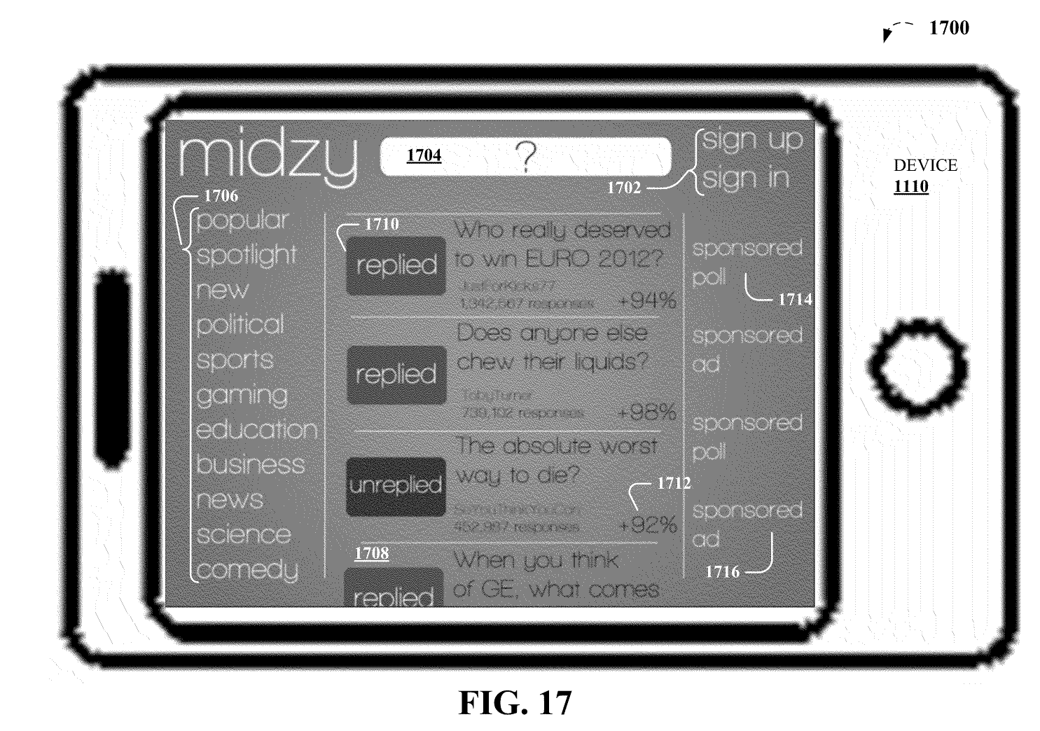

According to further non-limiting implementations, ISPP 104 can also facilitate storage of such account or profile information, at 208, which can be stored and/or made available according to user preferences, user privacy settings, storage and/or privacy policies associated with one or more of ISPP 104 or other third parties, and so on, etc. Once a user or subscriber 102 has installed the app and/or registered for an account or service, ISPP 104 can facilitate presenting one or more actionable options at 210 as described below, regarding FIG. 17, for example. As non-limiting examples, ISPP 104 can facilitate one or more of browsing polls and/or searching for polls at 212 (e.g., for responding to a poll, to see poll results, etc.), answering and/or responding to one or more polls at 214, creating a poll at 216, and/or publishing, sharing, and/or otherwise socializing one or more polls at 218 (e.g., releasing a created poll for responses from one or more users or subscribers 102, inviting friends, followers, customers, and/or affiliates to respond to a poll, or otherwise indicating interest in one or more of polls, poll results, and/or analyses, viewing polls, poll results, analyses, and/or other poll-related information, reviewing personal responses, comments, etc.). As illustrated in FIG. 2, these and other non-limiting examples of actionable options can facilitate communication of relevant data within ISPP 104, or otherwise, as further described below regarding FIGS. 17-26, for example.

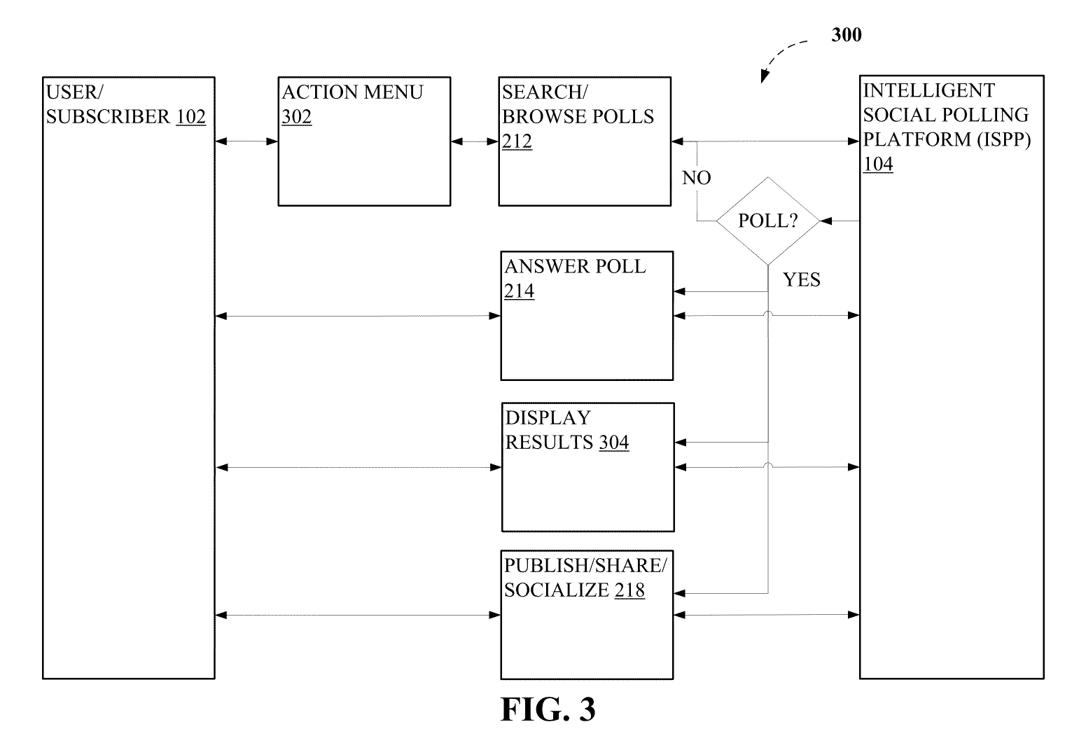

In a further non-limiting example, FIG. 3 illustrates a flow diagram of an exemplary interaction 300 of a user or subscriber 102 with an illustrative embodiment of ISPP 104 (e.g., for the purpose of searching for a poll of interest, answering a poll, publishing results, etc.). For instance, ISPP 104 can facilitate presenting actionable options (e.g., such as via an action menu or list, etc.), at 210, in which options can be presented for one or more of browsing polls and/or searching for polls at 212, answering one or more polls at 214, creating a poll at 216, and/or publishing, sharing, and/or otherwise socializing one or more polls at 218, as described herein, and/or displaying results at 304. For instance, ISPP 104 can be queried for a poll of interest, for which ISPP 104 can respond with search results (e.g., from a database of polls, results, statistics, metadata, etc.) and/or an option to create a poll. As a further non-limiting example, if no results for a poll topic of interest are found, ISPP 104 can present options to repeat and/or modify the search at 212, create a poll, and/or other actions, for example, as further described herein. In another non-limiting example, ISPP 104 can facilitate, for a poll that is found and/or selected by user or subscriber 102, the ability to answer a selected poll 214, display the results of a poll 304, and/or publishing, sharing, and/or otherwise socializing one or more polls at 218, as described above, and as further described below, regarding FIGS. 17-26, for example.

In still further non-limiting implementations, ISPP 104 can facilitate displaying results at 304, which can include, without limitation, the ability to analyze or drill down into the poll results to determine useful statistics, including but not limited to statistics related to or associated with standardized polling demographics information (e.g., location, age, income level, sex, partisan ID, registered voter, likely voter, response date, education level, etc.) and/or other customizable polling demographics information (e.g., length of product or service use, technical ability and/or competence, a referrer and/or how a respondent heard about the poll, etc.). It can be understood that ISPP 104 can advantageously facilitate employing any of a number, type, and/or category of information, data, and/or attributes associated with a poll, ISPP 104, or otherwise, and so on, etc., for analyses of poll results and/or statistics based on attributes of a poll respondent, associated profile information, and/or poll responses, and/or a device or platform (e.g., device type, manufacturer, operating system, browser, versioning information, etc.) associated with the respondent, without limitation, whether such information, data, and/or attributes are provided freely by user or subscriber 102 or a respondent, or in exchange for a reward or other incentive, and/or other information that can be useful in poll results analyses.

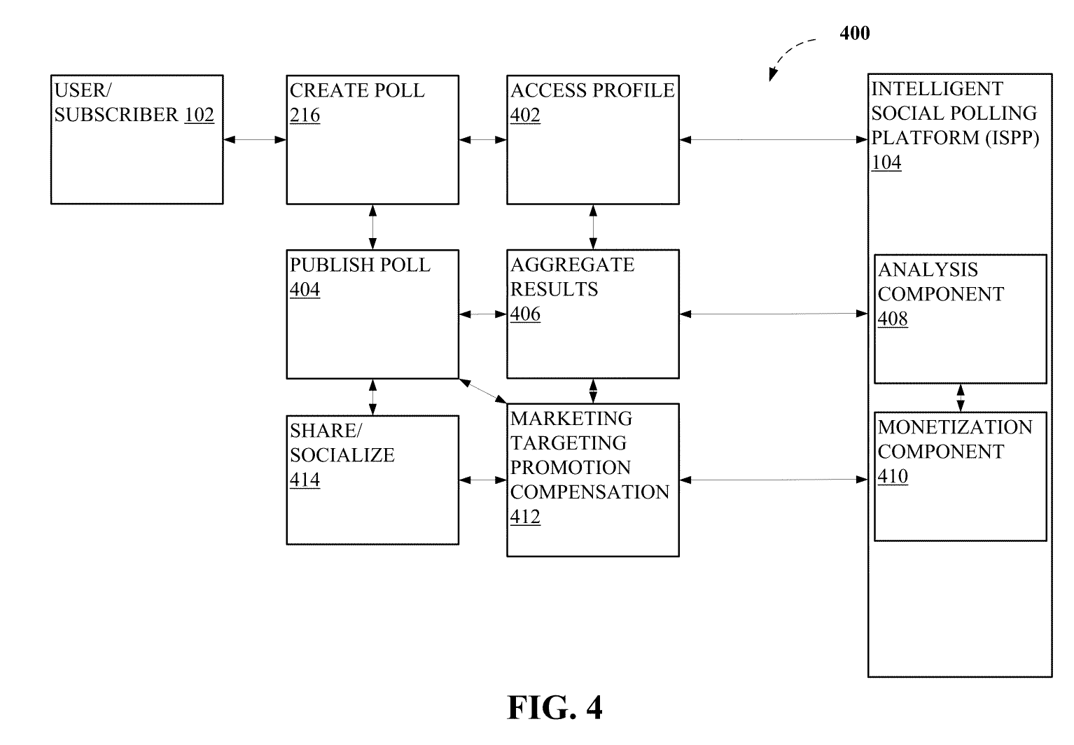

In yet another non-limiting example, FIG. 4 illustrates a flow diagram of an exemplary interaction 400 of a user or subscriber 102 with an illustrative embodiment of ISPP 104 (e.g., for the purpose of employing user profile information to intelligently target poll respondents, marketing, promotion, etc.). For instance, an ISPP 104, according to various non-limiting aspects, can facilitate a user or subscriber 102 creating and/or publishing polls based on any number of poll parameters and/or attributes (e.g., desired attributes of a poll respondent and/or associated profile information or poll responses, such as those of user or subscriber 102, a device or platform (e.g., device type, manufacturer, operating system, browser, versioning information, etc.) associated with the respondent, etc.), which can facilitate targeting a particular subset of users or subscribers 102 or demographic for polling, as described above (e.g., location, age, income level, sex, partisan ID, registered voter, likely voter, response date, education level, common interests, length of product or service use, technical ability and/or competence, a referrer and/or how a respondent heard about the poll, prior and/or other poll responses, device type, device location, device manufacturer, device operating system, browser, software versioning information, installed software, access to a particular network resource, integrity of a response to a signal or data packet, etc.), without limitation.

In still other exemplary implementations, an ISPP 104, according to further non-limiting aspects, can facilitate blocking the use of a subset of user profile information for such targeted polling based in part on one or more of a user's or subscriber's 102 privacy settings, ISPP 104 policies, user agreements, and/or other applicable agreements or regulations, can facilitate notifying a user or subscriber of rewards and/or incentives that may be available based in part on unblocking such uses, on targeted polls, to which the user or subscriber 102 may otherwise be eligible respond based on the unblocking, and so on, etc. As a further non-limiting example, ISPP 104 can facilitate creating a poll at 216, which can include specifying polling parameters and/or attributes, as described herein, which can correspond to user or subscriber profile information, and/or other information associated with user or subscriber 102, etc., and for which ISPP 104 can access a subset of users or subscribers 102 profiles and/or other information relevant to the polling parameters and/or attributes, whether such information is accessible on a real-time basis (e.g., as it is updated, such as via location tracking, etc.) or not, to determine whether a user or subscriber 102 may be a valid respondent.

In addition, by taking advantage of the proliferation of mobile device usage and data available therefrom, users or subscribers 102 (e.g., such as a user or subscriber 102 comprising a business entity), an ISPP 104, according to further non-limiting aspects, can facilitate collection of polling data in real-time or near real-time (e.g., as it is updated or briefly thereafter, such as via location tracking, etc.) based in part on such poll parameters and/or attributes. In one non-limiting aspect, ISPP 104 can facilitate notifying a user or subscriber 102 by “pushing” a notification to the user or subscriber 102. For example, in an instance where real-time polling data is desired, such as in an exemplary case of polling how a product launch was received by an audience, ISPP 104 can facilitate determining whether a user or subscriber 102 meets a polling parameter and/or attribute of being in the audience for the product launch (e.g., by determining whether a device associated with user or subscriber 102 is in the audience, proximate a transceiver, and so on, for example, via device location data, device connectivity to a local network associated with the product launch, a user or subscriber 102 indication of attendance, such as via ISPP 104 or another computing system, such as social media platform, and so on, etc.). As further described herein, by determining in real-time whether a user or subscriber 102 meets a polling parameter, ISPP 104 can facilitate sending notifications of the poll to a subset of users or subscribers 102, for which the polling parameter and/or attribute is valid and/or whose profile is not blocked by applicable privacy settings. As a result, ISPP 104 can facilitate collection of polling data where real-time or near real-time data is an important aspect to the creator of the poll (e.g., an entity user or subscriber 102 such as a business entity, etc.), or for which such real-time or near real-time data classifies a particular user or subscriber 102 as being in a subset of users or subscribers 102 having a particularly unique perception and/or opinion.

In another non-limiting aspect, ISPP 104 can facilitate notifying a user or subscriber 102 by the user or subscriber 102 “pulling” a notification to the user or subscriber 102. For instance, for a poll where data collection in real-time is not necessary and/or is not desired, where an applicable polling parameter and/or attribute is not concerned with real-time data (e.g., such as user or subscriber 102 or device location, etc.), where time is not of the essence, and/or where one or more of a poll questions or a polling parameter and/or attribute demonstrate that “pushing” notifications to users or subscribers 102 would be unnecessary, for example, without limitation, ISPP 104 can facilitate allowing users or subscribers 102 to “pull” notifications from ISPP 104. In a further non-limiting aspect, ISPP 104 can also facilitate allowing a user or subscriber 102 to specify a user preference of one or more of notification type (e.g., “push” notifications, “pull” notifications, a combination thereof, none, and so on, etc.), frequency, target device, account, and so on, etc., without limitation, associated with the user's or subscriber's account with ISPP 104. As a non-limiting example, ISPP 104 can facilitate notifying a user or subscriber 102 of a poll having a polling parameter and/or attribute that is valid for the user or subscriber 102, for example, by listing the poll (e.g., on a home screen, on notification screen, on a popup, on a user interface tray notification, etc.) such as can be presented to user or subscriber 102 via user interface component 110, based in part on the user preference, the poll, the polling parameter, policies associated with ISPP 104, search history, subscription status, and so on.

Thus, in exemplary interaction 400 of a user or subscriber 102 (e.g., such as en entity user or subscriber 102 such as a business entity) with an exemplary embodiment of ISPP 104 (e.g., for the purpose of employing user profile information to intelligently target poll respondents, real-time poll data collection, marketing, promotion, etc.), user or subscriber 102 can create a poll at 216, which, according to a non-limiting aspect, can be based on user profile information, for example, by specifying a polling parameter. That is, once a poll is created, ISPP 104 can facilitate publishing the poll at 404, for which, the poll creator has specified the polling parameter and/or attribute (e.g., one or more attributes that facilitate determining what subset of users or subscribers 102 can search the poll, answer the poll, view poll results, and so on, etc.), as described above. Thus, according to a further non-limiting aspect, ISPP 104 can facilitate determining, based in part on accessing user profiles, privacy settings, etc. at 402, what subset of users or subscribers 102 will receive notifications and/or what type, can access the poll, can access the poll results, and so on, etc., as described above.

In yet another non-limiting implementation, once a poll is published at 404, ISPP 104 can facilitate gathering and/or aggregating results at 406. As mentioned, one or more system components 116 of ISPP 104 can comprise one or more of an analysis component 408 and/or a monetization component 410. For instance, an ISPP 104 comprising an analysis component 408 can facilitate normalizing results (e.g., averaging, extrapolating, interpolating, weighting with other results or data, and so on, etc.) and/or other poll results and/or response based data analysis, interpretation, and/or presentation operations, whether based on statistical analysis, intuitive research, and/or inference based on artificial intelligence, and so on, etc. In addition, an ISPP 104 comprising a monetization component 410 can facilitate various monetization objectives and/or functions of ISPP 104, at 412. As non-limiting examples, ISPP 104 can facilitate various activities, such as: instantiating and/or combining marketing efforts associated with sharing of, publishing of, and/or responding to, polls (e.g., product, service, poll, or other promotion or cross-promotion, disseminating information regarding rewards, coupons, and/or other incentives, providing poll respondent compensation, etc.); promoting use of ISPP 104, its users or subscribers 102, and/or products, services, and/or polls or poll results associated therewith; sharing, publishing, and/or socializing any of the aforementioned (e.g., sharing of polls, poll results, analyses, and so on, following and/or subscribing to users or subscribers 102, polls, poll results, analyses, and so on, garnering followers, users or subscribers 102, as well as other aspects associated with social media, etc.); sharing and/or publishing of content (e.g., polls, results, analyses, etc.) of ISPP 104 to other networks not associated with ISPP 104, whether the networks are affiliated with or unaffiliated with ISPP 104; targeting advertising based in part on user profile information, search history, poll interests, poll responses, recognized trends within ISPP 104; and/or other interactions of user or subscriber 102 with ISPP 104, for example, without limitation.

As a non-limiting example, one or more polls, results, and/or analyses may support an inference that a particular fashion trend is very popular. Non-limiting aspects of ISPP 104 can facilitate trend recognition and/or inference, from which ISPP 104 can further facilitate marketing and/or promoting a popular line of fashion (e.g., via identification of and/or affiliation with third party entities, such as manufacturers, wholesalers, retailers, etc., interested in targeted advertising, poll sponsorship, incentivizing user or subscriber 102 participation in ISPP 104, and/or other marketing opportunities, etc.), based in part on users' or subscribers' 102 privacy settings, ISPP 104 policies, and/or other related agreements between or among any of user or subscriber 102, ISPP 104, or such third parties. In another non-limiting example, ISPP 104 can facilitate offering a coupon for a product associated with the trend, a reward (e.g., points or other incentives, etc.), for responding to the poll that supports the inference of the fashion trend. It can be understood, that the flexibility associated with ISPP 104 can facilitate many variations of combining polls and polling results with marketing or other activities within ISPP 104.

For instance, while polling results can be associated with real-time or near real-time data generation, collection, and/or aggregation, marketing efforts such as targeted advertising can be employed concurrently and/or after a subsequent delay from when the respondent provided the polling results. In another non-limiting example, a brand-loyal user or subscriber 102 can leverage capabilities of ISPP 104 to generate polls, poll results, and/or analyses that are particularly useful to the owner of the brand. In such an instance, the brand owner could choose to retroactively award the user or subscriber 102 that generated polls, poll results, and/or analyses with a reward as compensation for the market research. In yet another non-limiting example as described above, entities as users or subscribers 102 (e.g., commercial entities, non-commercial entities, political interest entities, individuals, etc.) can offer a reward as an incentive for other users or subscribers 102 to complete a poll.

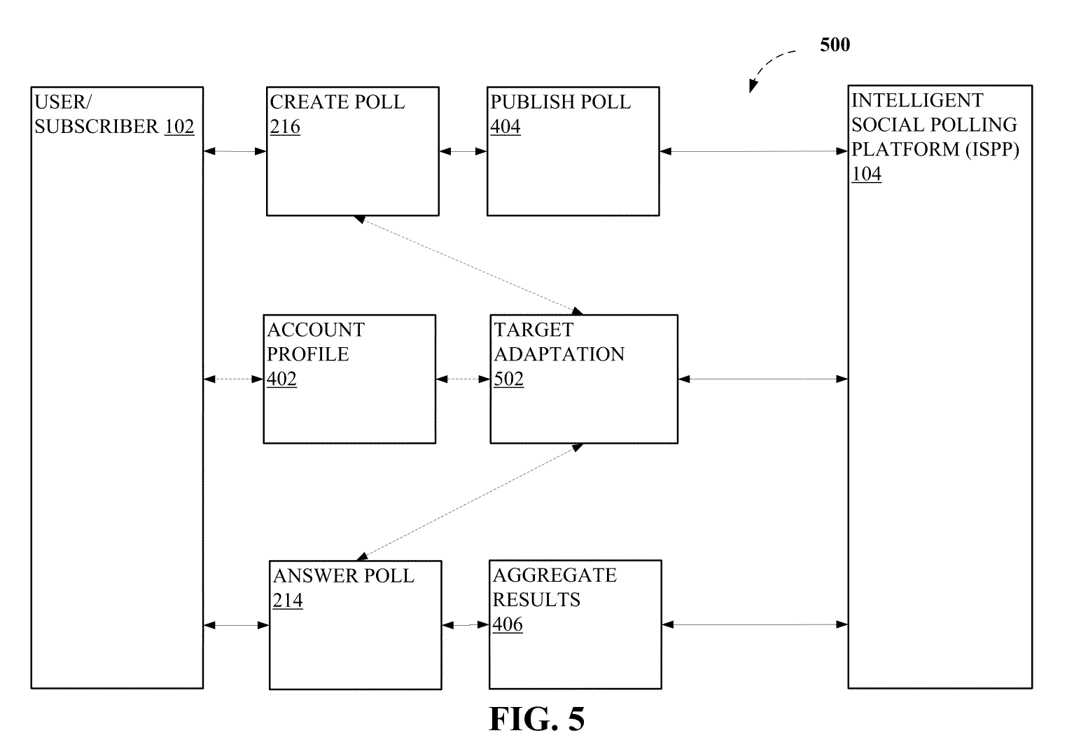

In yet another non-limiting example, FIG. 5 illustrates a flow diagram of an exemplary interaction 500 of a user or subscriber 102 with an exemplary embodiment of ISPP 104 (e.g., for the purpose of intelligently polling users or subscribers 102 based on user profiles, etc.). As described above, a non-limiting aspect of ISPP 104 can facilitate intelligent poll creation. As depicted in FIG. 5, a user or subscriber 102 (e.g., commercial entities, non-commercial entities, political interest entities, individuals, etc.) can create a poll at 216. In various embodiments, ISPP 104 can facilitate target adaptation at 502 in the process of poll creation, and/or thereafter. For instance, one or more system components 116 of ISPP 104 can facilitate employing one or more of related or similar polling data from ISPP 104, user or subscriber 102 profile data or preference data at 402, and so on to create a targeted poll. As a non-limiting example, for a user or subscriber 102 associated with a technology company that manufactures certain products in a particular product space, ISPP 104 can facilitate employing related or similar polling data and/or information associated with ISPP 104 (e.g., questions that are from similar types of polls or questions, associated with similar products, and so on, etc.) in the process of poll creation, to simplify the poll creation process. Likewise, user or subscriber 102 can also simply modify the related or similar polling data and/or information associated with ISPP 104 to meet the user's or subscriber's 102 current poll requirements. In a further non-limiting aspect, ISPP 104 can also facilitate rendering such targeted polling (e.g., automatically or otherwise) into results for a search query for a product or products associated with the targeted poll, notifying users or subscribers 102 that can be inferred would be familiar with such products (e.g., as inferred by reference to profile data, etc.) of the poll, notifying users or subscribers 102 based on other inferences that identify other users or subscribers 102 as belonging to the targeted group of users or subscribers 102, and so on, etc.

In yet another non-limiting aspect of exemplary implementations, ISPP 104 can facilitate determining whether users or subscribers 102 meet a particular attribute prior to being allowed to answer a poll at 214. As a non-limiting example, ISPP 104 can facilitate setting for polls that certain attributes must be true (e.g., true or within a predetermined tolerance, etc.) in order for a user or subscriber 102 to complete the polls. In a further non-limiting example of using a user's or subscriber's 102 age as an attribute, for a user or subscriber 102 over age, 55, at a particular date, the user or subscriber 102 attribute, valid age, would be true for a poll concerning how the Cuban Missile Crisis affected the user or subscriber 102. For still further non-limiting aspects, ISPP 104 can also facilitate employing such attributes to generate search results to return, to users or subscribers 102, targeted polls that interest users or subscribers 102 or that those fit users' or subscribers' 102 preferences. Further non-limiting implementations of ISPP 104 can also facilitate employing other parameters and/or attributes that can be available to ISPP 104 (e.g., time, location, etc.) to customize the creation and answering a poll, in addition to employing users' or subscribers' 102 profile, preferences, etc., as described above.

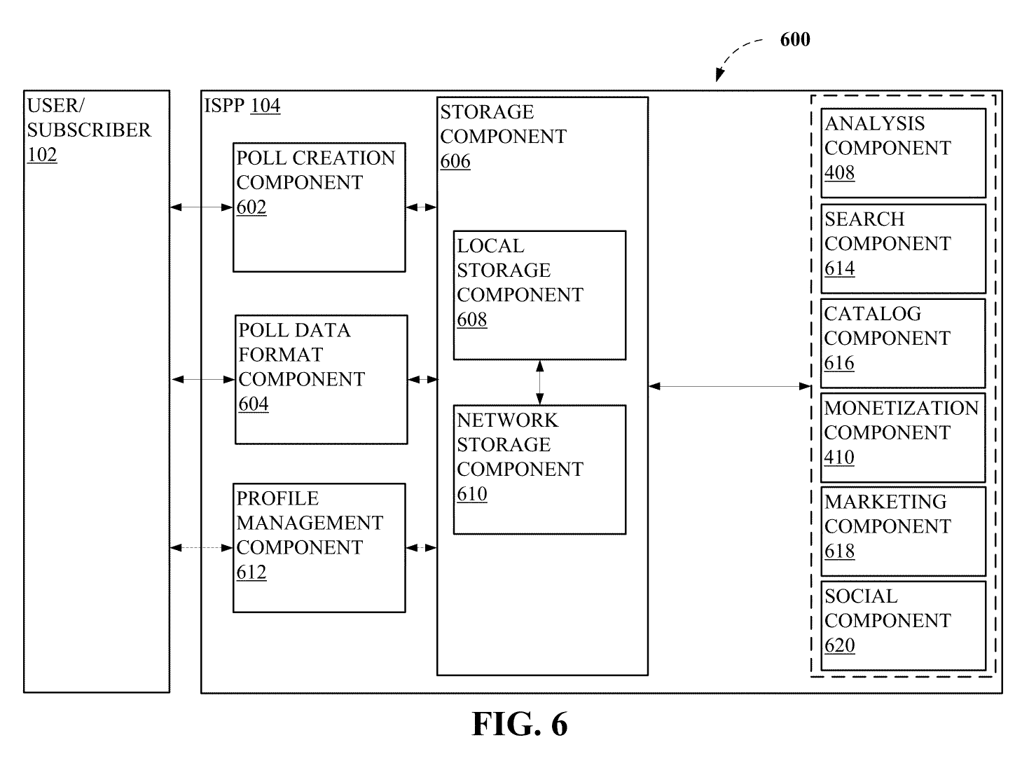

Thus, FIG. 6 depicts a functional block diagram illustrating an exemplary polling platform as a social platform for polling and other studies. For instance, the non-limiting example in FIG. 6 illustrates various components that the one or more system components 116 can comprise for an exemplary interaction 600 of a user or subscriber 102 with an exemplary embodiment of ISPP 104 (e.g., for poll creation, storing and organizing polling data, profile management, search, and so on, etc.). As non-limiting examples, an exemplary implementation of ISPP 104 can comprise one or more of a poll creation component 602, poll data format component 604, storage component 606 (e.g., which can comprise one or more of local storage component 608, network storage component 610, and so on, etc.), profile management component 612, search component 614, catalog component 616, marketing component 618, social component 620, and/or one or more of analysis component 408, monetization component 410, and so on, etc., as previously described, or as further described herein.

For instance, an exemplary poll creation component 602 can facilitate one or more of poll creation, such as targeting of polls or poll questions (e.g., creation of one or more targeted polls, etc.), identification of relevant attributes suitable for targeted polling, designing useful poll studies based in part on proposed theories or research goals (e.g., identifying target demographics, determining sample sizes, determining confidence intervals, and so on, etc.), employing best known methods and practices in the crafting polls and poll questions, and so on, etc., or as further described herein. An exemplary poll data format component 604 can facilitate receiving and/or adapting poll data received from various sources (e.g., users or subscribers 102 associated with various nationalities, languages, devices, technologies or media, such as web, mobile, phone, etc., browsers, apps, Internet protocol (IP) addresses, geographical locations, and so on, etc.) into a common data format. In further non-limiting aspects, data associated with ISPP 104 (e.g., polls, poll questions, accounts, profiles, preferences, responses, affiliations, and so on, etc.) can be stored in storage component 606.

In non-limiting examples of storage component 606, ISPP 104 can facilitate employing local storage component 608 (e.g., local to ISPP 104), and/or networks storage component 610 (e.g., storage remote from one or more other components of ISPP 104), or various combinations thereof, that may be suitable to particular implementations of ISPP 104. For instance, as described above, in further embodiments of an ISPP 104, exemplary implementations can facilitate use of computing resources (e.g., hardware and software) that can be delivered as a service over a network (e.g., the Internet, intranet, mesh network, ad hoc networks, etc.), colloquially referred to as cloud computing, for providing services (e.g., storage, polling data management, etc.), as well as, or in lieu of, local ISPP 104 components (e.g., local storage component 608, etc.). That is, from the perspective of a user or subscriber 102, it may be transparent whether ISPP 104 data storage (and/or other services) employ local storage component 608 (e.g., local to ISPP 104), and/or networks storage component 610 (e.g., storage remote from one or more other components of ISPP 104). However, it can be understood that ISPP 104 can also employ, from the perspective of ISPP 104, cloud computing or software as a service for various operations related to ISPP 104 (e.g., for data storage, data analyses, marketing, search, publication, and so on, etc.), in further non-limiting aspects. For instance, storage component 606 can be employed by an exemplary ISPP 104 for storage and/or retrieval for one or more of statistical analysis, cataloging of polls, responses, analyses, etc., search indices, profiles, and so on, etc.

In other non-limiting implementations of ISPP 104, ISPP 104 can employ a profile management component 612 that can facilitate various operations associated with one or more of profile creation, modification, administration, poll targeting, analyses, marketing, monetization, publishing and/or socializing of one or more of polls, responses, results, and/or analyses, and so on, etc. As a non-limiting example, a user profile can be generated via profile management component 612 for a user or subscriber 102 and can be stored via storage component 606 for subsequent analysis and other interactions with ISPP 104, as described herein.

As previously described, various non-limiting implementations of ISPP 104 can comprise ISPP 104 one or more of an analysis component 408 and a monetization component 410, as depicted in FIG. 6. In addition, further non-limiting implementations of ISPP 104 can also comprise one or more of search component 614, catalog component 616, marketing component 618, and/or, social component 620, and so on, etc. For example, while exemplary implementations of ISPP 104 comprising one or more of an analysis component 408 and a monetization component 410 have been described above, with regard to FIG. 4, for example, marketing component 618, according to further non-limiting aspects can facilitate instantiating and/or combining marketing efforts associated with publishing of, and/or responding to, polls (e.g., product, service, poll, or other promotion or cross-promotion, disseminating information regarding rewards, coupons, and/or other incentives, providing poll respondent compensation, etc.), promoting use of ISPP 104, its users or subscribers 102, and/or products, services, and/or polls or poll results associated therewith, sharing or socializing any of the aforementioned at 414 (e.g., sharing of polls, poll results, analyses, and so on, following and/or subscribing to users or subscribers 102, polls, poll results, analyses, and so on, garnering followers, users or subscribers 102, as well as other aspects associated with social media, etc.), publishing of content (e.g., polls, results, analyses, etc.) of ISPP 104 to other networks not associated with ISPP 104, whether the networks are affiliated with or unaffiliated with ISPP 104, targeting advertising based in part on user profile information, search history, poll interests, poll responses, recognized trends within ISPP 104, and/or other interactions of user or subscriber 102 with ISPP 104, or otherwise, for example, as well as other marketing activities (e.g., advertisement placement, poll promotion, and so on, etc.), without limitation, either in lieu of, or complementary to, functions associated with monetization component 410.

In other non-limiting implementations of ISPP 104, ISPP 104 can employ one or more of search component 614 and/or catalog component 616. As a non-limiting example, an exemplary implementation of ISPP 104 comprising a search component 614 can facilitate one or more of receiving search queries from user or subscriber 102, querying one or more search indices (e.g., search indices associated with ISPP 104, search indices associated with other entities, such as third party entities and/or networks, etc.), returning search results to user or subscriber 102, and so on, etc. It should be understood that, in the context of various non-limiting implementations of ISPP 104, search results as used herein can comprise any of a number of data types including, but not limited to polls, poll results, responses, users or subscribers 102, demographics, analyses, third party content associated with content related to ISPP 104, whether native to ISPP 104, or otherwise, and whether or not such data is of a textual nature, or otherwise (e.g., graphical, audio, video, and so on, etc.).

In still other non-limiting implementations of ISPP 104, catalog component 616 can facilitate one or more of aggregating, organizing, presenting, archiving, searching, retrieving, any of the data and/or information types or categories as described herein, and so on, etc., as well as other data of interest or related to functions associated with ISPP 104 (e.g., uniform resource identifiers or local copies of other data, etc.), without limitation. For instance, as further described herein, an exemplary implementation of ISPP 104 can employ catalog component 616 to facilitate employing data associated with, or related to functions associated with ISPP 104, within polls, analyses, presentations, and so on, for example, in conjunction with other applications or services, whether affiliated with ISPP 104, or otherwise, to provide dynamic hybrid web applications involving ISPP 104 and one or more other applications or services.

For instance, hybrid web applications or “mashups” can use and/or combine data and/or functionality from two or more sources to create compound applications or services, for which each of the sources typically provide simple and fast integration of data and/or functionality by employing published application programming interfaces (API) and an open data source. As such, hybrid web applications can produce enriched results and presentations beyond that which were originally contemplated by the developers of the data source and/or functionalities. To that end, further non-limiting implementations of ISPP 104 can comprise one or more APIs that can expose data and/or functionality associated with the one or more system components 116 (e.g., one or more of analysis component 408, monetization component 410, component 602, poll data format component 604, storage component 606, profile management component 612, search component 614, catalog component 616, marketing component 618, social component 620, and so on, etc., as well as other components and/or functionality as further described herein, etc.).

In yet other non-limiting implementations of ISPP 104, social component 620 can facilitate various operations with respect to the social aspects of ISPP 104. As non-limiting examples, social component 620 can facilitate sharing and/or socializing polls including, but not limited to, sharing and/or publishing polls, sharing and/or publishing results, sharing and/or publishing responses, sharing and/or publishing insights into poll results and/or analyses (e.g., trends in poll results, identified demographics of interest, etc.), creating personal social networks from subsets of the network participants (e.g., users or subscribers 102), and/or conducting personalized polls, and so on, etc.

For example, FIGS. 7-9 depict exemplary block diagrams illustrating further aspects of non-limiting embodiments of the disclosed subject matter. As a non-limiting example, FIG. 7 illustrates a flow diagram of an exemplary interaction 700 of a user or subscriber 102 with an illustrative embodiment of ISPP 104 (e.g., for the purpose of socializing polling activities, promoting ISPP 104 or other entities, etc.). FIG. 7 demonstrates an example of how ISPP 104 can be employed to enhance any user or subscriber 102 (e.g., one or more entities, such as commercial entities, non-commercial entities, political interest entities, individuals, etc.) online presence. For instance, in further non-limiting examples, FIG. 7 illustrates how user or subscriber 102 can leverage ISPP 104 non-limiting aspects directed to social media, which can facilitate representing a user's or subscriber's 102 brand, product, service, idea, reputation, ideological platform, cause, and so on, etc., promote the aforementioned or other conceivable thing, and/or offer incentives or other rewards for other users or subscribers 102 (e.g., customers, potential customers, fans, potential fans, constituents, followers, advocates, critics, detractors partners, affiliates, and so on, etc.).

It can be appreciated that, because polling can be an inherently a social activity, in one aspect of various non-limiting embodiments, ISPP 104 can be directed to a social media platform (e.g., can be a social media platform, can be associated with a social media platform, etc.). That is, when a user or subscriber 102 establishes an account, ISPP 104 can facilitate linking the account associated with user or subscriber 102 to one or more other social media accounts, according to a non-limiting aspect. As such, ISPP 104, in another non-limiting aspect, can facilitate providing updates to the one or more other social media accounts, based in part on activities associated with ISPP 104 (e.g., what polls user or subscriber 102 have answered or created, polls or other data “liked” or “disliked,” analyses performed, results viewed, polls shared or socialized, and so on, etc.), either in lieu of allowing such updates within ISPP 104 (e.g., on user's or subscriber's 102 home page) or in addition to providing updates to the one or more other social media accounts, or a combination thereof.

For instance, referring to FIG. 7, a user or subscriber 102 can share or socialize various data associated with ISPP 104 (e.g., polls, results, responses, analyses, reward programs, incentives, etc.) at 414, either within ISPP 104 (e.g., on user's or subscriber's 102 home page) or in addition to sharing to the one or more other social media accounts, or a combination thereof, as previously described. Thus, one non-limiting aspect of ISPP 104, as a social media platform, can facilitate users or subscribers 102 sharing polls, polling results, and so on, etc., at 414, as previously described. In other non-limiting aspects of ISPP 104 can provide users or subscribers 102 the ability to “follow” or subscribe to other users or subscribers 102 at 706, for which ISPP 104 can facilitate providing updates of the followed users or subscribers 102 activities based on one or more of users or subscribers 102 account profiles, preferences, ISPP 104 policies, and so on, etc. In still other non-limiting implementations of ISPP 104, at 708, ISPP 104 can enable users or subscribers 102 to participate in one or more other social activities, (e.g., voting to “like” or “dislike” data and/or information associated with ISPP 104, such as a poll, an analysis, etc., which can serve to promote quality polling questions, voting to “like” or “dislike” data, services, products, and so on, etc., not associated with ISPP 104, conducting games, contests, pools, or other social activities which can serve to promote ISPP 104 participation, community, and/or quality of membership, and/or cross-promote other third party data, services, products, networks, and so on etc.). In yet other non-limiting implementations of ISPP 104, at 710, ISPP 104 can enable user or subscriber 102 management of such social activities, for example, such as by specifying such preferences that can be manage in the profiles associated with users or subscribers 102.

Accordingly, various non-limiting implementations of ISPP 104 can comprise one or more of promotion or cross-promotion component 702 and/or connector component 704, or portions thereof. For instance, one or more of promotion or cross-promotion component 702 and/or connector component 704 can enable a user or subscriber 102 to publish, share and/or socialize various data associated with ISPP 104 (e.g., polls, results, responses, analyses, reward programs, incentives, etc.) at 414, either within ISPP 104 (e.g., on user's or subscriber's 102 home page) in addition to publishing, sharing and/or socializing to one or more other social media accounts, or a combination thereof, as previously described. In a further non-limiting example, a connector component 704 can facilitate linking (e.g., sharing, communicating, transmitting, and/or receiving various data, such as friends, followers, polls, responses, analyses, and/or other activities within either ISPP 104 or social media networks, and so on, whether unilaterally, bilaterally, or otherwise, etc.) ISPP 104 with other computing systems such as, social medial networks, for example. In another non-limiting example, promotion or cross-promotion component 702 can facilitate instantiating and/or combining marketing efforts associated with publishing of, and/or responding to, polls (e.g., product, service, poll, or other promotion or cross-promotion, disseminating information regarding rewards, coupons, and/or other incentives, providing poll respondent compensation, etc.), promoting use of ISPP 104, its users or subscribers 102, and/or products, services, and/or polls or poll results associated therewith, promotion of other networks, data, products, or services, whether related to social media or otherwise, and so on, via connector component 704, for example, or otherwise (e.g., whether via ISPP 104 functionality or otherwise, etc.).

In a further non-limiting example, FIG. 8 illustrates a flow diagram of an exemplary interaction 800 of a user or subscriber 102 with an exemplary embodiment of ISPP 104 (e.g., for the purpose of stimulating or incentivizing activities within ISPP 104, and cross-promotion, marketing, etc.). For instance, in further non-limiting examples, FIG. 8 illustrates how user or subscriber 102 can leverage ISPP 104 non-limiting aspects directed to business and/or promotion, and so on. ISPP 104, according to non-limiting aspects, can comprise one or more of promotion or cross-promotion component 702 and/or connector component 704, which can facilitate connecting to one or more third parties and/or networks 802 (e.g., for the purpose of transmission and/or sharing of data associated with one or more goals of ISPP 104 and/or third parties and/or networks 802, etc.), as described above. In other examples, such data can be shared and/or transmitted to promote one or more business objectives associated with ISPP 104, third parties and/or networks 802, and so on. For instance, sharing and/or transmitting data and/or information associated with ISPP 104 with one or more third parties and/or networks 802 (e.g., a business entity, social media company, etc.) can facilitate combining information from ISPP 104 and one or more other sources to provide enhanced data sources, analytical capabilities, improved insights, and so on, which, in turn, can enable third parties and/or networks 802 to enhance their online presence.

In a non-limiting example, a company that is seeking to promote its products or services, to conduct market research, to elicit community feedback, or otherwise, can add itself as a user or subscriber 102 to ISPP 104, at 804, to conduct polling activities at 806. As described herein, such polling activities (e.g., including targeted polling and/or incentivized polling at 808, such as offering and transmitting rewards at 808, etc.) can be combined with targeted advertising and/or product promotion at 810, stimulating brand and/or customer loyalty at 812, real-time polling at a product launch, for example, sales promotions, etc.

As described above, ISPP 104, according to non-limiting aspects, can comprise one or more of promotion or cross-promotion component 702 and/or connector component 704, which can facilitate connecting to one or more third parties and/or networks 802 (e.g., for the purpose of transmission or sharing of data associated with one or more goals of ISPP 104 and/or third parties and/or networks 802, etc.). It can be appreciated that, according to a non-limiting aspect, the one or more third parties and/or networks 802 can be disparate from a user or subscriber 102, as well as being one or more users or subscribers 102. As further described above, ISPP 104 comprising one or more of a promotion or cross-promotion component 702 and/or connector component 704 can enable a user or subscriber 102 to share or socialize various data and/or information associated with ISPP 104 (e.g., polls, results, responses, analyses, reward programs, incentives, etc.).

For instance, ISPP 104 comprising connector component 704, according to further non-limiting aspects, can facilitate leveraging ISPP 104 data and/or information from within management information system (MIS) software and/or other software platforms or systems to fully utilize information associated with ISPP 104. For instance, MIS software refers to applications that provide managers with information about sales, inventories, and/or other data, and so on, to support business or organizational decision-making, including, as non-limiting examples, decision support systems, resource and people management applications, enterprise resource planning (ERP), enterprise performance management (EPM), supply chain management (SCM), customer relationship management (CRM), project management and database retrieval applications, and so on. A non-limiting example of an ISPP 104 comprising connector component 704 can facilitate sharing of data associated with ISPP 104 with one or more MIS software platforms (or other e-commerce systems) to enable leveraging such data for a company as user or subscriber 102 (or as one or more third parties and/or networks 802) to employ in timely and relevant business decision-making, according to a further non-limiting aspect. In addition, ISPP 104 can enable a company as user or subscriber 102 (or as one or more third parties and/or networks 802) to leverage information and/or data associated with ISPP 104 to enhance a business' social relevancy (e.g., raise awareness, raise esteem on cultural issues such as environmental awareness, customer focus, customer service, etc.), presence, brand recognition, and so on.

As another non-limiting example, consider a company or individual that specializes in market research, statistical analysis (and/or software therefore), and/or other expertise, products, or services relevant to ISPP 104, or otherwise. Such companies or individuals as third parties and/or networks 802 (e.g., not necessarily as a user or subscriber 102) can provide specialized expertise or services to ISPP 104 related to the aforementioned or other categories, for example, in exchange promoting its own brand on ISPP 104, receiving advertising within ISPP 104 at a discount, gaining access to users or subscribers 102 (e.g., sponsoring a poll, etc.) at reduced rates, and so on etc., without limitation. In yet another example, market research companies as third parties and/or networks 802 (e.g., not necessarily a user or subscriber 102) could direct its clients' research opportunities to utilize facilities, functionalities, services, and/or portions thereof associated with ISPP 104 in exchange for (e.g., partially or otherwise) access to the market research companies' otherwise proprietary research data, stimulating membership and/or participation in ISPP 104, and so on.

In another non-limiting example, consider a company or individual with a product or service to promote. ISPP 104, according to non-limiting aspects, comprising one or more of promotion or cross-promotion component 702 and/or connector component 704, can facilitate connecting to one or more third parties and/or networks 802 (e.g., for the purpose of transmission or sharing of data and/or information associated with one or more goals of ISPP 104 and/or third parties and/or networks 802, etc.), as described above. In this non-limiting instance, ISPP 104 can facilitate enabling the company or individual to promote its products and/or services. For example, ISPP 104 can facilitate strategically placing an advertisement for the products and/or services with ISPP 104 content (e.g., one or more of a poll, results, analysis, or other data and/or information, and so on, etc.). As a further non-limiting example, such ISPP 104 content can be determined by ISPP 104 to be related to the products and/or services, can be inferred by ISPP 104 to have a relevant likelihood that a user or subscriber 102 would be interested in the product or service (e.g., such as by inferring from user or subscriber 102 history, such as poll history, search history, by inferring from user or subscriber 102 profile, and so on etc.), as well as identifying other opportunities for promotion. As such, ISPP 104 comprising one or more of promotion or cross-promotion component 702 and/or connector component 704 can facilitate one or more third parties and/or networks 802 to promote such a product or service.

In yet another non-limiting example, a company or individual having a well-known brand might be interested in cross-promotion of products and/or services within ISPP 104, otherwise. As a non-limiting example, ISPP 104 comprising one or more of promotion or cross-promotion component 702 and/or connector component 704 can facilitate cross-promotions product and/or services within ISPP 104, otherwise. For example, a game software developer interested in market research for and/or promotion of an upcoming game and a disparate game controller hardware manufacturer seeking to promote adoption of its game controller might desire to cross-promote their brands and/or products. It can be understood that one or more of the game software developer and/or game controller hardware manufacturer might not be registered as users or subscribers 102. In one instance, the two might bring identified cross-promotion opportunities to ISPP 104. In another instance either or both of the two might be unaware of such cross-promotion opportunities within ISPP 104, in which case ISPP 104 can facilitate analysis of users or subscribers 102, search history, poll catalog, and so on etc., to identify such cross-promotion opportunities within ISPP 104. In any event, the possibilities of cross-promotions via ISPP 104 are virtually limitless. As a non-limiting example, a first of the two (e.g., the game controller hardware manufacturer) might sponsor a poll of the other's product and/or service (e.g., game software developer's game), where a reward or incentive for responding to the poll can include such things as rebates on the game controller, entry into a contest for free a controller, and so on, etc. It can be understood, with the myriad of products and/or services that exist and/or have yet to be conceived, the capabilities of ISPP 104 to facilitate promotion and/or cross-promotion within the context of polling, analysis, market research, social networking, and so on, etc., are potentially without limitation.

In further non-limiting examples, ISPP 104 comprising one or more of promotion or cross-promotion component 702 and/or connector component 704, can facilitate connecting to one or more third parties and/or networks 802 (e.g., for the purpose of transmission or sharing of data associated with one or more goals of ISPP 104 and/or third parties and/or networks 802, etc.), as described above. In an exemplary implementation, data associated with ISPP 104 can be shared with other networks and/or computing systems, (e.g., such as social media networks, news networks, search networks, and/or associated computing systems, etc.) and/or third parties, (e.g., individuals, political organizations, public polling organizations, private polling organizations, universities, and/or associated computing systems, and so on, etc.). As described above, ISPP 104 comprising, for example, connector component 704 or other components as described herein, can facilitate developing hybrid web applications or “mashups,” populating such hybrid web applications with information and/or data associated with ISPP 104, and/or combining functionality from one or more sources in addition to functionality associated with ISPP 104 to create compound applications or services, and so on, etc.

As a non-limiting example, ISPP 104 comprising, for example, connector component 704 or other components as described herein, can facilitate exposing one or more of APIs, data sources, functionality, and so on, etc. associated with ISPP 104. To that end, further non-limiting implementations of ISPP 104 can comprise one or more APIs that can expose data and/or functionality associated with one or more system components 116 (e.g., one or more of analysis component 408, monetization component 410, component 602, poll data format component 604, storage component 606, profile management component 612, search component 614, catalog component 616, marketing component 618, social component 620, promotion or cross-promotion component 702 and/or connector component 704, and so on, etc., as well as other components and/or functionality as further described herein, etc.). To that end, further non-limiting implementations of ISPP 104 can comprise one or more APIs that can expose data and/or functionality associated with the one or more system components 116 (e.g., one or more of analysis component 408, monetization component 410, component 602, poll data format component 604, storage component 606, profile management component 612, search component 614, catalog component 616, marketing component 618, social component 620, and so on, etc., as well as other components and/or functionality as further described herein, etc.).

As such, ISPP 104 can facilitate implementation of hybrid web applications that can produce enriched results and/or presentations involving data and/or information associated with ISPP 104 (e.g., polls, poll questions, accounts, profiles, preferences, responses, affiliations, and so on, etc.) and one or more other data sources and/or functionality. In a non-limiting social media example, data and/or information associated with ISPP 104 can be combined with other social media data and/or information associated with other third parties and networks 802, for instance, to identify, share, publish, analyze, and so on, trends in real-time or near real-time. In a non-limiting mapping context, an exemplary implementation of a hybrid web application can combine mapping data, information, and/or functionality with data associated with ISPP 104 to facilitate identification, sharing, publishing, analyzing, and so on, poll results, product popularity, trends, and so on, etc., on a geographic basis, for which one or more of the foregoing can also be presented in real-time, in near real-time, on a historical basis, etc.

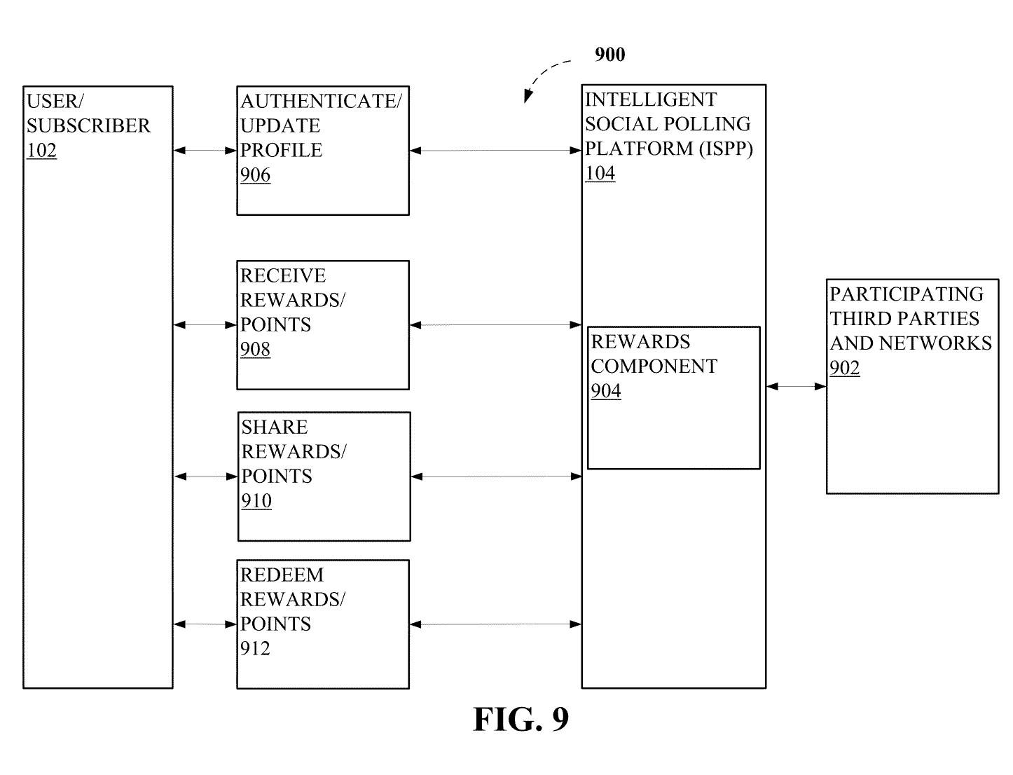

In yet another non-limiting example, FIG. 9 illustrates a flow diagram of an exemplary interaction 900 of a user or subscriber 102 with an exemplary embodiment of ISPP 104 (e.g., for the purpose of stimulating or incentivizing activities within ISPP 104, receiving rewards and/or points, sharing rewards and/or points, redeeming rewards and/or points, etc.). For instance, in further non-limiting examples, FIG. 9 illustrates how user or subscriber 102 and/or participating third parties and/or networks 902 can leverage ISPP 104 non-limiting aspects directed to stimulating and/or incentivizing activities within ISPP 104 (e.g., polling, responding to polls, analyzing data associated with ISPP 104, advertising, promoting products and/or services, and so on, etc.), or otherwise.

As described above, non-limiting aspects of an exemplary implementation of ISPP 104 comprising rewards component 904, or portions thereof, can facilitate implementing a point reward system, as well as other rewards systems. In an exemplary implementation of ISPP 104 that facilitates a reward and/or point system, a predetermined amount of points can be awarded to a user or subscriber 102 (e.g., after a user or subscriber 102 responds to a poll, in response to user's or subscriber's 102 poll socializing activities that promote goals or objectives of ISPP 104, etc.) based in part activities, either within ISPP 104, or otherwise, that promote goals or objectives of ISPP 104, such as: sharing a poll with a predetermined number of users or subscribers 102 within the user's or subscriber's 102 friends or followers network, which predetermined number of users or subscribers 102 also respond to the poll, completing poll analysis challenges or other challenges, responding to a predetermined number of polls; fulfilling various threshold levels of registration or membership level requirements, such as completion and/or verification of one or more user or subscriber 102 profile information data points, which can reliably increase the trustworthiness that the data points place the user or subscriber 102 into a particularly desirable demographic, promotion of ISPP 104, such as invitations, referrals, and/or attracting new users or subscribers 102 to ISPP 104; and/or fulfilling marketing or other advertising objectives within ISPP 104, such as viewing advertisement presentations including videos, or otherwise, completing advertising offers, making one or more purchases within ISPP 104, such as within an ISPP 104 mobile device supported application, and so on etc.

Thus, in a particular non-limiting implementation, ISPP 104 can facilitate a point and/or reward system that, when a user or subscriber 102 authenticates and/or updates the user's or subscriber's 102 profile at 906, ISPP 104 can determine what predetermined amount of reward or points to be awarded to user or subscriber 102, based in part on activities of user or subscriber 102 within ISPP 104, on ISPP 104 sponsorship levels by participating third parties and/or networks 902, on ISPP 104 objectives and/or goals, and so on, etc. Accordingly, in exemplary implementations of ISPP 104 that facilitates a reward and/or point system, a user or subscriber 102 can receive a predetermined amount of rewards and/or points at 908 according to the foregoing and/or other considerations. As non-limiting examples, ISPP 104, in the context of a point reward system, can facilitate user or subscriber 102 using points to create polls (e.g., in an instance where user or subscriber 102 would otherwise sponsor a poll is a participating third party or network 902, etc.), user or subscriber 102 sharing rewards and/or points at 910 with another user or subscriber 102, redeem rewards and/or points at 912 for products and/or other services (e.g., within ISPP 104, via participating third parties and/or networks 902, or otherwise, etc.), and so on.

In a further exemplary implementation, as previously mentioned, ISPP 104 can facilitate providing users or subscribers 102 with virtually limitless options above a predetermined threshold as to the amount of personal information users or subscribers 102 choose to disclose to ISPP 104 and/or to third parties and/or networks, the control of the manner in which data associated with personal information can be published, shared, used in analysis, and so on, etc. For instance, in a non-limiting aspect, ISPP 104 can facilitate offering a predetermined amount of points and/or other rewards to users or subscribers 102 in exchange for certain amounts of personal information users or subscribers 102 disclose to ISPP 104 and/or to third parties and/or networks (e.g., third parties and/or networks 802, participating third parties and/or networks 902, etc.). In another non-limiting aspect, ISPP 104 can facilitate offering a predetermined amount of points and/or other rewards to users or subscribers 102 in exchange for relinquishing certain aspects of control of data associated with personal information and/or personal information relating to how such data and/or information can be published, shared, used in analysis, and so on, etc. In still further non-limiting aspects, ISPP 104 can facilitate implementing a tiered membership, for which users or subscribers 102 in more desirable tiers of membership (e.g., desirable from the perspective of being eligible for higher rewards and/or amounts of points for responding to polls, and/or other activities, within ISPP 104, or otherwise, and so on, etc.) can be made eligible for higher levels of points and/or rewards for subsequent activities within ISPP 104, for example, where such tiers (and/or associated points and/or rewards) can be determined based in part on levels of disclosure of data and/or information associated with personal information and/or personal information, ability to verify and/or authenticate certain aspects of personal information (e.g., such as via a credit report verifying credit score, voter ID verifying political party identification and/or voting precinct, tax records verifying income level, home ownership status, and/or other information and/or data associated with financial demographics, and so on, etc.).

While a brief overview and various non-limiting implementation scenarios or interactions of user or subscriber 102 has been described above in order to provide a basic understanding of some aspects of the specification, various non-limiting devices, systems, and methods are now described as a further aid in understanding the advantages and benefits of various embodiments of the disclosed subject matter. To that end, it can be understood that such descriptions are provided merely for illustration and not limitation.

### Exemplary Systems and Devices

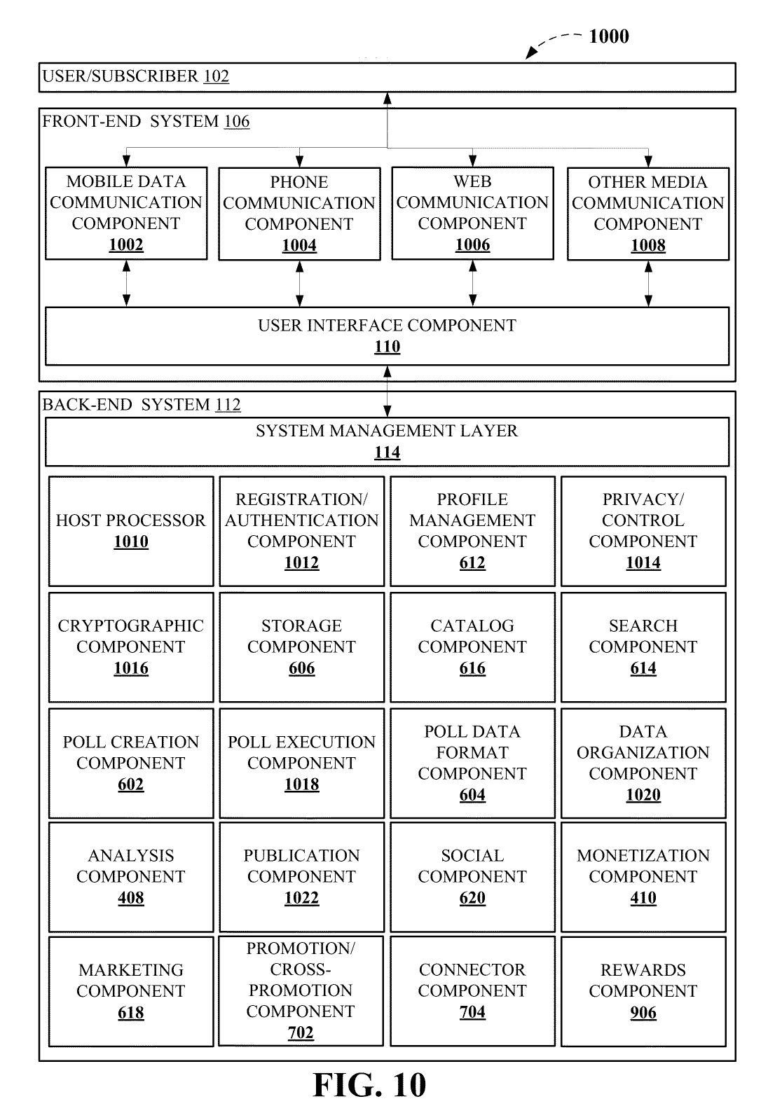

FIG. 10 depicts a functional block diagram illustrating exemplary non-limiting devices or systems suitable for use with aspects of the disclosed subject matter. For instance, FIG. 10 illustrates exemplary non-limiting devices or systems 1000 suitable for performing various aspects of the disclosed subject matter in accordance with an exemplary ISPP 104 as further described herein. For example, as described above regarding FIG. 1, a user or subscriber 102 can interact with ISPP 104 via a front-end system 106 that can comprise or be associated with one or more communication components 108 and/or one or more user interface components 110. As further described herein, user or subscriber 102 interactions with ISPP 104 can be further processed and/or handled via a back-end system 112 that can also comprise or be associated with system management layer 114 and/or one or more system components 116. As depicted in FIG. 10, ISPP 104 can comprise a front-end system 106 that can, in turn, comprise one or more of mobile data communication component 1002, phone communication component 1004, web communication component 1006, and/or other media communication component 1008, and so on, etc. As further depicted in FIG. 10, ISPP 104 can comprise a back-end system 112 that can, in turn, comprise one or more of host processor 1010, registration and/or authentication component 1012, profile management component 612, privacy and/or control component 1014, cryptographic component 1016, storage component 606, catalog component 616, search component 614, poll creation component 602, poll execution component 1018, poll data format component 604, data organization component 1020, analysis component 408, publication component 1022, social component 620, monetization component 410, marketing component 618, promotion and/or cross-promotion component 702, connector component 704, and/or rewards component 904, and so on, etc., either as described above, or as further described herein.

For instance, as described above, ISPP 104 can facilitate user or subscriber 102 interaction with ISPP 104 via front-end system 106 to enable input of information into ISPP 104 and/or receipt of information out of ISPP 104 associated with information processing, handling, and/or transformation occurring within ISPP 104 or otherwise. In a non-limiting implementation of ISPP 104 comprising an exemplary mobile data communication component 1002, ISPP 104 can facilitate transmitting information to, and/or receiving information from, ISPP 104 via one or more devices configured to transmit and receive information via a wireless data network (e.g., cellular wireless, Wireless Fidelity (WiFi™), Worldwide Interoperability for Microwave Access (WiMax®), etc.). In yet other non-limiting implementations of ISPP 104 comprising an exemplary phone communication component 1004, ISPP 104 can facilitate transmitting information to, and/or receiving information from, ISPP 104 via one or more devices configured to transmit and receive information via a voice network (e.g., cellular wireless voice network, analog or digital fixed line network, such as via conventional land-line networks, etc.). In further non-limiting implementations of ISPP 104 comprising an exemplary web communication component 1006, ISPP 104 can facilitate transmitting information to, and/or receiving information from, ISPP 104 via one or more devices configured to transmit and receive information via a data network supporting conventional web browsing protocols and/or applications (e.g., such as via a data connected device connected to an intranet, the Internet, wireless networks, etc.).

In still other exemplary implementations of ISPP 104 comprising other media communication component 1008, ISPP 104 can facilitate transmitting information to, and/or receiving information from, ISPP 104 via one or more devices configured to transmit and receive information via other technologies (e.g., mesh networks, ad hoc networks, personal area networks, interactive television, wearable computing devices, facial recognition, video telephony via any of a number of networks including the Internet, wireless networks, and so on, etc., near field communications (NFC) techniques including communications protocols and data exchange formats, such as those based on radio-frequency identification (RFID) techniques, quick response codes (QR Codes®), barcodes, voice recognition, and so on, etc.), without limitation.

At this point, it should be noted that, while a number of components and/or systems are depicted in FIG. 10, and/or are described herein with respect to ISPP 104 comprising various components and/or systems, various non-limiting implementations of ISPP 104 and/or devices associated with a user or subscriber 102 that can comprise and/or interact with ISPP 104 are not so limited. For instance, it can be understood that, depending on the context of the user or subscriber 102 (or other entity) interaction with ISPP 104 and/or a device or system associated with a user or subscriber 102 (or other entity), such a device or system associated with a user or subscriber 102 (or other entity) can comprise any of a number of components, subcomponents, and/or portions thereof depicted in FIG. 10, and/or can comprise such components, subcomponents, and/or portions thereof in lieu of, in addition to, and/or complementary to components depicted in FIG. 10. As a non-limiting example, a device (e.g., such as a mobile device) associated with user or subscriber 102 can comprise a user interface and/or a web browser, subcomponents, and/or portions thereof that are complementary (e.g., that can serve as a client of a server) to user interface component 110 of various implementations ISPP 104 (e.g., that serve as the server to the client). In a further non-limiting example, a device (e.g., such as a mobile device) associated with user or subscriber 102 can comprise any of a number of components, subcomponents, and/or portions thereof that can be employed in lieu of (or at least partially in lieu of) components depicted in FIG. 10 (e.g., such as an application, or app, programmed in native code for the particular device, etc.) that accomplishes and/or facilitates functionalities, or portions thereof, associated with components depicted in FIG. 10.

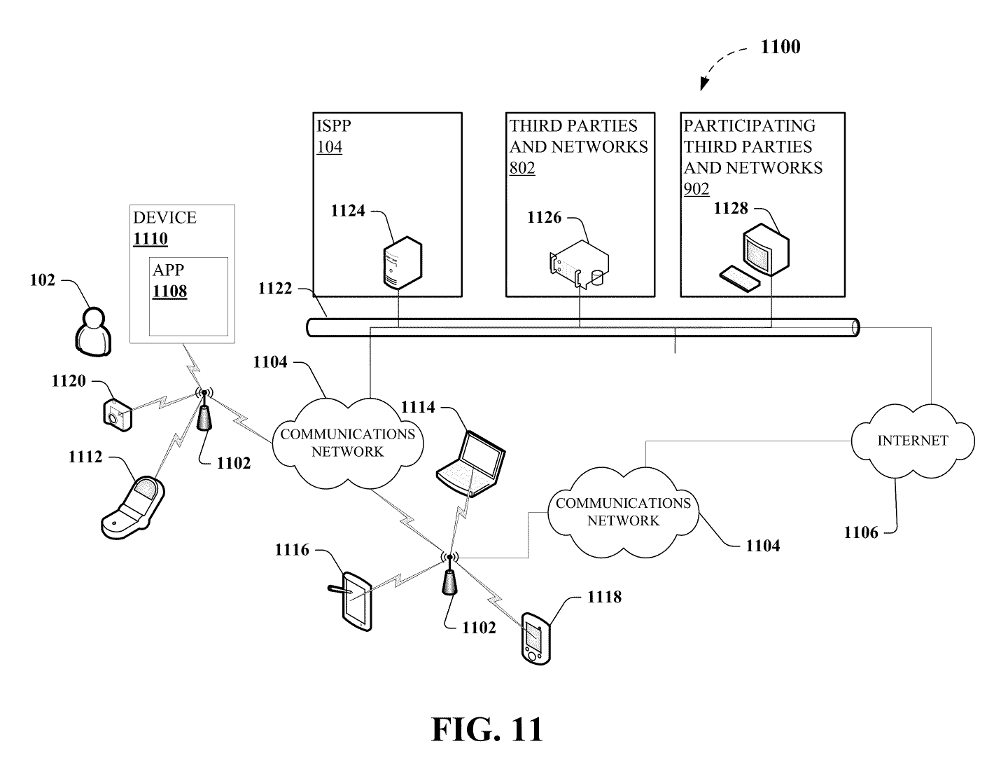

Thus, FIG. 10 illustrates an exemplary non-limiting device or system 1000 suitable for performing various aspects of the disclosed subject matter. As described below with reference to FIG. 11, for example, various non-limiting embodiments of the disclosed subject matter can comprise more or less functionality than those exemplary devices or systems described therein, depending on the context. In addition, a device or system 1000 as described can be any of the devices and/or systems as the context requires and as further described above in connection with FIGS. 1-9. It can be understood that while the functionality of device or system 1000 is described in a general sense, more or less of the described functionality may be implemented, combined, and/or distributed (e.g., among network components, servers, databases, and the like), according to context, system design considerations, and/or marketing factors, and the like. For the purposes of illustration and not limitation, exemplary non-limiting devices or systems 1000 can comprise one or more exemplary devices and/or systems of FIG. 11, such as ISPP 104 (or device 1110, computing system 1126, computing system 1128, etc.) as described below, for example, or portions thereof.

In yet another non-limiting example, ISPP 104 can be implemented as a social networking computing system, and/or a subset of components associated with ISPP 104 and/or portions thereof can be incorporated within, associated with, in communication with, and/or otherwise affiliated with another computing system (e.g., such as one or more of a social media network computing system, a news network computing system, a search network computing system, etc.), and/or one or more computing systems associated with third parties, (e.g., individuals, political organizations, public polling organizations, private polling organizations, universities, and so on, etc.). Moreover, any of the components described herein can be configured to perform the described functionality (e.g., via computer-executable instructions stored in a tangible computer readable medium, and/or executed by a computer, a processor, etc.). Additionally, it can be understood that various components, as described herein, can be communicatively coupled with one or more other components, as described herein, or otherwise, to share data and/or information among such components to accomplish any functionality, as described herein, and/or otherwise, that can be associated with ISPP 104, related thereto, and/or ancillary to various aspects and disclosed subject matter.

Referring again to FIG. 10, ISPP 104 comprising device or system 1000, or portions thereof, can also include a user interface component 110, which can be associated with one or more host processors 1010, and which can facilitate various aspects of the disclosed subject matter. For instance, user interface component 110 can provide various types of user interfaces to facilitate interaction between a user or subscriber 102 (e.g., user or subscriber 102, a device on behalf of user or subscriber 102, an appropriately configured application, or app, such as an app appropriately configured for a specific device, communications service carrier, such as described below with reference to FIGS. 11-12, 16-26, 29-30, and so on, etc.) and any component coupled to, or associated with, one or more host processors 1010, ISPP 104, and so on, for example, such as described below with reference to FIGS. 11-12, 16-26, etc. In addition to being configured or adapted to be accessed by one or more user or subscriber 102, user interface component 110, can be further configured to provide one or more GUIs, command line interfaces (CLIs), machine accessible interfaces (e.g., APIs such as e-commerce and/or MIS back-end interfaces), structured and/or customized menus, and the like. In yet another exemplary implementation, user interface component 110 can facilitate interaction between a user or subscriber 102 (e.g., via a device associated with user or subscriber 102, and so on, etc.), such as between a mobile device native app installed directly onto the device (e.g., smartphone, tablet, etc.) coded in its own native programming language, and/or a mobile web app (e.g., an Internet-enabled app, etc.) that has specific functionality for mobile devices and accessed through the mobile device's web browser, as further described herein.

For example, an ISPP 104 comprising user interface component 110 can facilitate rendering a GUI that can provide user or subscriber 102 with a region (e.g., region of a device screen, such as via an operating system (OS), application, or otherwise, etc.) or other means to load, import, read, etc., data and/or information, and/or can include a region to present results output from ISPP 104. These regions can comprise known text and/or graphic regions comprising dialogue boxes, static controls, drop-down-menus, list boxes, pop-up menus, edit controls, combo boxes, radio buttons, check boxes, push buttons, and/or graphic boxes, and the like. In addition, utilities to facilitate the presentation such as vertical and/or horizontal scroll bars for navigation and toolbar buttons to determine whether a region will be viewable can be employed. For example, user or subscriber 102 can interact with one or more of the components depicted in FIG. 10, for instance, whether associated with, coupled to, and/or incorporated in one or more host processors 1010 ISPP 104, and so on.

ISPP 104 comprising user interface component 110 can facilitate user or subscriber 102 interaction with such regions to select and/or provide information via various devices such as a mouse, a roller ball, a keypad, a keyboard, touchpad, touch screen, a pen and/or voice activation, for example. Typically, a mechanism such as a push button or the enter key on the keyboard can be employed to facilitate entering information in a device associated with user or subscriber 102 to facilitate interaction with ISPP 104 comprising device or system 1000, or portions thereof. However, it is to be understood that the claimed subject matter is not so limited. In a non-limiting example, merely highlighting a check box can initiate information conveyance.

In yet another example, a command line interface (CLI) can be employed. For example, the command line interface can prompt (e.g., via a text message on a display and/or an audio tone, etc.) user or subscriber 102 for information via providing a text message. Thus, user or subscriber 102 can provide suitable information, such as alpha-numeric input corresponding to an option provided in the interface prompt or an answer to a question posed in the prompt. It is to be understood that a command line interface can be employed in connection with a GUI and/or API. In addition, the command line interface can be employed in connection with hardware (e.g., video cards of a computer) and/or displays (e.g., black and white, EGA, or other video display unit of a standalone device such as an LCD display on a network capable device) with limited graphic support, and/or low bandwidth communication channels. As a further example, a device associated with user or subscriber 102 that facilitates interaction with ISPP 104 comprising device or system 1000 can include one or more motion sensors and associated software components, voice activation components, and/or facial recognition components that can be used by a user to facilitate entering information into ISPP 104 comprising device or system 1000, or portions thereof.

Accordingly, an ISPP 104 can comprise advanced mobile device centric applications and services that can facilitate interactions with ISPP 104 as described herein related to polling activities, social activities, marketing activities, and so on, e.g., via one or more of user interface component 110 and/or communication components 108, etc. For instance, in an exemplary implementation ISPP 104 can facilitate user or subscriber 102 employing any of a variety of devices comprising an appropriately configured application, or app (e.g., such as via an app appropriately configured for a specific device associated with user or subscriber 102, an app appropriately configured for a communications service carrier, etc.), such as described below with reference to FIGS. 11-12, 16-26, 29-30, and so on, etc.). As a result, ISPP 104 can provide one or more of a variety of interfaces to mobile devices via mobile applications that can facilitate providing access to ISPP 104 functionalities as described herein, for example, with reference to FIGS. 2-9, 16-26, and so on, etc.

Thus, in exemplary non-limiting implementations, ISPP 104 can facilitate user or subscriber 102 interfacing with ISPP 104 via a mobile device, a phone, a web browser, and/or other media and/or device types (e.g., via one or more of mobile data communication component 1002, phone communication component 1004, web communication component 1006, and/or other media communication component 1008, and so on, etc.), which are employed by, or are associated with, user or subscriber 102. In further non-limiting implementations, ISPP 104 comprising user interface component 110 can facilitate transforming any of a variety of input formats (e.g., data, voice, video, and so on, etc.) into a common data format and/or transmitting input formats and/or common data format to back-end system 112. Moreover, any of the components described herein (e.g., one or more of user interface component 110, mobile data communication component 1002, phone communication component 1004, web communication component 1006, and/or other media communication component 1008, and so on, etc.) can be configured to perform the described functionality (e.g., via computer-executable instructions stored in a tangible computer readable medium, and/or executed by a computer, a processor, etc.).

Referring again to FIG. 10, in further exemplary implementations, ISPP 104 can comprise one or more system management layers 114 that can facilitate management of one or more system components 116, as further described herein, and/or one or more components associated with user interface component 110, one or more communications components 108, and so on, for example, via computer-executable instructions executing on one or more host processors 1010. In a non-limiting example of an exemplary ISPP 104, one or more system components 116 can comprise one or more of registration and/or authentication component 1012, profile management component 612, privacy and/or control component 1014, cryptographic component 1016, storage component 606, catalog component 616, search component 614, poll creation component 602, poll execution component 1018, poll data format component 604, data organization component 1020, analysis component 408, publication component 1022, social component 620, monetization component 410, marketing component 618, promotion and/or cross-promotion component 702, connector component 704, and/or reward component 906, and so on, etc., without limitation. In addition to being configured or adapted to facilitate management of one or more of system components 116, and so on, system management layer 114, can be further configured to manage and/or provide one or more interfaces such as one or more CLIs, machine accessible interfaces (e.g., APIs such as e-commerce and/or MIS back-end interfaces), and the like, whether in lieu of, in addition to, and/or complementary to any such interfaces provided by user interface component 110 or other components associated with ISPP 104.

As described above, an exemplary ISPP 104 comprising device or system 1000, or portions thereof, can include one or more host processors 1010 that can be associated with one or more system components 116. As a non-limiting example, computer-executable instructions associated with one or more system components 116 can be executed via one or more host processors 1010. For instance, as described above, ISPP 104 can facilitate user or subscriber 102 (e.g., user or subscriber 102, a device on behalf of user or subscriber 102, an appropriately configured application, or app, such as an app appropriately configured for a specific device, communications service carrier, etc.) registering a user or subscriber 102, or a computer or device on behalf of user or subscriber 102, with ISPP 104, for a service that facilitates interaction with ISPP 104, and so on etc. Moreover, any of the components described herein (e.g., one or more of system management layers 114, system components 116, and so on, etc.) can be configured to perform the described functionality (e.g., via computer-executable instructions stored in a tangible computer readable medium, and/or executed by a computer, a processor, etc.).

In an exemplary implementation, ISPP 104 comprising device or system 1000, or portions thereof, can further include a registration and/or authentication component 1012 that can solicit authentication data from user or subscriber 102 or other device (e.g., via an operating system, and/or application software, etc.) on behalf of the user, and, upon receiving authentication data so solicited, can be employed, individually and/or in conjunction with information acquired and ascertained as a result of biometric modalities employed (e.g., facial recognition, voice recognition, etc.), to facilitate registering a user or subscriber 102, or a computer or device on behalf of user or subscriber 102, creating an account on behalf of user or subscriber 102, associating a device with a user or subscriber 102, verifying received authentication data, and so on. The authentication data can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), and the like, for example.

Additionally and/or alternatively, public key infrastructure (PKI) data can also be employed by registration and/or authentication component 1012. PKI arrangements can provide for trusted third parties to vet, and affirm, entity identity through the use of public keys that typically can be certificates issued by trusted third parties. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

Accordingly, registration and/or authentication component 1012 can implement one or more machine-implemented techniques to identify a user or subscriber 102 or other device (e.g., via an operating system and/or application software) on behalf of the user, by the user's unique physical and behavioral characteristics and attributes. Biometric modalities that can be employed can include, for example, face recognition wherein measurements of key points on an entity's face can provide a unique pattern that can be associated with the entity, iris recognition that measures from the outer edge towards the pupil the patterns associated with the colored part of the eye—the iris—to detect unique features associated with an entity's iris, voice recognition, and/or finger print identification that scans the corrugated ridges of skin that are non-continuous and form a pattern that can provide distinguishing features to identify an entity. Moreover, any of the components described herein (e.g., registration and/or authentication component 1012, and so on, etc.) can be configured to perform the described functionality (e.g., via computer-executable instructions stored in a tangible computer readable medium, and/or executed by a computer, a processor, etc.).

Referring again to FIG. 10, in a further exemplary implementation, ISPP 104 comprising device or system 1000, or portions thereof, can also include a profile management component 612 that can facilitate account setup, updating, modification, preference specification, and so on, etc., for a user or subscriber 102 of ISPP 104, which account can include or be associated with user preferences, user privacy settings, as well as other user account or profile information (e.g., demographic related information, subscription level information, and so on, etc.). In yet other exemplary implementations, profile management component 612 can facilitate determining, based in part on accessing user profiles, privacy settings, etc., what subset of users or subscribers 102 will receive notifications and/or what type, can access one or more polls, can access poll results, and so on, etc., as described above. Thus, as described above, various non-limiting implementations of ISPP 104 can employ a profile management component 612 that can facilitate various operations associated with one or more of profile creation, modification, administration, poll targeting, analyses, marketing, monetization, and/or publishing and/or socializing of one or more of polls, responses, results, and/or analyses, and so on, etc.

In still other non-limiting implementations, ISPP 104 can enable user or subscriber 102 management of social activities (e.g., voting to “like” or “dislike” data associated with ISPP 104, such as a poll, an analysis, etc., which can serve to promote quality polling questions, voting to “like” or “dislike” data, services, products, and so on, etc., not associated with ISPP 104, conducting games, contests, pools, or other social activities which can serve to promote ISPP 104 participation, community, and/or quality of membership, and/or cros s-promote other third party data, services, products, networks, and so on etc.), for example, such as by specifying such preferences that can be managed in the profiles associated with users or subscribers 102, for example. Thus, a user profile can be initiated and/or generated via one or more of profile management component 612 and/or registration and/or authentication component 1012 for a user or subscriber 102 and can be stored via storage component 606 for subsequent management, analysis and/or other interactions (e.g., targeted polling, targeted advertising, etc.) with ISPP 104, as further described herein. In further non-limiting implementations, ISPP 104 can enable user or subscriber 102 management of interactions with ISPP 104 (e.g., receiving targeted polling requests, notifications thereof, and so on etc.) based in part on availability of user or subscriber 102 (e.g., on the basis of time, such as, specifying an interval of time or status as busy, available, or otherwise, setting reminders to respond to targeted polls, setting a “sleep” period for targeted poll notifications, and so on, etc.), for example, such as by specifying preferences that can be manage in the profiles associated with users or subscribers 102. Furthermore, any of the components described herein (e.g., profile management component 612, and so on, etc.) can be configured to perform the described functionality (e.g., via computer-executable instructions stored in a tangible computer readable medium, and/or executed by a computer, a processor, etc.).

In other non-limiting implementations, ISPP 104 comprising device or system 1000, or portions thereof, can also include a privacy and/or control component 1114 that can facilitate setting up, updating, modifying, specifying, and/or enforcing, and so on, etc., user or subscriber 102 privacy settings, ISPP 104 privacy policies, other terms of service, and/or other policies associated with data storage, data retention and/or aging, privacy policies, other terms of service, and/or other policies associated with one or more of third parties and network 802 and/or participating third parties and/or networks 902, and the like. Thus, ISPP 104 can further facilitate (e.g., via one or more of profile management component 612, privacy and/or control component 1014, etc.) account setup, updating, modification, specification, and/or enforcement of user preferences, such as user privacy settings, for a user or subscriber 102 on the ISPP 104, which account can include or be associated with user preferences, user privacy settings, whether or not user or subscriber 102 also interacts with ISPP 104 as one of one or more of third parties and network 802 and/or participating third parties and/or networks 902. In addition, any of the components described herein (e.g., privacy and/or control component 1114, and so on, etc.) can be configured to perform the described functionality (e.g., via computer-executable instructions stored in a tangible computer readable medium, and/or executed by a computer, a processor, etc.).

In other non-limiting implementations, ISPP 104 comprising device or system 1000, or portions thereof, can also include cryptographic component 1016 that can facilitate encrypting and/or decrypting data and/or information associated with ISPP 104 to protect such sensitive data and/or information associated with user or subscriber 102, such as authentication data, data and/or information employed to confirm various user or subscriber 102 demographics, usage history, search history, and so on, etc. Thus, one or more of host processors 1010 can be associated with cryptographic component 1016. In accordance with an aspect of the disclosed subject matter, cryptographic component 1016 can provide symmetric cryptographic tools and accelerators (e.g., Twofish, Blowfish, AES, TDES, IDEA, CAST5, RC4, etc.) to facilitate encrypting and/or decrypting data and/or information associated with ISPP 104.

Thus, cryptographic component 1016 can facilitate securing data and/or information being written to, stored in, and/or read from the storage component 606 (e.g., account and/or profile information, messages, queries, requests, polls, poll responses, etc.), transmitted to and/or received from a connected network (e.g., such as for transmitting user or subscriber 102 and/or associated device information to a trusted intermediary, etc.), and/or creating a secure communication channel as part of a secure association of various devices with exemplary implementations of ISPP 104 comprising non-limiting embodiments of devices or systems 1100, or portions thereof, with a user or subscriber 102 (or one or more of third parties and network 802 and/or participating third parties and/or networks 902) facilitating various aspects of the disclosed subject matter to ensure that protected data can only be accessed by those entities authorized and/or authenticated to do so. To the same ends, cryptographic component 1016 can also provide asymmetric cryptographic accelerators and tools (e.g., RSA, Digital Signature Standard (DSS), and the like) in addition to accelerators and tools (e.g., Secure Hash Algorithm (SHA) and its variants such as, for example, SHA-0, SHA-1, SHA-224, SHA-256, SHA-384, SHA-512, SHA-3, and so on). As described, any of the components described herein (e.g., cryptographic component 1016, and so on, etc.) can be configured to perform the described functionality (e.g., via computer-executable instructions stored in a tangible computer readable medium, and/or executed by a computer, a processor, etc.).

For still other non-limiting implementations, ISPP 104 comprising device or system 1000, or portions thereof, can also include storage component 606 (e.g., which can comprise one or more of local storage component 608, network storage component 610, memory 1202, storage component 1610, and so on, etc.) that can facilitate storage and/or retrieval of data and/or information associated with ISPP 104. Thus, as described above, an exemplary ISPP 104 comprising device or system 1100, or portions thereof, can include one or more host processors 1010 that can be associated with storage component 606 to facilitate storage of data and/or information (e.g., polls, poll questions, poll responses, messages, accounts, profiles, preferences, affiliations, analyses, reports, publications, advertisements, usage history, search history, and so on, etc.), and/or instructions for performing functions associated with and/or incident to the disclosed subject matter as described herein, for example, regarding FIGS. 2-9, etc. In addition, in exemplary non-limiting implementations, storage component 606 associated with ISPP 104 can be configured to store instructions adapted to facilitate storage of account and/or profile information, as described herein, which can be stored and/or available according to user preferences, user privacy settings, storage and privacy policies associated with ISPP 104, and so on, etc.

It can be understood that storage component 606 can comprise one or more of system components 116, and/or portions thereof, to facilitate any of the functionality described herein and/or ancillary thereto, such as by execution of computer-executable instructions by a computer, a processor, and so on, etc. (e.g., one or more of host processors 1010, processor 1204, processor 1604, and so on, etc.). Moreover, any of the components described herein (e.g., storage component 606, and so on, etc.) can be configured to perform the described functionality (e.g., via computer-executable instructions stored in a tangible computer readable medium, and/or executed by a computer, a processor, etc.).

In other exemplary embodiments, ISPP 104 comprising device or system 1000, or portions thereof, can also include one or more of search component 614 and/or catalog component 616. To that end, one or more of host processors 1010 can be associated with one or more of search component 614 and/or catalog component 616 to facilitate functionality described herein. As a non-limiting example, an exemplary implementation of ISPP 104 comprising a search component 614 can facilitate one or more of receiving search queries from user or subscriber 102, querying one or more search indices (e.g., search indices associated with ISPP 104, search indices associated with other entities, such as third party entities and/or networks 802, etc.), returning search results to user or subscriber 102, and so on, etc. It should be understood that, in the context of various non-limiting implementations of ISPP 104, search results as used herein can comprise any of a number of data types including, but not limited to polls, poll results, responses, users or subscribers 102, demographics, analyses, third party content associated with content related to ISPP 104, whether native to ISPP 104, or otherwise, and whether or not such data is of a textual nature, or otherwise (e.g., graphical, audio, video, and so on, etc.). In further non-limiting example, catalog component 616 can facilitate one or more of aggregating, organizing, presenting, archiving, searching, retrieving, any of the data and/or information types described herein, and so on, etc., as well as other data of interest or related to functions and/or interaction associated with ISPP 104 (e.g., uniform resource identifiers to and/or local copies of other data and/or information, etc.), without limitation.

For instance, an exemplary implementation of ISPP 104 can employ catalog component 616 to facilitate employing data and/or information associated with, or related to functions associated with ISPP 104, within polls, analyses, presentations, and so on, for example, in conjunction with other applications or services, whether affiliated with ISPP 104, or otherwise, to provide dynamic hybrid web applications involving ISPP 104 and one or more other applications or services as further described herein. Furthermore, any of the components described herein (e.g., one or more of search component 614, catalog component 616, and so on, etc.) can be configured to perform the described functionality (e.g., via computer-executable instructions stored in a tangible computer readable medium, and/or executed by a computer, a processor, etc.).

Referring again to FIG. 10, according to further non-limiting implementations, ISPP 104 comprising device or system 1000, or portions thereof, can also include poll creation component 602 that can facilitate one or more of poll creation, such as identification of relevant attributes suitable for targeted polling, creation and/or targeting of polls or poll questions based thereon, designing useful poll studies based in part on proposed theories or research goals (e.g., identifying target demographics, determining sample sizes, determining confidence intervals, and so on, etc.), employing best known methods and practices in the crafting polls and poll questions, and so on, etc., or as further described herein. Accordingly, one or more of host processors 1010 can be associated with poll creation component 602 to facilitate functionality described herein.

For instance, as described herein regarding analysis component 408, ISPP 104 can facilitate displaying results (e.g., poll results, analyses, etc.), which can include, without limitation, the ability to analyze and/or drill down into the poll results to determine useful insights and/or statistics, including but not limited to statistics related to or associated with standardized polling demographics information (e.g., location, age, income level, sex, partisan ID, registered voter, likely voter, response date, education level, etc.) and/or other customizable polling demographics information (e.g., length of product or service use, technical ability and/or competence, a referrer and/or how a respondent heard about the poll, etc.). As further described herein, it can be understood that ISPP 104 comprising analysis component 408 can advantageously facilitate employing any of a number, type, and/or category of information, data, and/or attributes, associated with a poll, ISPP 104, or otherwise, and so on, etc., for analyses of poll results and/or statistics based on attributes of a poll respondent and/or associated profile information or poll responses, and/or a device or platform (e.g., device type, manufacturer, operating system, browser, versioning information, etc.) associated with the respondent, without limitation, whether such information, data, and/or attributes are provided freely by user or subscriber 102 or a respondent, or in exchange for a reward or other incentive, and/or other information that can be useful in poll results analyses.

Accordingly, ISPP 104 comprising device or system 1000, or portions thereof, including poll creation component 602, can facilitate employing any of a number of analyses and/or other functions as can be provided by analysis component 408 (or other components or portions thereof), or otherwise, for example, to facilitate creating, targeting, modifying, and so on, one or more of polls, poll questions, etc., recommending and/or improving poll targeting (e.g., identifying target demographics and/or other attributes of interest in poll targeting, and so on, etc.), determining and/or identifying weaknesses and/or other areas of unreliability in polls, poll questions, and/or poll sample sizes, and so on. Moreover, any of the components described herein (e.g., poll creation component 602, and so on, etc.) can be configured to perform the described functionality (e.g., via computer-executable instructions stored in a tangible computer readable medium, and/or executed by a computer, a processor, etc.). For instance, an exemplary non-limiting implementation of ISPP 104 can comprise a memory or other tangible computer-readable medium to store computer-executable components (e.g., poll creation component 602, and so on, etc.) and a processor communicatively coupled to the memory or other computer-readable medium (e.g., one or more host processors 1010, and so on, etc.) that can facilitate execution of the computer-executable components. As a non-limiting example, an exemplary non-limiting implementation of ISPP 104 can comprise a poll creation component 602 configured to create a targeted poll based in part on an attribute associated with poll targeting as described herein. In yet another non-limiting example, an exemplary non-limiting implementation of ISPP 104 can comprise a poll creation component 602 configured to allow a poll creator (e.g., one or more users or subscribers 102, etc.) to include one or more images on the side of one or more poll response options (e.g., an image for each possible response option associated with the poll). Thus, in a particular non-limiting implementation that limits poll response options to four, four possible pictures can be selected, either as poll response options, or otherwise (e.g., as amplifying information associated with other data and/or information representing poll response options, etc.).

In other exemplary implementations, ISPP 104 comprising device or system 1000, or portions thereof, can also include poll execution component 1018 that can facilitate poll execution (e.g., presenting a poll, such as a targeted poll, etc., responding to a poll, viewing ancillary and/or associated data, information, or functionality, and so on, etc.). As a non-limiting example, ISPP 104 comprising poll execution component 1018 can facilitate one or more operations and/or activities within ISPP 104, such as: presenting a poll (e.g., a targeted poll, etc.) to one or more users or subscribers 102, for example, based in part on one or more attributes associated with poll targeting, such as search queries, profile settings, privacy settings, other attributes associated with targeted polling (e.g., including but not limited to standardized polling demographics information, such as, for example, location, age, income level, sex, partisan ID, registered voter, likely voter, response date, education level, etc., and/or other customizable polling demographics, such as length of product or service use, technical ability and/or competence, a referrer and/or how a respondent heard about the poll, etc., and/or any of a number or type of other categories for poll targeting based on attributes of a poll respondent and/or associated profile information, poll responses, and/or a device or platform, associated therewith, such as device type, manufacturer, operating system, browser, versioning information, etc.) associated with user or subscriber 102 as a respondent, or as a potential respondent, without limitation, whether such information, data, and/or attributes are provided freely by user or subscriber 102 or a respondent, or in exchange for a reward or other incentive, and/or other information that can be useful in poll targeting; and/or presenting options associated with a poll presented to a user or subscriber 102 (e.g., options such as sharing, syndicating, publishing, linking, emailing, rating, ignoring, or otherwise indicating an interest or rating in the subject matter of the poll, in the quality of the poll questions, in the poll results, and/or in other data and/or information associated with the poll, ISPP 104, or otherwise, and so on, etc.).

In another non-limiting example, ISPP 104 comprising poll execution component 1018 can facilitate one or more operations and/or activities within ISPP 104, such as: allowing a user or subscriber 102 to respond to a poll (e.g., via a GUI, text box, web form, control, CLI, etc.) via one or more devices configured to transmit and/or receive information via other technologies (e.g., mesh networks, ad hoc networks, personal area networks, interactive television, wearable computing devices, facial recognition, video telephony via any of a number of networks including the Internet, wireless networks, and so on, etc., NFC techniques including communications protocols and data exchange formats, such as those based on RFID techniques, QR Codes®, barcodes, voice recognition, and so on, etc.), without limitation; receiving poll respondent data and/or information, including, but not limited to one or more of poll answers or responses, poll feedback (e.g., ratings, comments, etc.), and so on, and/or any of the aforementioned numbers, types, and/or categories of information, data, and/or attributes, associated with the poll, ISPP 104, or otherwise, and so on, etc.; reviewing poll one or more of poll answers or responses, poll feedback (e.g., ratings, comments, etc.), and so on; presenting poll results (e.g., whether aggregate or otherwise); as well as presenting other data, information, and/or options whether associated with ISPP 104, or otherwise, including, but not limited to, one or more of offers for a reward or other incentives, advertisements, reports, publications, analyses, poll response status for user or subscriber 102 and/or affiliated users or subscribers 102 (e.g., friends or followers of user or subscriber 102, etc.), poll statistics and/or popularity ratings, feedback status, poll restrictions, search capabilities, and so on, without limitation. To these and related ends, one or more of host processors 1010 can be associated with poll execution component 1018 to facilitate functionality described herein.

Accordingly, ISPP 104 comprising device or system 1000, or portions thereof, including poll execution component 1018, can facilitate employing any of a number, type, and/or category of information, data, and/or attributes or other functions as can be provided by analysis component 408 (or other components or portions thereof), for example, to facilitate poll execution (e.g., presenting a poll, responding to a poll, viewing ancillary and/or associated data, information, or functionality, and so on, etc.).

Moreover, any of the components described herein (e.g., poll execution component 1018, and so on, etc.) can be configured to perform the described functionality (e.g., via computer-executable instructions stored in a tangible computer readable medium, and/or executed by a computer, a processor, etc.). For instance, an exemplary non-limiting implementation of ISPP 104 can comprise a memory or other tangible computer-readable medium to store computer-executable components (e.g., poll execution component 1018, and so on, etc.) and a processor communicatively coupled to the memory or other computer-readable medium (e.g., one or more host processors 1010, and so on, etc.) that can facilitate execution of the computer-executable components. As a non-limiting example, an exemplary non-limiting implementation of ISPP 104 can comprise a poll execution component 1018 configured to present a targeted poll to the potential respondent (e.g., one or more users or subscribers 102, etc.) based in part on an attribute associated with poll targeting, as further described herein (e.g., such as regarding attributes associated with poll targeting comprising data and/or information concerning the potential respondent, and so on, etc.). In other non-limiting examples, an exemplary non-limiting implementation of ISPP 104 can comprise a poll execution component 1018 configured to allow the potential respondent (e.g., one or more users or subscribers 102, etc.) to respond to a targeted poll based in part on a determination of whether the attribute associated with poll targeting is fulfilled or satisfied for the potential respondent, to present a reward or other incentive with the targeted poll to the potential respondent, and so on, as further described herein.

In still other non-limiting examples, an exemplary non-limiting implementation of ISPP 104 can comprise a poll execution component 1018 configured to determine information concerning a potential respondent (e.g., one or more users or subscribers 102, on etc.) based in part on a predetermined interval between an attribute associated with poll targeting concerning time or space and a characteristic associated with the potential respondent concerning time or space, respectively (e.g., where a spatial interval can be determined between a receiver, for example, and a device associated with user or subscriber 102, by comparison of location information associated with user or subscriber 102, such as is available from a GPS receiver, from triangulation via multiple cellular base stations, NFC techniques, etc.; where a temporal interval can be determined based on a desirable time associated with targeted polling and a time associated with a user's or subscriber's 102 last activity of interest, for example, within ISPP 104; and so on; etc.). In a further example, non-limiting implementations of ISPP 104 can comprise a poll execution component 1018 configured to determine information concerning a potential respondent (e.g., one or more users or subscribers 102, on etc.) such as one or more of age, income level, education level, sex, political partisan ID, registered voter status, likely voter status, a prior poll response date, a search query, location, technical competence, technical ability, referrer of the targeted poll, a number of followers, a number of shared polls, a number of completed polls, verification status of a subset of profile information, and/or device information (e.g., one or more of device type, device manufacturer, operating system, application, browser, length of device use, length of service use, length of application use, and/or version information, and so on, etc.) associated with a device (e.g., device 1110, etc.) with the potential respondent (e.g., one or more users or subscribers 102, on etc.).

In still other non-limiting examples, non-limiting implementations of ISPP 104 can comprise a poll execution component 1018 configured to determine data and/or information concerning the potential respondent (e.g., one or more users or subscribers 102, on etc.) related to one or more of a profile setting (e.g., via one or more of profile management component 612, connector component 704, and so on, etc.) and/or a privacy setting (e.g., via one or more of privacy and/or control component 1014, connector component 704, and so on, etc.) associated with one or more of the polling system (e.g., ISPP 104) or another computing system (e.g., such as one or more of a social media network computing system, a news network computing system, a search network computing system, etc.), and/or one or more computing systems associated with third parties, (e.g., individuals, political organizations, public polling organizations, private polling organizations, universities, and so on, etc.).

In still other exemplary implementations, ISPP 104 comprising device or system 1000, or portions thereof, can also include poll data format component 604 that can facilitate receiving and/or adapting poll data and/or information received from various sources (e.g., users or subscribers 102, nationalities, languages, devices, technologies or media, such as web, mobile, phone, etc., browsers, apps, Internet protocol (IP) addresses, geographical locations, and so on, etc.) into a common data format, for which, data and/or information associated with ISPP 104 (e.g., polls, poll questions, accounts, profiles, preferences, responses, affiliations, and so on, etc.) can be stored in storage component 606, in further non-limiting aspects. Accordingly, one or more of host processors 1010 can be associated with poll execution component 1018 to facilitate functionality described herein. Thus, ISPP 104 comprising device or system 1000, or portions thereof, including poll data format component 604, can facilitate employing any of a number, type, and/or category of information, data, and/or other functions as can be provided by data organization component 1020 (or other components or portions thereof), for example, to facilitate receiving and/or adapting poll data and/or information received from various sources into a common data format and so on, etc. Moreover, any of the components described herein (e.g., poll data format component 604, and so on, etc.) can be configured to perform the described functionality (e.g., via computer-executable instructions stored in a tangible computer readable medium, and/or executed by a computer, a processor, etc.).

According to further exemplary implementations, ISPP 104 comprising device or system 1000, or portions thereof, can also include data organization component 1020, in lieu of, in addition to, and/or complementary to one or more of storage component 606, and/or catalog component 616, that can facilitate organizing any of the data and/or information types or categories (or subsets thereof) as described herein, (e.g., such as one or more of aggregating, organizing, presenting, archiving, searching, retrieving, any of the data and/or information types or categories as described herein, and so on, etc., as well as other data of interest or related to data, information, and/or functions associated with ISPP 104 (e.g., uniform resource identifiers or local copies of other data, etc.), without limitation. Accordingly, one or more of host processors 1010 can be associated with data organization component 1020 to facilitate functionality described herein. For instance, various non-limiting implementations of ISPP 104 can comprise one or more of one or more databases, associated data structures, database management systems (DBMS), and so on, and the like can facilitate organized storage of any of the data and/or information types or categories (or subsets thereof) as described herein (e.g., polls, poll questions, poll responses, polling data, information, and/or analyses from sources other than ISPP 104, messages, accounts, profiles, preferences, affiliations, analyses, reports, publications, advertisements, and so on, etc.), without limitation.

Accordingly, ISPP 104 comprising device or system 1000, or portions thereof, including data organization component 1020, can facilitate management of any of a number, type, and/or category of information, data, and/or other functions as can be provided by analysis component 408, profile management component 612, storage component 606, catalog component 616, and/or other components, or portions thereof, for example, to facilitate organized storage of any of the data and/or information types or categories (or subsets thereof) as described herein. Furthermore, any of the components described herein (e.g., data organization component 1020, and so on, etc.) can be configured to perform the described functionality (e.g., via computer-executable instructions stored in a tangible computer readable medium, and/or executed by a computer, a processor, etc.).

In addition, as described below regarding analysis component 408, ISPP 104 can facilitate displaying results (e.g., poll results, analyses, etc.), which can include, without limitation, the ability to analyze and/or drill down into the poll results to determine useful insights and/or statistics, including but not limited to statistics related to or associated with standardized polling demographics information and/or other customizable polling demographics. Thus, data organization component 1020, can facilitate organization of any of the various types of data and/or information associated with ISPP 104 to facilitate analysis component 408 employing any of a number, type, and/or category of information, data, and/or attributes, associated with a poll, ISPP 104, or otherwise, and so on, etc., as further described below.

According to further exemplary implementations, ISPP 104 comprising device or system 1000, or portions thereof, can also include analysis component 408. To that end, one or more of host processors 1010 can be associated with analysis component 408 to facilitate functionality described herein. In a non-limiting example, ISPP 104 comprising device or system 1000, or portions thereof, can facilitate, among other things, aggregate and/or analyze data and/or information sources associated with ISPP 104 (e.g., one or more of polls, poll questions, poll responses, messages, accounts, profiles, preferences, affiliations, statistics, analyses, reports, publications, advertisements, and so on, without limitation, etc.), perform one or more analyses, determine results of the analyses and/or generate reports, results, or recommendations, compose and/or respond to requests or queries, and so on, etc. For instance, an ISPP 104 comprising an analysis component 408 can facilitate normalizing results (e.g., averaging, extrapolating, interpolating, weighting with other results or data, and so on, etc.) and/or other poll results-based data analysis, interpretation, and/or presentation operations, whether based on statistical analysis, intuitive research, and/or inference based on artificial intelligence, and so on, etc. In further non-limiting implementations, analysis component 408 can be configured to provide one or more analyses that can provide users or subscribers 102, third parties and/or networks 802, participating third parties and/or networks 902, proprietors of ISPP 104, and others, etc., for example, with up-to-date (e.g., real-time or near real-time) information regarding information and/or data associated with ISPP 104 (e.g., poll-related data, data and/or information associated with users or subscribers 102, non-poll-related data and/or information, such as system performance statistics, and so on, etc.) to predetermined categories of users or subscribers 102, or others, depending on context, to facilitate analysis of data and/or information associated with ISPP 104. In a non-limiting example, analysis component 408 can be configured to provide one or more analyses that can be employed to facilitate decision making (e.g., decision making via a manual, semi-automated, or fully automated process, according to a decision tree, a decision matrix, heuristics, inference, artificial intelligence, or other decision tool, or any combination, etc.) concerning information and/or data associated with ISPP 104.

In other exemplary implementations of ISPP 104 comprising analysis component 408, ISPP 104 can facilitate displaying results (e.g., poll results, analyses, etc.), which can include, without limitation, the ability to analyze and/or drill down into the poll results to determine useful insights and/or statistics, including but not limited to statistics related to or associated with standardized polling demographics information (e.g., location, age, income level, sex, partisan ID, registered voter, likely voter, response date, education level, etc.) and/or other customizable polling demographics information (e.g., length of product or service use, technical ability and/or competence, a referrer and/or how a respondent heard about the poll, etc.). It can be understood that ISPP 104 comprising analysis component 408 can advantageously facilitate employing any of a number, type, and/or category of information, data, and/or attributes, associated with a poll, ISPP 104, or otherwise, and so on, etc., for analyses of poll results and/or statistics based on attributes of a poll respondent and/or associated profile information or poll responses, and/or a device or platform (e.g., device type, manufacturer, operating system, browser, versioning information, etc.) associated with the respondent, without limitation, whether such information, data, and/or attributes are provided freely by user or subscriber 102 or a respondent, or in exchange for a reward or other incentive, and/or other information that can be useful in poll results analyses.

In a further non-limiting example, one or more analyses can comprise information regarding aggregate data (e.g., information regarding aggregate poll results, etc.) for one or more users or subscribers 102, and/or can comprise subsets thereof employing any of a number, type, and/or category of information, data, and/or attributes, associated with a poll, ISPP 104, or otherwise, and so on, etc. As yet another non-limiting example described herein, for example, one or more analyses can comprise information relating to system requirements such as device type (e.g., desktop, tablet, smartphone, etc.), operating system specification (e.g., brand/or type and version, such as Windows® 7, Android™ 3.0, etc.), device hardware or software specification (e.g., RAM, hard disk, Internet browser, etc.), user or subscriber 102 and/or data, information, and/or attributes relating thereto such a target demographic, an industry segment (e.g., consumer, small and medium business (SMB), enterprise, healthcare, government, financial, legal, etc.), and so on, geographical region, referral source, and the like, etc.

As can be understood, such analyses and/or other functions as can be provided by analysis component 408 can be employed by one or more of users or subscribers 102, third parties and/or networks 802, participating third parties and/or networks 902, ISPP 104, and/or others, for example, to facilitate various operations, within ISPP 104, or otherwise, such as: creating, modifying, and/or studying one or more of polls, poll results, and/or poll questions; observing, measuring, and/or reporting on behavior, performance, and/or return on investment in ISPP 104; determining and/or improving poll targeting (e.g., identifying target demographics and/or other attributes of interest in poll targeting, and so on, etc.); guiding and/or crafting analyses (e.g., such as suggesting particular analysis techniques, offering tutorials, performing automated and/or semi-automated analyses, and so on, etc.); determining and/or identifying weaknesses and/or other areas of unreliability in polls, poll questions, and/or poll sample sizes; analyzing, identifying, and/or determining whether one or more poll responses are suspect, questionable, and/or disingenuous (e.g., such as by employing one or more algorithms to identify automated, semi-automated, and/or computer-generated responses, based in part on a time or frequency based analysis, on cross-referencing with known good polling data, behavioral analysis for one or more users or subscribers 102, on a network traffic analysis, and so on, etc.).

In various non-limiting implementations including analysis component 408, it can be understood that analysis of data and/or information associated with ISPP 104 can be facilitated by ISPP 104 providing access to one or more of communication components 108, user interface components 110, system management layer 114, and or system components 116, and so on. In addition, as user or subscriber 102 base grows over time, data and/or information associated with ISPP 104 will expand virtually limitlessly, thereby providing more valuable information and opportunities for monetization, marketing, etc. As a result, analysis component 408 can facilitate analyzing virtually any of the data and/or information associated with ISPP 104 and can facilitate providing summary information therefor. In further non-limiting embodiments analysis component 408, in conjunction with, in lieu of, in addition to, and/or complementary to one or more of the other system components 116 can facilitate indexing polling data by any search parameter. In still other exemplary embodiments of ISPP 104, analysis component 408, in conjunction with, in lieu of, in addition to, and/or complementary to one or more of the other system components 116 can employ techniques and technologies appropriate for the storage, indexing, cross-referencing, searching, customization, analysis, and so on, of large and/or complex data sets, colloquially referred to as “big data” technology. For instance, suitable technologies that can be employed by analysis component 408, in conjunction with, in lieu of, in addition to, and/or complementary to one or more of the other system components 116 can include, without limitation, simulation, time series analysis and visualization, crowd sourcing, machine learning, natural language processing, neural networks, pattern recognition, predictive modeling, regression, signal processing, massively parallel-processing (MPP) databases, search-based applications, data-mining grids, supervised and unsupervised learning, distributed file systems, distributed databases, cloud computing platforms, and scalable storage systems, and so on, etc.

Accordingly, analysis component 408 can be configured to be accessed by one or more of users or subscribers 102, third parties and/or networks 802, participating third parties and/or networks 902, and be further configured to facilitate one or more analyses and/or other functions as described herein. Moreover, any of the components described herein (e.g., analysis component 408, and so on, etc.) can be configured to perform the described functionality (e.g., via computer-executable instructions stored in a tangible computer readable medium, and/or executed by a computer, a processor, etc.). For instance, an exemplary non-limiting implementation of ISPP 104 can comprise a memory or other tangible computer-readable medium to store computer-executable components (e.g., analysis component 408, and so on, etc.) and a processor communicatively coupled to the memory or other computer-readable medium (e.g., one or more host processors 1010, and so on, etc.) that can facilitate execution of the computer-executable components. As a non-limiting example, an exemplary non-limiting implementation of ISPP 104 can comprise a analysis component 408 configured to identify and/or recommend (e.g., to one or more of user or subscriber 102, third parties and/or networks 802, participating third parties and/or networks 902, and so on, etc.) the attribute associated with poll targeting to facilitate creation of the targeted poll, as further described herein (e.g., such as regarding attributes associated with poll targeting comprising data and/or information concerning the potential respondent, and so on, etc.).

Referring again to FIG. 10, according to further non-limiting implementations, ISPP 104 comprising device or system 1000, or portions thereof, can also include one or more of publication component 1022 and/or social component 620, or portions thereof, that can facilitate publishing, sharing, and/or otherwise socializing one or more polls (e.g., releasing a created poll for responses from one or more users or subscribers 102, inviting friends, followers, customers, and/or affiliates to respond to a poll, or otherwise indicating interest in one or more of polls, poll results, and/or analyses, viewing polls, poll results, analyses, and/or other poll-related information, reviewing personal responses, comments, etc.). For instance, once a poll is created (e.g., via poll creation component 602, or otherwise), ISPP 104 comprising publication component 1022 can facilitate publishing the poll (e.g., to users or subscribers 102, friends, followers, customers, and/or affiliates within ISPP 104, or otherwise, such as within third parties and/or networks 802), as described herein. In a further non-limiting example, ISPP 104 can facilitate poll creation in advance of publishing, such as by facilitating saving of drafts or other works in progress of polls, or other works (e.g., one or more of analyses, reports, etc.) for concurrent and/or future publication.

In yet another non-limiting example, ISPP 104 comprising social component 620, for example, can facilitate various operations with respect to the social aspects of ISPP 104. As non-limiting examples, social component 620 can facilitate sharing and/or socializing polls (or other data or information) including, but not limited to, sharing and/or publishing polls, sharing and/or publishing results, sharing and/or publishing responses, sharing and/or publishing insights into poll results and/or analyses (e.g., trends in poll results, identified demographics of interest, etc.), creating personal social networks from subsets of the network participants (e.g., users or subscribers 102), and/or conducting personalized polls, and so on, etc. To these and related ends, one or more of host processors 1010 can be associated with one or more of publication component 1022 and/or social component 620 to facilitate functionality described herein.

For instance, as further described herein regarding FIGS. 2-9 (e.g., regarding one or more of monetization component 410, marketing component 618, promotion and/or cross-promotion component 702, connector component 704, and/or rewards component 904, and so on, etc.), for example, ISPP 104 can facilitate various operations, such as: instantiating and/or combining marketing efforts associated with sharing and/or publishing of, and/or responding to, polls (e.g., product, service, poll, or other promotion or cross-promotion, disseminating information regarding rewards, coupons, and/or other incentives, providing poll respondent compensation, etc.); promoting use of ISPP 104, its users or subscribers 102, and/or products, services, and/or polls or poll results associated therewith; sharing, publishing, and/or socializing any of the aforementioned (e.g., sharing of polls, poll results, analyses, and so on, following and/or subscribing to users or subscribers 102, polls, poll results, analyses, and so on, garnering followers, users or subscribers 102, as well as other aspects associated with social media, etc.); sharing and/or publishing of content (e.g., polls, results, analyses, etc.) of ISPP 104 to other networks not associated with ISPP 104, whether the networks are affiliated with or unaffiliated with ISPP 104; and/or other interactions of user or subscriber 102 with ISPP 104, for example, without limitation.

In a further non-limiting example, as further described herein, one or more of promotion or cross-promotion component 702 and/or connector component 704 can enable a user or subscriber 102 (or third parties and/or networks 802, participating third parties and/or networks 902, etc.) to publish, share and/or socialize various data and/or information associated with ISPP 104 (e.g., polls, results, responses, analyses, reward programs, incentives, etc.), either within ISPP 104 (e.g., on user's or subscriber's 102 home page), in addition to publishing, sharing and/or socializing to one or more other computing systems (e.g., computing systems associated with other social media accounts, etc.), or a combination thereof, as previously described. In a further non-limiting example, a connector component 704 can facilitate linking (e.g., sharing, communicating, transmitting, and/or receiving various data, such as friends, followers, polls, responses, and/or other activities within either ISPP 104 or social media networks, and so on, whether unilaterally, bilaterally, or otherwise, etc.) ISPP 104 with other computing systems, such as social medial networks, and so on, etc.

Accordingly, ISPP 104 comprising device or system 1000, or portions thereof, including one or more of publication component 1022, social component 620, and/or connector component 704, or portions thereof, can facilitate employing any of a number, type, and/or category of information, data, and/or other functions as can be provided by one or more of poll creation component 602, monetization component 410, marketing component 618, promotion and/or cross-promotion component 702, connector component 704, and/or rewards component 904 (or other components or portions thereof), for example, to facilitate publishing, sharing, and/or socializing information and/or data associated with ISPP 104. In addition, any of the components described herein (e.g., one or more of publication component 1022, social component 620, and so on, etc.) can be configured to perform the described functionality (e.g., via computer-executable instructions stored in a tangible computer readable medium, and/or executed by a computer, a processor, etc.). For instance, an exemplary non-limiting implementation of ISPP 104 can comprise a memory or other tangible computer-readable medium to store computer-executable components (e.g., social component 620, and so on, etc.) and a processor communicatively coupled to the memory or other computer-readable medium (e.g., one or more host processors 1010, and so on, etc.) that can facilitate execution of the computer-executable components. As a non-limiting example, an exemplary non-limiting implementation of ISPP 104 can comprise a social component configured to allow the potential respondent (e.g., one or more users or subscribers 102, etc.) to share the targeted poll with one or more other potential respondent (e.g., one or more users or subscribers 102, etc.) associated with the polling system (e.g., ISPP 104) or another computing system (e.g., such as a computing system associated with social networking, etc.), as further described herein.

According to further non-limiting implementations, ISPP 104 comprising device or system 1000, or portions thereof, can also include monetization component 410 that can facilitate monetization objectives and/or functions associated with ISPP 104, such as: instantiating and/or combining marketing efforts associated with sharing and/or publishing of, and/or responding to, polls (e.g., product, service, poll, and/or other promotion or cross-promotion, disseminating information regarding rewards, coupons, and/or other incentives, providing poll respondent compensation, etc.); promoting use of ISPP 104, its users or subscribers 102, and/or products, services, and/or polls or poll results associated therewith; sharing, publishing, and/or socializing any of the aforementioned (e.g., sharing of polls, poll results, analyses, and so on, following and/or subscribing to users or subscribers 102, polls, poll results, analyses, and so on, garnering followers, users or subscribers 102, as well as other aspects associated with social media, etc.); sharing and/or publishing of content (e.g., polls, results, analyses, etc.) of ISPP 104 to other networks not associated with ISPP 104, whether the networks are affiliated with or unaffiliated with ISPP 104; targeting advertising based in part on user profile information, search history, poll interests, poll responses, recognized trends within ISPP 104, and/or other interactions of user or subscriber 102 with ISPP 104, for example, without limitation. To these and related ends, one or more of host processors 1010 can be associated with monetization component 410 to facilitate functionality described herein.

Accordingly, ISPP 104 comprising device or system 1000, or portions thereof, including monetization component 410, can facilitate employing any of a number, type, and/or category of information, data, and/or other functions as can be provided by one or more of profile management component 612, privacy and/or control component 1014, storage component 606, catalog component 616, data organization component 1020, analysis component 408, (or other components or portions thereof), for example, to facilitate monetization objectives and/or functions of ISPP 104. In the non-limiting example described above, one or more polls, results, and/or analyses may support an inference that a particular fashion trend is very popular. Non-limiting aspects of ISPP 104 can facilitate trend recognition and/or inference (e.g., via analysis component 408, etc.), from which ISPP 104 can further facilitate marketing and/or promoting a popular line of fashion (e.g., via identification of and affiliation with third party entities, such as manufacturers, wholesaler, retailers, etc., interested in targeted advertising, poll sponsorship, incentivizing user or subscriber 102 participation in ISPP 104, and/or other marketing opportunities, etc.), based in part on users' or subscribers' 102 privacy settings, ISPP 104 policies, and/or other related agreements between and/or among any of user or subscriber 102, ISPP 104, or such third parties. In another non-limiting example described above, ISPP 104 can facilitate offering a coupon for a product associated with the trend, a reward (e.g., points or other incentives, etc.), for responding to the poll that supports the inference of the fashion trend.

Moreover, any of the components described herein (e.g., one or more of monetization component 410, profile management component 612, privacy and/or control component 1014, storage component 606, catalog component 616, data organization component 1020, analysis component 408, and so on, etc.) can be configured to perform the described functionality (e.g., via computer-executable instructions stored in a tangible computer readable medium, and/or executed by a computer, a processor, etc.). For instance, an exemplary non-limiting implementation of ISPP 104 can comprise a memory or other tangible computer-readable medium to store computer-executable components (e.g., monetization component 410, and so on, etc.) and a processor communicatively coupled to the memory or other computer-readable medium (e.g., one or more host processors 1010, and so on, etc.) that can facilitate execution of the computer-executable components. As a non-limiting example, an exemplary non-limiting implementation of ISPP 104 can comprise a monetization component 410 configured to provide data associated with the targeted poll to the poll sponsor (e.g., one or more users or subscribers 102, third parties and/or networks 802, participating third parties and/or networks 902, and so on, etc.) based in part on the sponsorship, as further described herein. In a further non-limiting example, an exemplary non-limiting implementation of ISPP 104 including a monetization component 410 can be further configured to provide data associated with the targeted poll to entities (e.g., one or more users or subscribers 102, third parties and/or networks 802, participating third parties and/or networks 902, and so on, etc.) other than the poll sponsor (e.g., one or more users or subscribers 102, third parties and/or networks 802, participating third parties and/or networks 902, and so on, etc.), as further described herein. For instance, one or more system components 116 (e.g., one or more of profile management component 612, privacy and/or control component 1014, storage component 606, catalog component 616, search component 614, poll creation component 602, poll execution component 1018, poll data format component 604, data organization component 1020, analysis component 408, publication component 1022, social component 620, monetization component 410, marketing component 618, promotion and/or cross-promotion component 702, connector component 704, and/or rewards component 904, and so on, etc.) can be configured to provide data and/or information associated with polling within an ISPP 104, such as, providing via analysis component 408 customized and/or customizable polling results, which can be made available (e.g., via subscription, fee, bounty, onetime payment, free, or otherwise, and so on, etc.) from consumers of such data and/or information (e.g., individuals, organizations, businesses, etc.), for example, without limitation.

According to further non-limiting implementations, ISPP 104 comprising device or system 1000, or portions thereof, can also include marketing component 618 that can facilitate achieving marketing objectives and/or functions associated with ISPP 104, such as: instantiating and/or combining marketing efforts associated with publishing of, and/or responding to, polls (e.g., product, service, poll, or other promotion or cross-promotion, disseminating information regarding rewards, coupons, and/or other incentives, providing poll respondent compensation, etc.); promoting use of ISPP 104, its users or subscribers 102, and/or products, services, and/or polls or poll results associated therewith; sharing and/or socializing any of the aforementioned (e.g., sharing of polls, poll results, analyses, and so on, following and/or subscribing to users or subscribers 102, polls, poll results, analyses, and so on, garnering followers, users or subscribers 102, as well as other aspects associated with social media, etc.); publishing of content (e.g., polls, results, analyses, etc.) of ISPP 104 to other networks not associated with ISPP 104, whether the networks are affiliated with or unaffiliated with ISPP 104; targeting advertising based in part on user profile information, search history, poll interests, poll responses, recognized trends within ISPP 104, and/or other interactions of user or subscriber 102 with ISPP 104, for example, as well as other marketing activities (e.g., advertisement placement, poll promotion, and so on, etc.), without limitation, either in lieu of, or complementary to functions associated with monetization component 410. To these and related ends, one or more of host processors 1010 can be associated with marketing component 618 to facilitate functionality described herein.

Thus, ISPP 104 comprising device or system 1000, or portions thereof, including marketing component 618, can facilitate employing any of a number, type, and/or category of information, data, and/or other functions as can be provided by profile management component 612, privacy and/or control component 1014, storage component 606, catalog component 616, data organization component 1020, analysis component 408, monetization component 410 (or other components or portions thereof), for example, to facilitate achieving marketing objectives and/or functions associated ISPP 104. For instance, non-limiting aspects of ISPP 104 can facilitate trend recognition and/or inference (e.g., via analysis component 408, and so on, etc.), from which ISPP 104 can further facilitate marketing and/or promoting products and/or services (e.g., via identification of and affiliation with third party entities, such as manufacturers, wholesaler, retailers, etc., interested in targeted advertising, poll sponsorship, incentivizing user or subscriber 102 participation in ISPP 104, and/or other marketing opportunities, etc.), based in part on users' or subscribers' 102 privacy settings, ISPP 104 policies, and/or other related agreements between and/or among any of user or subscriber 102, ISPP 104, or such third parties, without limitation, either in lieu of, or complementary to functions associated with monetization component 410, or other components, for example. Moreover, any of the components described herein (e.g., one or more of marketing component 618, profile management component 612, privacy and/or control component 1014, storage component 606, catalog component 616, data organization component 1020, analysis component 408, monetization component 410, and so on, etc.) can be configured to perform the described functionality (e.g., via computer-executable instructions stored in a tangible computer readable medium, and/or executed by a computer, a processor, etc.).

Referring again to FIG. 10, in other non-limiting implementations, ISPP 104 comprising device or system 1000, or portions thereof, can also include one or more of promotion and/or cross-promotion component 702 and/or connector component 704, or portions thereof, that can facilitate users or subscriber s 102 publishing, sharing, and/or socializing various data associated with ISPP 104 (e.g., polls, results, responses, analyses, reward programs, incentives, etc.), either within ISPP 104 (e.g., on user's or subscriber's 102 home page) in addition to publishing, sharing and/or socializing to one or more other social media accounts, or a combination thereof, as previously described. In a further non-limiting example, a connector component 704 can facilitate linking (e.g., sharing, communicating, transmitting, and/or receiving various data, such as friends, followers, polls, responses, analyses, and/or other activities within either ISPP 104 or social media networks, and so on, whether unilaterally, bilaterally, or otherwise, etc.) ISPP 104 with other computing systems, such as social medial networks, and so on, etc. In another non-limiting example, promotion or cross-promotion component 702 can facilitate instantiating and/or combining marketing efforts associated with publishing of, and/or responding to, polls (e.g., product, service, poll, or other promotion or cross-promotion, disseminating information regarding rewards, coupons, and/or other incentives, providing poll respondent compensation, etc.), promoting use of ISPP 104, its users or subscribers 102, and/or products, services, and/or polls or poll results associated therewith, promotion of other networks, data, products, or services, whether related to social media or otherwise, and so on, via connector component 704, for example, or otherwise (e.g., whether via ISPP 104 functionality or otherwise, etc.).

Accordingly, one or more of host processors 1010 can be associated with one or more of promotion and/or cross-promotion component 702 and/or connector component 704, portions thereof, to facilitate functionality described herein. Thus, ISPP 104 comprising device or system 1000, or portions thereof, including promotion and/or cross-promotion component 702, can facilitate employing any of a number, type, and/or category of information, data, and/or other functions as can be provided by profile management component 612, privacy and/or control component 1014, storage component 606, catalog component 616, data organization component 1020, analysis component 408, (or other components or portions thereof), for example, to facilitate functions and/or objectives associated with one or more of promotion and/or cross-promotion component 702 and/or connector component 704, as described herein, regarding FIGS. 7-8, for example. As a non-limiting illustration, a user or subscriber 102 can leverage ISPP 104 non-limiting aspects directed to business and/or promotion, and so on. Thus, ISPP 104, according to non-limiting aspects, can comprise one or more of promotion or cross-promotion component 702 and/or connector component 704, which can facilitate connecting to one or more third parties and/or networks 802 (e.g., for the purpose of transmission and/or sharing of data associated with one or more goals of ISPP 104 and/or third parties and/or networks 802, etc.), as described above.

In other examples, such data can be shared and/or transmitted to promote one or more business objectives associated with ISPP 104, third parties and/or networks 802, and so on. Accordingly, sharing and/or transmitting ISPP 104 data with one or more third parties and/or networks 802 (e.g., a business entity, social media company, etc.) can facilitate combining information from ISPP 104 and one or more other sources to provide enhanced data sources, analytical capabilities, improved insights, and so on, which, in turn, can enable third parties and/or networks 802 to enhance their online presence. In yet another non-limiting example, a company that is seeking to promote its products or services (e.g., such as to conduct market research, to elicit community feedback, or otherwise, etc.) can add itself as a user or subscriber 102 to ISPP 104, to conduct polling activities, for instance. As described above, regarding FIG. 8, for example, such polling activities (e.g., including targeted polling and/or incentivized polling, such as offering and/or transmitting rewards, etc.) can be combined with targeted advertising and/or product promotion, stimulating brand and/or customer loyalty, real-time polling, sales promotions, etc.

In still other non-limiting examples as described above, regarding FIG. 8, for instance, ISPP 104 comprising one or more of promotion or cross-promotion component 702 and/or connector component 704, or portions thereof, can facilitate connecting to one or more third parties and/or networks 802 (e.g., for the purpose of transmission and/or sharing of information and/or data associated with one or more goals of ISPP 104 and/or third parties and/or networks 802, etc.). It can be appreciated that, according to a non-limiting aspect, the one or more third parties and/or networks 802 can be disparate from a user or subscriber 102, as well as being one or more users or subscribers 102. As further described above, ISPP 104 comprising one or more of a promotion or cross-promotion component 702 and/or connector component 704 can enable a user or subscriber 102 to share and/or socialize various information and/or data associated with ISPP 104 (e.g., polls, results, responses, analyses, reward programs, incentives, etc.). For instance, ISPP 104 comprising connector component 704, according to further non-limiting aspects, can facilitate leveraging data and/or information associated with ISPP 104 from within MIS software and/or other software platforms or systems (e.g., e-commerce systems, etc.) to fully utilize information and/or data associated with ISPP 104.

A non-limiting example of ISPP 104 comprising connector component 704 can facilitate sharing of data and/or information associated with ISPP 104 with one or more MIS software platforms to enable leveraging such data and/or information for a company as user or subscriber 102 (or as one or more third parties and/or networks 802) to employ in timely and relevant business decision-making, according to a further non-limiting aspect. In addition, ISPP 104 can enable a company as user or subscriber 102 (or as one or more third parties and/or networks 802) to leverage information and/or data associated with ISPP 104 to enhance a business' social relevancy (e.g., raise awareness, raise esteem on cultural issues such as environmental awareness, customer focus, customer service, etc.), presence, brand recognition, and so on. Further exemplary aspects of ISPP 104 comprising one or more of promotion or cross-promotion component 702 and/or connector component 704, or portions thereof, are described above, regarding FIG. 8, for example.

For instance, an exemplary implementation of ISPP 104 comprising one or more of promotion or cross-promotion component 702 and/or connector component 704, can facilitate connecting to one or more third parties and/or networks 802 (e.g., for the purpose of transmission or sharing of data associated with one or more goals of ISPP 104 and/or third parties and/or networks 802, etc.), as described above. In an exemplary implementation, data and/or information associated with ISPP 104 can be shared with other networks, (e.g., such as social media networks, news networks, search networks, etc.) and/or third parties, (e.g., individuals, political organizations, public polling organizations, private polling organizations, universities, and so on, etc.). As described above, ISPP 104 comprising, for example, connector component 704 or other components as described herein, can facilitate developing hybrid web applications or “mashups,” populating such hybrid web applications with information and/or data associated with ISPP 104, and/or combining functionality from one or more sources in addition to functionality associated with ISPP 104 to create compound applications or services, and so on, etc., as further described herein, regarding system management layer 114, as a non-limiting example.

For instance, an exemplary embodiment of ISPP 104 comprising, for example, connector component 704 or other components as described herein, can facilitate exposing one or more of APIs, data sources, functionality, and so on, etc. associated with ISPP 104. To that end, further non-limiting implementations of ISPP 104 can comprise one or more APIs that can expose data and/or functionality associated with one or more system components 116. Moreover, any of the components described herein (e.g., one or more of cross-promotion component 702, connector component 704, and so on, etc.) can be configured to perform the described functionality (e.g., via computer-executable instructions stored in a tangible computer readable medium, and/or executed by a computer, a processor, etc.). For instance, an exemplary non-limiting implementation of ISPP 104 can comprise a memory or other tangible computer-readable medium to store computer-executable components (e.g., connector component 704, and so on, etc.) and a processor communicatively coupled to the memory or other computer-readable medium (e.g., one or more host processors 1010, and so on, etc.) that can facilitate execution of the computer-executable components. As a non-limiting example, an exemplary non-limiting implementation of ISPP 104 can comprise a connector component 704 configured to allow communications between the polling system and another computing system (e.g., another computing system such as an advertising computer system, a market research computing system, an electronic commerce computing system, a computing system associates with a management information system, a search provider computer system, and/or a social networking computer system, and so on, etc.), as further described herein.

According to yet other exemplary implementations, ISPP 104 comprising device or system 1000, or portions thereof, can also include rewards component 904 that can facilitate implementing a point reward system, as well as other rewards systems. To these and related ends, one or more of host processors 1010 can be associated with rewards component 904 to facilitate functionality described herein. For instance, in an exemplary implementation of ISPP 104 comprising rewards component 904 that can facilitate a reward and/or point system, a predetermined amount of points can be awarded to a user or subscriber 102 (e.g., after a user or subscriber 102 responds to a poll, in response to user's or subscriber's 102 poll socializing activities that promote goals or objectives of ISPP 104, etc.) based in part activities, either within ISPP 104, or otherwise, that promote goals and/or objectives associated with ISPP 104, such as: responding to a poll (e.g., such as a poll sponsored by a poll sponsor, etc.); sharing a poll with a predetermined number of users or subscribers 102 within the user's or subscriber's 102 friends or followers network, which predetermined number of users or subscribers 102 also respond to the poll, completing poll analysis challenges or other challenges, responding to a predetermined number of polls; fulfilling various threshold levels of registration or membership level requirements, such as completion and/or verification of one or more user or subscriber 102 profile information data points and/or attributes, which can reliably increase the trustworthiness that the data points and/or attributes place the user or subscriber 102 into a particularly desirable demographic, promotion of ISPP 104, such as invitations, referrals, and/or attracting new users or subscribers 102 to ISPP 104; and/or fulfilling marketing or other advertising objectives within ISPP 104, such as viewing advertisement presentations including videos, or otherwise, completing advertising offers, making one or more purchases within ISPP 104, such as within an ISPP 104 mobile device supported application, and so on, etc.

Accordingly, ISPP 104 comprising device or system 1000, or portions thereof, including rewards component 904, can facilitate employing any of a number, type, and/or category of information, data, and/or other functions as can be provided by profile management component 612, privacy and/or control component 1014, storage component 606, catalog component 616, data organization component 1020, analysis component 408, (or other components or portions thereof) for example, to facilitate one or more reward systems that promote goals and/or objectives of ISPP 104 and/or functionality associated therewith. Thus, in a particular non-limiting implementation, ISPP 104 comprising rewards component 904, or portions thereof, can facilitate a point and/or reward system that, when a user or subscriber 102 authenticates and/or updates the user's or subscriber's 102 profile at 906, ISPP 104 can determine what predetermined amount of reward and/or points to be awarded to user or subscriber 102, based in part on activities of user or subscriber 102 within ISPP 104, on ISPP 104 sponsorship levels by participating third parties and/or networks 902, on ISPP 104 objectives and/or goals, and so on, etc.

Thus, in further exemplary implementations of ISPP 104 comprising rewards component 904, or portions thereof, that facilitates a reward and/or point system, a user or subscriber 102 can receive a predetermined amount of rewards and/or points at 908 according to the foregoing and/or other considerations. In other non-limiting examples, ISPP 104 comprising rewards component 904, or portions thereof, in the context of a point reward system, can facilitate user or subscriber 102 using points to create polls (e.g., in an instance where user or subscriber 102 would otherwise sponsor a poll is a participating third party or network 902, etc.), user or subscriber 102 sharing rewards and/or points with another user or subscriber 102, redeem rewards and/or points for products and/or other services (e.g., within ISPP 104, via participating third parties and/or networks 902, or otherwise, etc.), and so on.

In still further exemplary implementations, as previously mentioned, ISPP 104 comprising rewards component 904, or portions thereof, can facilitate providing users or subscribers 102 with virtually limitless options above a predetermined threshold as to the amount of personal information users or subscribers 102 choose to disclose to ISPP 104 and/or to third parties and/or networks 802, participating third parties and/or networks 902, and others, the control of the manner in which data associated with personal information can be published, shared, used in analysis, and so on, etc. For instance, in a another non-limiting aspect, ISPP 104 comprising rewards component 904, or portions thereof, can facilitate offering a predetermined amount of points and/or other rewards to users or subscribers 102 in exchange for certain amounts of personal information users or subscribers 102 disclose to ISPP 104 and/or to third parties and/or networks 802, participating third parties and/or networks 902, and others, etc. In another non-limiting aspect, ISPP 104 comprising rewards component 904, or portions thereof, can facilitate offering a predetermined amount of points and/or other rewards to users or subscribers 102 in exchange for relinquishing certain aspects of control of data associated with personal information and/or personal information relating to how such data or information can be published, shared, used in analysis, and so on, etc.

In still further non-limiting aspects, ISPP 104 comprising rewards component 904, or portions thereof, can facilitate implementing a tiered membership, for which users or subscribers 102 in more desirable tiers of membership can be made eligible for higher levels of points and/or rewards for subsequent activities within ISPP 104, for example, where such tiers (and associated points and/or rewards) are determined based in part on levels of disclosure of data and/or information associated with personal information and/or personal information, ability to verify and/or authenticate certain aspects of personal information (e.g., such as via a credit report verifying credit score, voter ID verifying political party identification and/or voting precinct, tax records verifying income level, home ownership status, and/or other information and/or data associated with financial demographics, and so on, etc.). In addition, ISPP 104 comprising one or more of profile management component 612, analysis component 408, monetization component 410 and/or rewards component 904, or other system components 116, or portions thereof, can facilitate providing access to (e.g., including periodic updates, daily updates, etc.) changes of data and/or information associated with ISPP 104. For instance, in a non-limiting example, ISPP 104 can provide updates on trends in data and/or information associated with ISPP 104 (e.g., hottest polls as regards network traffic, most controversial polls as regards ratings, reviews, or comments, and so on etc.). In yet another non-limiting example involving an exemplary ISPP 104 including one or more of profile management component 612, analysis component 408, monetization component 410 and/or rewards component 904, or other system components 116, or portions thereof, ISPP 104 can facilitate providing access to such data and/or information associated with ISPP 104, which can be made available (e.g., via subscription, fee, bounty, onetime payment, free, or otherwise, and so on, etc.) to consumers of such data and/or information (e.g., individuals, organizations, businesses, etc.), for example, without limitation. Thus, in further non-limiting implementations, ISPP 104 can facilitate providing access to data and/or information associated with ISPP 104, in exchange for compensation, or otherwise, in instances where such data and/or information associated with ISPP 104 might be reserved for the user or subscriber 102 that uploaded or created the poll. For instance, such data and/or information can include, without limitation demographics, time-related poll response and/or results, history of the poll (e.g., comments, feedback, ratings, and/or the like, etc.), and can include recommendations (e.g., via one or more of analysis component 408, monetization component 410 and/or rewards component 904, or other system components 116, or portions thereof, etc.) including how to exploit or otherwise employ such data and/or information.

Moreover, any of the components described herein (e.g., one or more of rewards component 904, profile management component 612, privacy and/or control component 1014, storage component 606, catalog component 616, data organization component 1020, analysis component 408, and so on, etc.) can be configured to perform the described functionality (e.g., via computer-executable instructions stored in a tangible computer readable medium, and/or executed by a computer, a processor, etc.). For instance, an exemplary non-limiting implementation of ISPP 104 can comprise a memory or other tangible computer-readable medium to store computer-executable components (e.g., rewards component 904, and so on, etc.) and a processor communicatively coupled to the memory or other computer-readable medium (e.g., one or more host processors 1010, and so on, etc.) that can facilitate execution of the computer-executable components. As a non-limiting example, an exemplary implementation of ISPP 104 can comprise a rewards component 904 configured to award, to a potential respondent (e.g., one or more users or subscribers 102, etc.), a reward and/or other incentive for responding to the targeted poll (or other activities within ISPP 104) based in part on sponsorship of the targeted poll by a poll sponsor (e.g., one or more users or subscribers 102, third parties and/or networks 802, participating third parties and/or networks 902, and so on, etc.), as described herein.

Referring again to FIG. 10, ISPP 104 comprising device or system 1000, or portions thereof, can also include system management layer 114, which can be associated with one or more host processors 1010, can facilitate various aspects of the disclosed subject matter, as described above. For instance, system management layer 114 can facilitate transmitting and/or receiving information and/or data that can be written to, stored in, and/or read from the storage component 606, can facilitate transmitting and/or receiving information and/or data between and/or among one or more of system components 116, as further described herein, and/or one or more components associated with user interface component 110, one or more communications components 108, and so on, and/or one or more host processors 1010, can facilitate control and/or execution of one or more of system components 116, and so on, etc. As a further non-limiting example, the system management layer 114 can facilitate transmitting data, information, and/or instructions between front-end system 106 and back-end system 112, can facilitate transmitting and/or receiving data, information, and/or instructions incident to various aspects and/or functionalities associated with ISPP 104, or otherwise, and the like, as further as described herein, for example, regarding FIGS. 2-9, etc. In a further non-limiting example involving an exemplary implementation of ISPP 104 comprising system management layer 114, or portions thereof, ISPP 104 can facilitate presenting actionable options (e.g., via, in lieu of, in addition to, and/or complementary to user interface component 110) to a user or subscriber 102 (or third parties and/or networks 802, participating third parties and/or networks 902, or others, etc.), for example, by identifying and/or determining options and/or activities available to user or subscriber 102 within ISPP 104, based in part on one or more of whether user or subscriber 102 (or others) has installed an appropriately configured app on a device associated with user or subscriber 102 (or others), whether user or subscriber 102 (or others) has registered for an account within ISPP 104, or otherwise, capabilities of one or more system components 116, and so on, etc.

In yet another non-limiting example in the context of hybrid web applications or “mashups,” system management layer 114 can facilitate using and/or combining data, information, and/or functionality associated with ISPP 104 (or components or portions thereof) with one or more other sources to create compound applications or services by providing one or more APIs associated with one or more system components 116, and by providing access to one or more information and/or data sources associated with ISPP 104. To these and related ends, further non-limiting implementations of ISPP 104 comprising system management layer 114 (or one or more system components 116), or portions thereof, can provide one or more APIs that can expose data, information, and/or functionality associated with the one or more system components 116 (e.g., one or more of host processor 1010, registration and/or authentication component 1012, profile management component 612, privacy and/or control component 1014, cryptographic component 1016, storage component 606, catalog component 616, search component 614, poll creation component 602, poll execution component 1018, poll data format component 604, data organization component 1020, analysis component 408, publication component 1022, social component 620, monetization component 410, marketing component 618, promotion and/or cross-promotion component 702, connector component 704, and/or rewards component 904, and so on, etc.), either as described above, or as further described herein.

It should be noted that, as depicted in FIG. 10, devices or systems 1000 are described as monolithic devices or systems. However, it is to be understood that the various components and/or the functionality provided thereby can be incorporated into one or more host processors 1010 or provided by one or more other connected devices. Accordingly, it is to be understood that more or less of the described functionality may be implemented, combined, and/or distributed (e.g., among network devices or systems, servers, databases, and the like), according to context, system design considerations, and/or marketing factors. Moreover, any of the components described herein can be configured to perform the described functionality (e.g., via computer-executable instructions stored in a tangible computer readable medium, and/or executed by a computer, a processor, etc.).

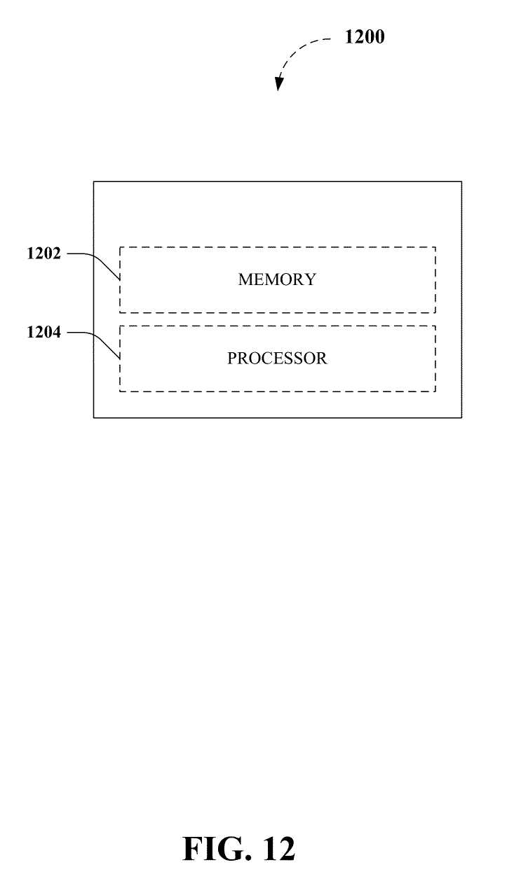

FIG. 11 illustrates an overview of an exemplary computing environment 1100 suitable for incorporation of embodiments of the disclosed subject matter. For example, computing environment 1100 can comprise wired communication environments, wireless communication environments, and so on. As a further example, computing environment 1100 can further comprise one or more of a wireless access component 1102, communications networks 1104, the Internet 1106, etc., with which a user or subscriber 102 can employ any of a variety of devices (e.g., device 1110, devices 1112-1122, and so on) comprising an appropriately configured application, or app 1108 (e.g., such as via an app appropriately configured for a specific device associated with user or subscriber 102, an app appropriately configured for a communications service carrier, such as described below with reference to FIGS. 12, 16-26, 29-30, and so on, etc.), or other functionality (e.g., browsers, clients, etc.) to communicate data and/or information over a communication medium (e.g., a wired medium 1122, a wireless medium, etc.) according to an agreed protocol, to facilitate communication of data and/or information associated with ISPP 104 between and/or among one or more of ISPP 104, user or subscriber 102, third parties and/or networks 802, and/or participating third parties and/or networks 902, and/or computing systems or devices associated therewith, such as device 1110, computing systems or devices 1124, 1126, and 1128, respectively (e.g., via an operating system, application software, device drivers, communications stacks, etc., which can perform such actions on behalf of such computing systems or devices). For instance, user interface component 110 can facilitate interaction between a user or subscriber 102 (e.g., via a device associated with user or subscriber 102, and so on, etc.), such as via a mobile device native app installed directly onto the device (e.g., smartphone, tablet, etc.) coded in its own native program language, and/or via a mobile web app (e.g., an Internet-enabled app, etc.) that has specific functionality for mobile devices and/or accessed through the mobile device's web browser, as described herein.

Thus, as described herein, in various non-limiting aspects, devices 1110 (e.g., comprising app 1108, or otherwise, and so on, etc.) employed in connection with ISPP 104 or functionalities thereof can facilitate determining whether an attribute is fulfilled based on a predetermined interval between an attribute associated with the user or subscriber 102 concerning time or space and information (e.g., information and/or data available via device 1110, and so on, etc.) associated with the user or subscriber 102 concerning time or space, respectively (e.g., where a spatial interval can be determined between a receiver, for example, and a device associated with user or subscriber 102, by comparison of location information associated with user or subscriber 102, such as is available from a global positioning system (GPS) receiver, from triangulation via multiple cellular base stations, NFC techniques, etc.; where a temporal interval can be determined based on a desirable time associated with targeted polling and a time associated with a user's or subscriber's 102 last activity of interest, for example, within ISPP 104; and so on; etc.). As a result, various non-limiting implementations of devices 1110 (e.g., comprising app 1108, or otherwise, and so on, etc.) can provide information associated with the user or subscriber 102 concerning one or more of time and/or space to consumers of such information (e.g., individuals, organizations, businesses, etc.), which can be made available (e.g., via subscription, fee, bounty, onetime payment, free, or otherwise, and so on, etc.) via ISPP 104, or otherwise.

In a non-limiting example, for a customer (e.g., user or subscriber 102, etc.) in front of store, inside a store, etc., ISPP 104 (e.g., according to one or more of a privacy and/or a profile setting, etc., that allows it), can facilitate sending reviews and/or data and/or information related to polling to a mobile device 1110 associated with the customer at a time and/or in a location that corresponds to information associated with the user or subscriber 102 concerning one or more of time and/or space (e.g., within a predetermined interval between an attribute associated with the customer and reviews and/or data and/or information related to polling concerning time or space and information (e.g., information and/or data available via device 1110, and so on, etc.) associated with the customer concerning time or space, respectively. Such information associated with the customer concerning time or space and devices 1110 (e.g., comprising app 1108, or otherwise, and so on, etc.) that can provide information associated with the customer concerning one or more of time and/or space can even be employed via ISPP 104 to provide information and/or data associated with ISPP 104 about products in front of a customer at a particular time (e.g., via NFC techniques, RFID techniques, QR Codes®, barcodes, voice recognition, facial recognition, or otherwise, and so on, etc.), without limitation, as further described herein. As a further non-limiting example, employing such information associated with the customer concerning time or space and devices 1110 (e.g., comprising app 1108, or otherwise, and so on, etc.) that can provide information associated with the customer concerning one or more of time and/or space can also include pushing time and/or location sensitive data and/or information to customers (e.g., user or subscriber 102, etc.) based on event based in part on one or more of event related information (e.g., a calendar associated with user or subscriber 102 indicates that the user or subscriber 102 is attending an event, such as being in a debate, a sales meeting, etc.), in addition to and/or in lieu of employing information associated with the customer concerning one or more of time and/or space that can support an inference that the user or subscriber 102 is attending the event.

Accordingly, computing environment 1100 can comprise a number of components to facilitate described functionalities according to various aspects of the disclosed subject matter, among other related functions. While various embodiments are described with respect to the components of computing environment 1100 and the further embodiments more fully described herein, one having ordinary skill in the art would recognize that various modifications could be made without departing from the spirit of the disclosed subject matter. Thus, it can be understood that the description herein is but one of many embodiments that may be possible while keeping within the scope of the claims appended hereto.

Additionally, while device 1110 is shown as a generic network capable device, which can include any of a variety of devices (e.g., device 1110, devices 1112-1122, and so on), device 1110 is intended to refer to a class of network capable devices that can one or more of receive, transmit, store, etc., data and or information incident to and that user or subscriber 102, ISPP 104, third parties and/or networks 802, and/or participating third parties and/or networks 902 can employ to facilitate various techniques of the disclosed subject matter. However, the discussion of the foregoing distinction is intended for illustration and not limitation. While for purposes of illustration, user or subscriber 102 is described as performing certain actions, it is to be understood that device 1110 (e.g., via an operating system, application software, device drivers, communications stacks, etc.) can perform such actions on behalf of user or subscriber 102. Similarly for third parties and/or networks 802 and/or participating third parties and/or networks 902, which can be discussed or described as performing certain actions, it is to be understood that computing systems or devices (e.g., 1126, 1128) associated with third parties and/or networks 802 and/or participating third parties and/or networks 902, respectively (e.g., via an operating system, application software, device drivers, communications stacks, etc.) can perform such actions on behalf of third parties and/or networks 802 and/or participating third parties and/or networks 902, respectively.

Accordingly, exemplary device 1110 can include, without limitation, a cellular phone 1112, a laptop computer 1114, a tablet personal computer (PC) device 1116, and/or a personal digital assistant (PDA) 1118, or other mobile device, and so on connected to a network via access component 1102 or otherwise. As further examples, device 1110 can include such devices as a network capable camera 1120 and other such devices (not shown) as a pen computing device, wearable computing device, portable digital music player, home entertainment devices, network capable devices, appliances, kiosks, and sensors, and so on. It is to be understood that device 1110 can comprise more or less functionality than those exemplary devices described above as the context requires and as further described herein in connection with FIGS. 1-10, 27-29, etc., for instance.

According to various embodiments of the disclosed subject matter, device 1110 can connect to other devices to facilitate accomplishing various functions as further described herein. In addition, device 1110 can connect via one or more communications networks 1104 to a wired network 1122 (e.g., directly, via the Internet 1106, or otherwise). Wired network 1122 (as well as communications network 1104) can comprise any number of computers, servers, intermediate network devices, and the like to facilitate various functions as further described herein. As a non-limiting example, wired network 1122 can include and/or be associated with computing systems or devices 1126 (e.g., one or more appropriately configured computing devices associated with, operated by, or operated on behalf of third parties and/or networks 802, etc.) as described above, that facilitates providing access to ISPP 104 for third parties and/or networks 802 to enable various operations as described herein. In yet other non-limiting implementations, ISPP 104 can facilitate various interactions and/or functionality as described herein, regarding FIGS. 4-10, etc.

In a further non-limiting example, wired network 1122 can include and/or be associated with computing systems or devices 1128 (e.g., one or more appropriately configured computing devices associated with, operated by, or operated on behalf of participating third parties and/or networks 902, etc.) as described above, that facilitates providing access to ISPP 104 for participating third parties and/or networks 902 to enable various operations as described herein. In still other non-limiting implementations, ISPP 104 can facilitate various interactions and/or functionality as described herein, regarding FIGS. 9-10, etc.

ISPP 104 can further include any number of intermediaries acting on behalf of one or more of users or subscribers 102, ISPP 104, third parties and/or networks 802, and/or participating third parties and/or networks 902, and so on, to facilitate various functions as further described herein. In a further non-limiting example, an intermediary acting on behalf of ISPP 104 could store and/or provide access to data and/or information associated with ISPP 104, to other computing systems (e.g., CRM platforms, MIS platforms, e-commerce systems, social media networks, news networks, search networks, etc.) and/or third parties, (e.g., individuals, political organizations, public polling organizations, private polling organizations, universities, and so on, etc.). Moreover, ISPP 104 can be further configured to perform any number of additional and/or complementary functions incident to functionalities as described above, regarding FIGS. 2-10, for example.

In addition, wired network 1122 or systems (or components) thereof can facilitate performing ancillary functions to accomplish various techniques described herein. For example, computing systems or devices 1126 (or 1128) associated with third parties and/or networks 802 (participating third parties and/or networks 902) can provide functions that facilitate authentication and/or authorization of one or more of users or subscribers 102, third parties and/or networks 802, participating third parties and/or networks 902, and/or others to ISPP 104, transmission of data and/or information associated with ISPP 104 (e.g., via an API, etc.) and/or other information associated with facilitating polling, and/or the use, consumption, socializing, and/or exploitation data and/or information associated therewith, etc. as described above. Accordingly, in various non-limiting embodiments of the disclosed subject matter, computing environment 1100 can further comprise additional network components (not shown). For example, systems, devices, and/or components can be relatively simplistic and/or lacking certain features to facilitate various techniques of the disclosed subject matter. Thus, particular aspects of the disclosed subject matter can be facilitated by additional network components (not shown) in communication with the devices and/or other components of computing environment 1100.

For instance, computing systems or devices 1126 associated with third parties and/or networks 802 can be capable of performing a number of functions as described above regarding ISPP 104, and/or computing systems or devices 1126 associated with third parties and/or networks 802, and functionality described above regarding computing systems or devices 1126 associated with third parties and/or networks 802 can likewise be provided by other components or devices associated with wired network 1122 (e.g., ISPP 104, computing systems or devices 1128 associated with participating third parties and/or networks 902, and/or others, or portions thereof, etc.). For example, functionality associated with ISPP 104 for providing one or more of analyses, inferences, or insights can be provided by one or more computing systems (not shown) that can be considered ancillary to, but associated with ISPP 104. In a further non-limiting example, functionality associated with ISPP 104 for search, monetization, promotion and/or cross-promotion, marketing, sharing, publishing, socializing, connecting to other parties and/or networks, advertising, and so on, without limitation, can be provided by one or more computing systems (not shown) that can be considered ancillary to, but associated with ISPP 104, computing systems or devices 1126 associated with third parties and/or networks 802, computing systems or devices 1128 associated with participating third parties and/or networks 902, etc. As a further example, data collected, transmitted, and/or received by a storage component 606 can be stored in an associated database system (not shown). As a further example, many of the analyses, reporting functions, and/or other information associated with one or more of analysis component 408, marketing component 618, rewards component 904, and so on, without limitation, can also be provided by associated systems such as CRM platforms, MIS platforms, and/or the like.

In addition, as previously described, one or more intermediaries (e.g., any of a number of MIS providers, e-commerce solution providers, and so on, etc.) acting on behalf one or more of user or subscriber 102, third parties and/or networks 802, and/or participating third parties and/or networks 902, can provide subsets of functionality such as described above regarding ISPP 104. In yet another example, while third parties and/or networks 802 or computing systems or devices 1126 associated with third parties and/or networks 802 can be capable of facilitating functions as previously described, third parties and/or networks 802 or computing systems or devices 1126 associated with third parties and/or networks 802 could also be functionally limited resulting in an inability to authenticate third parties and/or networks 802 or verify that access is authorized (e.g., verifying fulfillment of a specified authentication requirement) in embodiments that employ such techniques. Accordingly, computing environment 1100 can comprise such further components (not shown) (e.g., authentication, authorization and accounting (AAA) servers, e-commerce servers, database servers, application servers, etc.) in communication with one or more of ISPP 104, computing systems or devices 1126 associated with third parties and/or networks 802, computing systems or devices 1128 associated with participating third parties and/or networks 902, and/or user or subscriber 102 to accomplish the desired functions, without limitation.

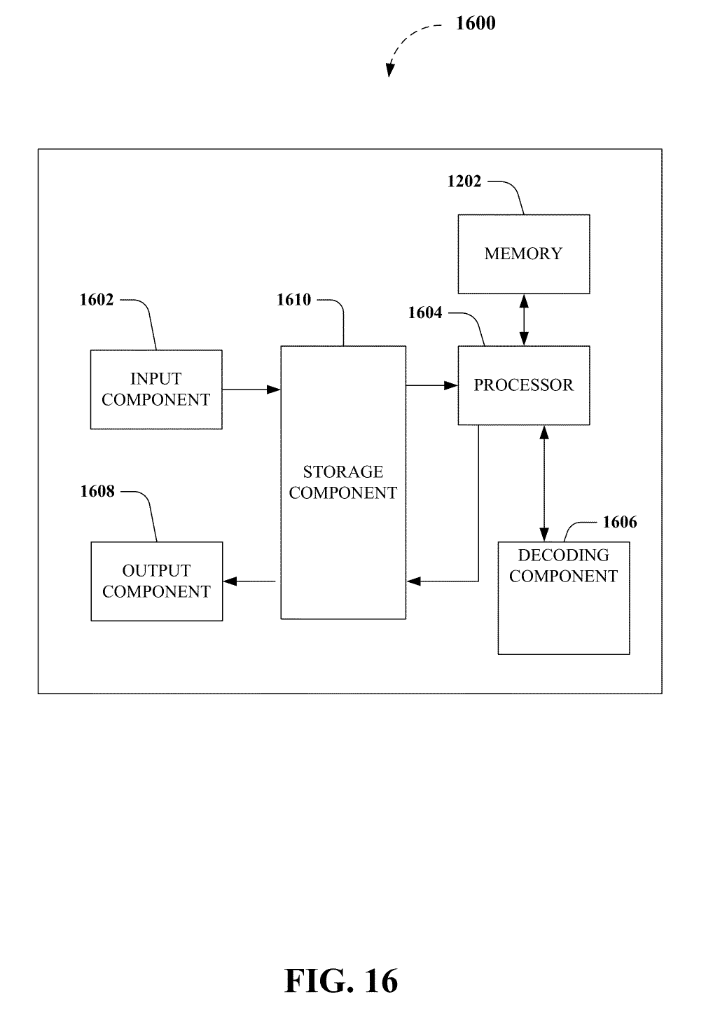

FIG. 12 illustrates an exemplary non-limiting device or system 1200 suitable for performing various aspects of the disclosed subject matter. The device or system 1200 can be a stand-alone device or a portion thereof, a specially programmed computing device or a portion thereof (e.g., a memory retaining instructions for performing the techniques as described herein coupled to a processor), and/or a composite device or system comprising one or more cooperating components distributed among several devices, as further described herein. As an example, exemplary non-limiting device or system 1200 can comprise exemplary devices and/or systems regarding FIGS. 10-11 as described above, or as further described below regarding FIGS. 16, 27-29, for example, or portions thereof. For example, FIG. 11 describes device 1110, associated with user or subscriber 102, which can comprise an appropriately configured application, or app (e.g., appropriately configured for a specific device, communications service carrier, etc.), such as app 1108.

Accordingly, device or system 1200 can include a memory 1202 that retains various instructions with respect to facilitating various operations, for example, such as: receiving a targeted poll based in part on a determination whether an attribute associated with a user or subscriber 102 of the computing device (e.g., device 1110, device 1200, device 1600, etc.) is fulfilled, wherein the attribute is specified for the targeted poll by a poll sponsor (e.g., user or subscriber 102, third parties and/or networks 802, participating third parties and/or networks 902, and so on, etc.); responding to the targeted poll; receiving an incentive based in part on responding to the targeted poll, sponsorship of the targeted poll by the poll sponsor, sharing the targeted poll, and so on; authorizing the transmitting or sharing of information associated with the user or subscriber 102 or the targeted poll based in part on one or more of a profile setting or a privacy setting associated with a social networking computing system; encryption; decryption; various user interfaces; and/or communications routines such as networking, social networking, and/or peer-to-peer communications routines, and/or the like.

For instance, device or system 1200 can include a memory 1202 that retains instructions for transmitting information to facilitate determining whether the attribute is fulfilled (e.g., age, income level, education level, sex, political partisan ID, registered voter status, likely voter status, a prior poll response date, a search query, location, technical competence, technical ability, referrer of the targeted poll, a number of followers, a number of shared polls, a number of completed polls, verification status of a subset of profile information, or computing device information associated with the user or subscriber 102, and so on, etc.). Additionally, memory 1202 can retain instructions for determining whether the attribute is fulfilled based on a predetermined interval between the attribute associated with the user or subscriber 102 concerning time or space and the information associated with the user or subscriber 102 concerning time or space, respectively (e.g., where a spatial interval can be determined between a receiver, for example, and a device associated with user or subscriber 102, by comparison of location information associated with user or subscriber 102, such as is available from a GPS receiver, from triangulation via multiple cellular base stations, NFC techniques, etc.; where a temporal interval can be determined based on a desirable time associated with targeted polling and a time associated with a user's or subscriber's 102 last activity of interest, for example, within ISPP 104; and so on; etc.).

In a further non-limiting example, FIG. 10 describes ISPP 104 and various components and functionality therefor, associated with interactions of user or subscriber 102, and others such as third parties and/or networks 802, participating third parties and/or networks 902, and so on, etc. Thus, in yet another non-limiting example, memory 1202 can retain instructions with respect to facilitating various operations, for example, such as: receiving, by a system (e.g., ISPP 104) including a processor (e.g., one or more host processors 1010), a request from a poll sponsor (e.g., user or subscriber 102, third parties and/or networks 802, participating third parties and/or networks 902, and so on, etc.) to create a targeted poll based in part on an attribute of a potential respondent (e.g., user or subscriber 102, etc.); to identify and/or recommend (e.g., to one or more of user or subscriber 102, third parties and/or networks 802, participating third parties and/or networks 902, and so on, etc.) the attribute associated with poll targeting to facilitate creation of the targeted poll; and/or determine, by the system (e.g., ISPP 104), whether the attribute of the potential respondent (e.g., user or subscriber 102, etc.) is satisfied by querying with a computer a data store (e.g., storage component 606, etc.) of potential respondents (e.g., users or subscribers 102, etc.) including determining based in part on a predetermined interval between a poll targeting attribute concerning time or space and the attribute of the potential respondent concerning time or space, respectively (e.g., where a spatial interval can be determined between a receiver, for example, and a device associated with user or subscriber 102, by comparison of location information associated with user or subscriber 102, such as is available from a GPS receiver, from triangulation via multiple cellular base stations, etc., where a temporal interval can be determined based on a desirable time associated with targeted polling and daytime associated with a user's or subscriber's 102 last activity, for example, within ISPP 104, and so on, etc.).

Additionally, memory 1202 can retain instructions for providing, by a system (e.g., ISPP 104), an incentive for responding to the targeted poll, based in part on determining whether the attribute of the potential respondent (e.g., user or subscriber 102, etc.) is satisfied, based in part on sponsorship of the targeted poll by the poll sponsor (e.g., user or subscriber 102, third parties and/or networks 802, participating third parties and/or networks 902, and so on, etc.); and/or presenting (e.g., via one or more of user interface component 110, poll execution component 1018, rewards component 904, and so on, etc.), by the system (e.g., ISPP 104), the targeted poll to the potential respondent including presenting the incentive with the targeted poll to the potential respondent (e.g., user or subscriber 102, etc.); encryption; decryption; various user interfaces; and/or communications routines such as networking, social networking, and/or peer-to-peer communications routines, and/or the like. In further non-limiting examples, memory 1202 can retain instructions for determining whether information associated with the potential respondent (e.g., user or subscriber 102) satisfies the attribute of the potential respondent (e.g., age, income level, education level, sex, political partisan ID, registered voter status, likely voter status, a prior poll response date, a search query, location, technical competence, technical ability, referrer of the targeted poll, a number of followers, a number of shared polls, a number of completed polls, verification status of a subset of profile information, and/or device information for a device associated with the potential respondent).

For instance, device or system 1200 can include a memory 1202 that retains instructions for transmitting, by the system (e.g., ISPP 104), data associated with the targeted poll to the poll sponsor (e.g., user or subscriber 102, third parties and/or networks 802, participating third parties and/or networks 902, and so on, etc.) based in part on the sponsorship. Additionally, memory 1202 can retain instructions for publishing the targeted poll to one or more other potential respondents (e.g., users or subscribers 102, etc.) based in part on a profile setting, a privacy setting, etc. associated with a computing system (e.g., ISPP 104, a social networking computing system, third parties and/or networks 802, participating third parties and/or networks 902, and so on, etc.).

The above example instructions and other suitable instructions for functionalities as described herein for example, regarding FIGS. 2-11 and 13-26, etc., can be retained within memory 1202, and a processor 1204 can be utilized in connection with executing the instructions.

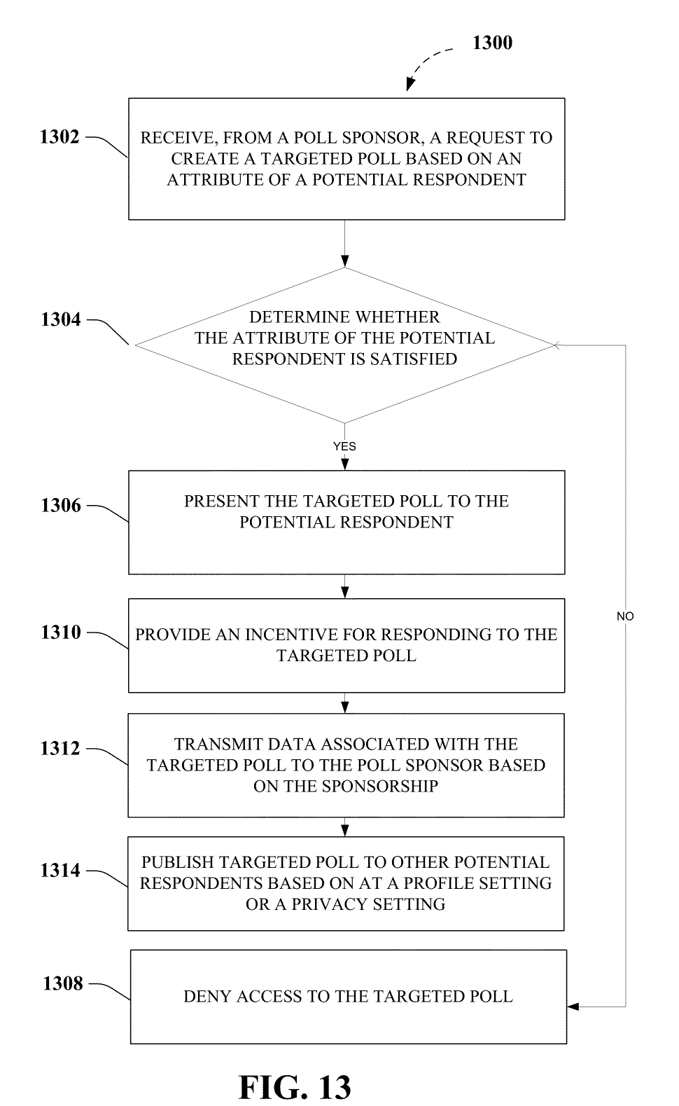

In view of the exemplary embodiments described supra, methods that can be implemented in accordance with the disclosed subject matter will be better appreciated with reference to the flowcharts of FIGS. 13-15. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methods described hereinafter. Additionally, it should be further understood that the methods and/or functionality disclosed hereinafter and throughout this specification are capable of being stored on an article of manufacture to facilitate transporting and transferring such methods to computers, for example, as further described herein. The terms computer readable medium, article of manufacture, and the like, as used herein, are intended to encompass a computer program accessible from any computer-readable device or media.

### Exemplary Methods

FIG. 13 illustrates an exemplary non-limiting flow diagram of methods 1300 for performing aspects of embodiments of the disclosed subject matter. For instance, referring to FIG. 13, methods 1300 can facilitate polling potential respondents (e.g., one or more users or subscribers 102, etc.), as described herein. As a non-limiting example, a request to create a targeted poll based in part on an attribute of a potential respondent (e.g., one or more users or subscribers 102, etc.) can be received at 1302, by a system (e.g., ISPP 104, etc.) including a processor (e.g., one or more host processors 1010, and so on, etc.) from a poll sponsor (e.g., one or more users or subscribers 102, third parties and/or networks 802, participating third parties and/or networks 902, and so on, etc.). For instance, as further described herein, regarding FIGS. 2-10, etc., for example, ISPP 104 can facilitate, at 1302, receiving a request to create a poll (e.g., via one or more of user interface component 110, system management layer 114, system components 116, and/or portions thereof, such as poll creation component 602, and so on, etc.), wherein one or more attributes can be specified to target the poll to potential respondents (e.g., one or more users or subscribers 102, etc.). In addition, methods 1300 can include identifying and/or recommending (e.g., to a poll sponsor such as one or more of users or subscribers 102, third parties and/or networks 802, participating third parties and/or networks 902, and so on, etc.) the attribute associated with poll targeting to facilitate targeting of the poll, as further described herein (e.g., such as regarding attributes associated with poll targeting comprising data and/or information concerning the potential respondent, and so on, etc.).

In a further non-limiting example, a determination can be made by the system (e.g., ISPP 104), at 1304, whether the attribute of the potential respondent (e.g., one or more users or subscribers 102, etc.) is satisfied by querying (e.g., via one or more of profile management component 612, privacy and/or control component 1014, catalog component 616, poll execution component 1018, and/or portions thereof, and so on, etc.) with a computer (e.g., one or more host processors 1010, and so on, etc.) a data store (e.g., one or more of storage component 606, storage component 1610, etc.) of potential respondents (e.g., one or more users or subscribers 102, etc.). For instance, such a determination can include determining whether the attribute of the potential respondent (e.g., one or more users or subscribers 102, etc.) is satisfied based in part on a predetermined interval between a poll targeting attribute concerning time or space and the attribute of the potential respondent concerning time or space, respectively (e.g., where a spatial interval can be determined between a receiver, for example, and a device associated with user or subscriber 102, by comparison of location information associated with user or subscriber 102, such as is available from a GPS receiver, from triangulation via multiple cellular base stations, NFC techniques, etc.; where a temporal interval can be determined based on a desirable time associated with targeted polling and a time associated with a user's or subscriber's 102 last activity of interest, for example, within ISPP 104; and so on; etc.).

In a further example, non-limiting implementations of methods 1300 can include determining whether the attribute of the potential respondent (e.g., one or more users or subscribers 102, etc.) is satisfied or fulfilled based in part on such attributes as, for example, one or more of age, income level, education level, sex, political partisan ID, registered voter status, likely voter status, a prior poll response date, a search query, location, technical competence, technical ability, referrer of the targeted poll, a number of followers, a number of shared polls, a number of completed polls, verification status of a subset of profile information, and/or device information (e.g., one or more of device type, device manufacturer, operating system, application, browser, length of device use, length of service use, length of application use, and/or version information, and so on, etc.) associated with a device (e.g., device 1110, etc.) associated with the potential respondent (e.g., one or more users or subscribers 102, on etc.).

In yet another example, for non-limiting implementations of methods 1300 that determine, at 1304, that the attribute of the potential respondent (e.g., one or more users or subscribers 102, etc.) is satisfied or fulfilled, then, at 1306, the targeted poll can be presented to the potential respondent (e.g., one or more users or subscribers 102, etc.) by the system (e.g., ISPP 104). For instance, non-limiting implementations of methods 1300 can also include presenting an incentive and/or other reward with the targeted poll to the potential respondent (e.g., one or more users or subscribers 102, etc.), as further described herein.

In still further examples, for non-limiting implementations of methods 1300 that determine, at 1304, that the attribute of the potential respondent (e.g., one or more users or subscribers 102, etc.) is not satisfied, then, at 1308, the potential respondent (e.g., one or more users or subscribers 102, etc.) can be denied access to the targeted poll, and/or other options can be presented or otherwise displayed by the system (e.g., ISPP 104), for example, such as identifying the attribute that is not satisfied, providing options to update and/or satisfy the attribute (e.g., via profile management component 612, privacy and/or control component 1014, monetization component 410, marketing component 618, promotion and/or cross-promotion component 702, rewards component 904, and/or portions thereof, and so on, etc.), and so on, as further described herein.

As described above, methods 1300 can further include, at 1310, providing, by the system, an incentive and/or other reward for responding to the targeted poll (and/or for other activities within ISPP 104, or otherwise), based in part on the determination at 1304. For instance, exemplary implementations of methods 1300 can also include providing an incentive and/or other reward based in part on sponsorship of the targeted poll by the poll sponsor (e.g., one or more users or subscribers 102, third parties and/or networks 802, participating third parties and/or networks 902, and so on, etc.), as further described herein, for example regarding FIGS. 4-10 (e.g., regarding one or more of monetization component 410, marketing component 618, promotion and/or cross-promotion component 702, connector component 704, rewards component 904, and so on, etc.).

In further non-limiting methods 1300, the methods can include transmitting, by the system, data and/or information associated with the targeted poll to the poll sponsor (e.g., one or more users or subscribers 102, third parties and/or networks 802, participating third parties and/or networks 902, and so on, etc.) based in part on the sponsorship, at 1312. For example, as an incentive for one or more users or subscribers 102 to respond to a targeted poll sponsored by a third party and/or network 802, rewards, such as points in a point system, or otherwise, can be offered to the one or more users or subscribers 102, for which the data associated with the targeted poll can be forwarded to the third party and/or networks 802 in exchange for such sponsorship of the targeted poll, as further described herein, for example regarding FIGS. 4-10 (e.g., regarding one or more of monetization component 410, marketing component 618, promotion and/or cross-promotion component 702, connector component 704, rewards component 904, and so on, etc.).

In a further example, methods 1300 can include, at 1314, publishing the targeted poll to one or more other potential respondents based in part on one or more of a profile setting (e.g., via one or more of profile management component 612, connector component 704, and so on, etc.) and/or a privacy setting (e.g., via one or more of privacy and/or control component 1014, connector component 704, and so on, etc.) associated with one or more of the system (e.g., ISPP 104) or another computing system (e.g., such as one or more of a social media network computing system, a news network computing system, a search network computing system, etc.), and/or one or more computing systems associated with third parties, (e.g., individuals, political organizations, public polling organizations, private polling organizations, universities, and so on, etc.), as further described herein, regarding FIG. 10, for example.

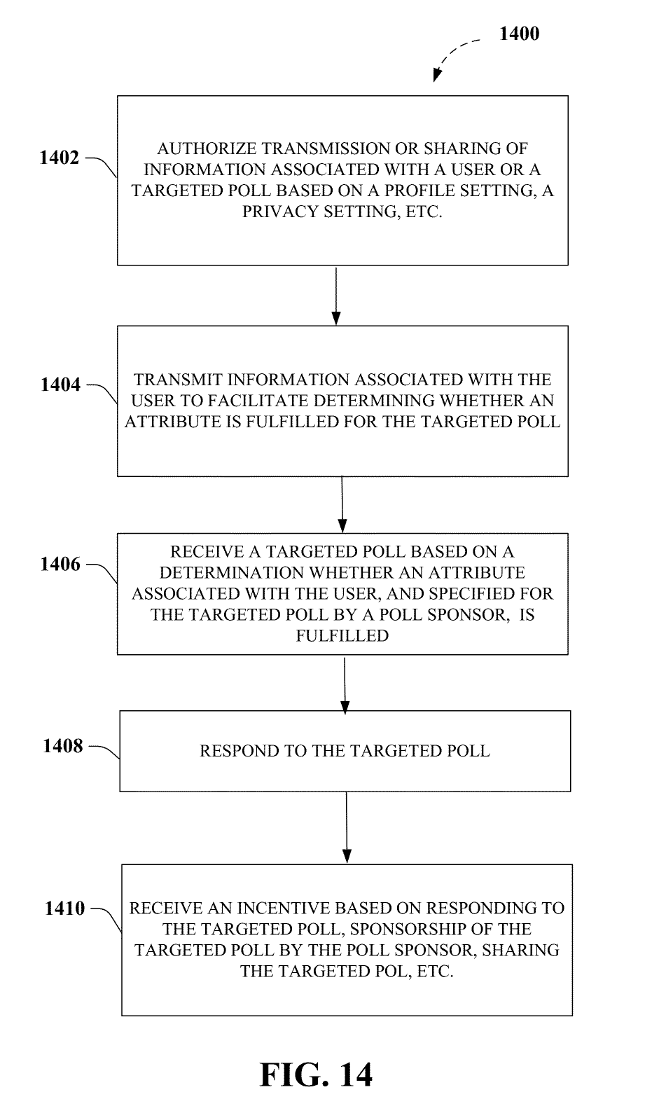

FIG. 14 illustrates an exemplary non-limiting flow diagram of methods 1400 for performing aspects of embodiments of the disclosed subject matter. For instance, referring to FIG. 14, methods 1400 can facilitate polling potential respondents (e.g., one or more users or subscribers 102, etc., via one or more devices associated therewith, such as device 1110, and so on, etc.), as described herein. As a non-limiting example, one or more users or subscribers 102, etc., can, at 1402, via a device (e.g., device 1110, device 1600, etc.) including a processor (e.g., one or more of processor 1204, processor 1604, and so on, etc.), authorize transmitting, sharing, and/or otherwise communicating data and/or information associated with the one or more users or subscribers 102, a targeted poll, and so on, based in part on one or more of a profile setting (e.g., via a device 1110, 1600, etc., in communication with one or more of profile management component 612, connector component 704, and so on, etc.) and/or a privacy setting (e.g., via a device 1110, 1600, etc., in communication with one or more of privacy and/or control component 1014, connector component 704, and so on, etc.) associated with one or more of the system (e.g., ISPP 104) or another computing system (e.g., such as one or more of a social media network computing system, a news network computing system, a search network computing system, etc.), and/or one or more computing systems associated with third parties, (e.g., individuals, political organizations, public polling organizations, private polling organizations, universities, and so on, etc.), as further described herein, regarding FIGS. 10-12, 16, for example. For instance, such data and/or information associated with the one or more users or subscribers 102 can comprise one or more poll targeting attributes concerning time or space and a predetermined interval associated therewith (e.g., where a spatial interval can be determined between a receiver, for example, and a device associated with user or subscriber 102, by comparison of location information associated with user or subscriber 102, such as is available from a GPS receiver, from triangulation via multiple cellular base stations, NFC techniques, etc.; where a temporal interval can be determined based on a desirable time associated with targeted polling and a time associated with a user's or subscriber's 102 last activity of interest, for example, within ISPP 104; and so on; etc.).

In another example, such data and/or information associated with the one or more users or subscribers 102 can comprise one or more of age, income level, education level, sex, political partisan ID, registered voter status, likely voter status, a prior poll response date, a search query, location, technical competence, technical ability, referrer of the targeted poll, a number of followers, a number of shared polls, a number of completed polls, verification status of a subset of profile information, and/or device information (e.g., one or more of device type, device manufacturer, operating system, application, browser, length of device use, length of service use, length of application use, and/or version information, and so on, etc.) associated with a device (e.g., device 1110, etc.) associated with the potential respondent (e.g., one or more users or subscribers 102, on etc.). Thus, in any event, further non-limiting examples of methods 1400, at 1404, can include the authorization of and/or the transmitting of such data and/or information, as described above, to facilitate determining whether an attribute specified for a targeted poll (e.g., by a poll sponsor, such as one or more users or subscribers 102, third parties and/or networks 802, participating third parties and/or networks 902, and so on, etc.) is fulfilled.

In yet other examples, non-limiting implementations of methods 1400, at 1406, can include receiving a targeted poll (e.g., by one or more users or subscribers 102, etc., via one or more devices associated therewith, such as device 1110, device 1600, and so on, etc.) based in part on a determination whether the attribute associated with a user of the computing device (e.g., device 1110, etc.) is fulfilled or satisfied, for instance, wherein the attribute specified for the targeted poll is specified by a poll sponsor (e.g., one or more one or more users or subscribers 102, third parties and/or networks 802, participating third parties and/or networks 902, and so on, etc.), as further described herein, regarding FIGS. 10-12, 16, for example. In still other exemplary implementations of methods 1400, the determination can include determining whether the attribute is fulfilled or satisfied based in part on a predetermined interval between the attribute associated with the user or subscriber 102 concerning time or space and the data and/or information associated with the user or subscriber 102 concerning time or space, respectively, as described above.

In addition, methods 1400 can further include, at 1408, responding to the targeted poll (e.g., by one or more users or subscribers 102, etc., via one or more devices associated therewith, such as device 1110, device 1600, and so on, etc.). For instance, exemplary implementations of devices suitable for incorporation of various aspects of the disclosed subject matter can provide various components and/or functionality (e.g., corresponding to user interfaces, communications, networking, encryption, and so on, etc.) that can facilitate receipt, storage, input, and/or output of data, information, and/or instructions in communication with ISPP 104 (e.g., via user interface component 110, etc.), as further described herein, regarding device 1110, device 1600, and so on, etc. Accordingly, such devices can be configured facilitate responding to the targeted poll (e.g., by one or more users or subscribers 102, etc., via one or more devices associated therewith, such as device 1110, device 1600, and so on, etc.).

In further non-limiting methods 1400, the methods can include, at 1410, receiving an incentive and/or other reward based in part on responding to the targeted poll, sharing the targeted poll, and/or other activities, whether within ISPP 104, or otherwise, sponsorship of the targeted poll by the poll sponsor (e.g., sponsorship by one or more users or subscribers 102, third parties and/or networks 802, participating third parties and/or networks 902, and so on, etc.), as further described herein, for example regarding FIGS. 4-11, 16, etc. (e.g., via a device 1110, 1600, etc., in communication with one or more of monetization component 410, marketing component 618, promotion and/or cross-promotion component 702, connector component 704, rewards component 904, and so on, etc.).

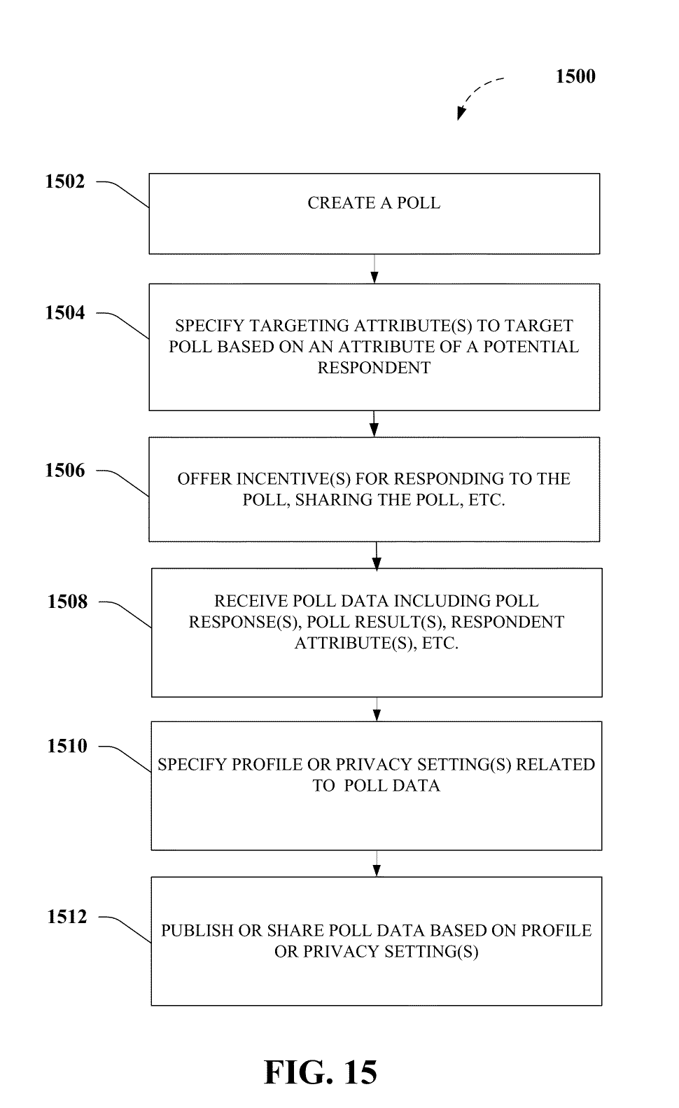

FIG. 15 illustrates an exemplary non-limiting flow diagram of methods 1500 for performing aspects of embodiments of the disclosed subject matter. For instance, referring to FIG. 15, methods 1500 can facilitate polling potential respondents (e.g., one or more users or subscribers 102, etc.), as described herein. As a non-limiting example, a poll that can be targeted (e.g., via specifying a poll targeting attribute, etc.) can be created at 1502, via a system (e.g., ISPP 104, etc.) including a processor (e.g., one or more host processors 1010, and so on, etc.), based in part on an attribute of a potential respondent (e.g., one or more users or subscribers 102, etc.), by a poll sponsor (e.g., one or more users or subscribers 102, third parties and/or networks 802, participating third parties and/or networks 902, and so on, etc). For instance, as further described herein, regarding FIGS. 2-10, etc., for example, ISPP 104 can facilitate, at 1502, creating a targeted poll (e.g., via one or more of user interface component 110, system management layer 114, system components 116, and/or portions thereof, such as poll creation component 602, promotion and/or cross-promotion component 702, connector component 704, and so on, etc.), wherein one or more attributes can be specified to target the poll to potential respondents (e.g., one or more users or subscribers 102, etc.), at 1504. In addition, methods 1500 can also include receiving a recommendation the one or more attributes associated with poll targeting to facilitate targeting of the poll, as further described herein (e.g., such as regarding attributes associated with poll targeting comprising data and/or information concerning the potential respondent, and so on, etc.).

Thus, in a further non-limiting example, at 1504, one or more targeting attributes of a potential respondent (e.g., one or more users or subscribers 102, etc.) can be specified (e.g., via one or more of profile management component 612, privacy and/or control component 1014, catalog component 616, poll execution component 1018, and/or portions thereof, and so on, etc.). For instance, such targeting attributes of the potential respondent (e.g., one or more users or subscribers 102, etc.) can be specified based in part on a predetermined interval between a poll targeting attribute concerning time or space and the attribute of the potential respondent concerning time or space, respectively (e.g., where a spatial interval can be determined between a receiver, for example, and a device associated with user or subscriber 102, by comparison of location information associated with user or subscriber 102, such as is available from a GPS receiver, from triangulation via multiple cellular base stations, NFC techniques, etc.; where a temporal interval can be determined based on a desirable time associated with targeted polling and a time associated with a user's or subscriber's 102 last activity of interest, for example, within ISPP 104; and so on; etc.).

In a further example, non-limiting implementations of methods 1500 can include specifying the one or more targeting attributes of the potential respondent (e.g., one or more users or subscribers 102, etc.), at 1504, based in part on such attributes as, for example, one or more of age, income level, education level, sex, political partisan ID, registered voter status, likely voter status, a prior poll response date, a search query, location, technical competence, technical ability, referrer of the targeted poll, a number of followers, a number of shared polls, a number of completed polls, verification status of a subset of profile information, and/or device information (e.g., one or more of device type, device manufacturer, operating system, application, browser, length of device use, length of service use, length of application use, and/or version information, and so on, etc.) associated with a device (e.g., device 1110, etc.) with the potential respondent (e.g., one or more users or subscribers 102, on etc.).

As described above, methods 1500 can further include, at 1506, offering, via the system, an incentive and/or other reward for responding to the targeted poll (and/or for other activities, such as sharing the targeted poll, within ISPP 104, or otherwise, etc.). For instance, at 1506, exemplary implementations of methods 1500 can also include offering an incentive and/or other reward as sponsorship of the targeted poll by the poll sponsor (e.g., one or more users or subscribers 102, third parties and/or networks 802, participating third parties and/or networks 902, and so on, etc.), as further described herein, for example regarding FIGS. 4-10 (e.g., via one or more of monetization component 410, marketing component 618, promotion and/or cross-promotion component 702, connector component 704, rewards component 904, and so on, etc.).

In still other non-limiting methods 1500, the methods can include receiving, from the system (e.g., ISPP 104), for example, poll data associated with the targeted poll (e.g., one or more of poll responses, poll results, respondent attributes, analyses, reports, and so on, etc.) by the poll sponsor (e.g., one or more users or subscribers 102, third parties and/or networks 802, participating third parties and/or networks 902, and so on, etc.) based in part on the sponsorship, at 1508. For example, as an incentive or reward for one or more users or subscribers 102 to respond to a targeted poll sponsored by a third party and/or network 802, rewards, such as points in a point system, or otherwise, can be offered to the one or more users or subscribers 102, for which the data and/or information associated with the targeted poll can be forwarded to the third party and/or networks 802 in exchange for such sponsorship of the targeted poll, as further described herein, for example regarding FIGS. 4-10 (e.g., regarding one or more of monetization component 410, marketing component 618, promotion and/or cross-promotion component 702, connector component 704, rewards component 904, and so on, etc.).

In yet another non-limiting example, methods 1500 can include, at 1510, specifying, by a poll sponsor (e.g., one or more users or subscribers 102, third parties and/or networks 802, participating third parties and/or networks 902, and so on, etc.), one or more of a profile setting (e.g., of a user or subscriber 102 via a device 1110, 1600, etc., in communication with one or more of profile management component 612, connector component 704, and so on, etc.) and/or a privacy setting (e.g., of a user or subscriber 102 via a device 1110, 1600, etc., in communication with one or more of privacy and/or control component 1014, connector component 704, and so on, etc.) related to poll data and/or information (e.g., one or more of poll responses, poll results, respondent attributes, search history, analyses, reports, and so on, etc.) and associated with one or more of the system (e.g., ISPP 104) or another computing system (e.g., such as one or more of a social media network computing system, a news network computing system, a search network computing system, etc.), and/or one or more computing systems associated with third parties, (e.g., individuals, political organizations, public polling organizations, private polling organizations, universities, and so on, etc.), as further described herein, regarding FIGS. 10-12, 16, for example. For instance, ISPP 104 can facilitate selective publishing, sharing, transmitting, and/or otherwise communicating such poll data and/or information based in part on a profile setting and/or a privacy setting (e.g., via one or more of publication component 1022, social component 620, profile management component 612, privacy and/or control component 1014, monetization component 410, connector component 704, reward component 906, and so on, etc.).

Thus, in a further example, methods 1500 can include, at 1512, publishing, sharing, transmitting, and/or otherwise communicating data and/or information associated with the targeted poll such as poll data and/or information (e.g., one or more of polls, poll responses, poll results, respondent attributes, search history, analyses, reports, and so on, etc.) to one or more other potential respondents (e.g., one or more users or subscribers 102, etc.), to one or more third parties and/or networks 802, to one or more participating third parties and/or networks 902, and so on, or otherwise, within ISPP 104, or otherwise, based in part on one or more of a profile setting (e.g., via one or more of profile management component 612, connector component 704, and so on, etc.) and/or a privacy setting (e.g., via one or more of privacy and/or control component 1014, connector component 704, and so on, etc.) associated with one or more of the system (e.g., ISPP 104) or another computing system (e.g., such as one or more of a social media network computing system, a news network computing system, a search network computing system, etc.), and/or one or more computing systems associated with third parties, (e.g., individuals, political organizations, public polling organizations, private polling organizations, universities, and so on, etc.), as further described herein, regarding FIGS. 10, 14, etc., for example.

### Exemplary Systems, Devices, and Graphical User Interfaces

FIG. 16 illustrates an exemplary non-limiting system or device 1600 suitable for performing various aspects of the disclosed subject matter. As an illustrative example, exemplary non-limiting device or system 1600 can comprise exemplary devices or systems of FIGS. 10-12, as described above, or portions thereof. System or device 1600 can comprise an input component 1602 that can receive data or signals, and performs typical actions thereon (e.g., transmits to storage component 1610) the received data or signal. A storage component 1610 can store the received data or signal, as described above, for example, regarding storage component 606, memory 1202, etc., for subsequent processing or can provide it to a decoding component 1606, or a processor (e.g., one or more host processors 1010, 1204, etc.), via a memory (e.g., memory 1202, etc.) over a suitable communications bus or otherwise, or to the output component 1608.

Processor 1604 can be a processor dedicated to analyzing and performing functions on information received by input component 1602 and/or generating information for transmission by an output component 1608. Processor 1604 can be a processor that controls one or more portions of system or device 1600, and/or a processor that analyzes information received by input component 1602, generates information for transmission by output component 1608, and performs various decoding algorithms of decoding component 1606. Decoding component 1606 can include various algorithms and routines to facilitate communication according specified network protocols and coding algorithms.

While decoding component 1606 is shown external to the processor 1604 and memory 1202, it is to be understood that decoding component 1606 can include decoding code stored in storage component 1610, storage component 606, memory 1202, etc., and/or subsequently retained in memory 1202 for execution by processor 1604. It can be understood that various routines performed by system or device 1600 can utilize artificial intelligence based methods in connection with performing inference and/or probabilistic determinations and/or statistical-based determinations in connection with various aspects of the disclosed subject matter.

System or device 1600 can additionally comprise a memory (e.g., memory 1202, etc.) that is operatively coupled to processor 1604 and that stores information such as described above, parameters, information, and the like, wherein such information can be employed in connection with implementing various aspects as described herein. Memory 1202 can additionally store received data and/or information (e.g., data and/or information associated with ISPP 104, such as polls, poll responses, analyses, reports, targeting attributes, data and/or information associated with user or subscriber 102, third parties and/or networks 802, participating third parties and/or networks 902, advertisements, marketing campaigns, promotions, cross-promotions, etc.), as well as software routines and/or instructions for functionality as described above in reference to FIGS. 2-15, etc., for example.

As an illustration of a non-limiting implementation of the disclosed subject matter, an exemplary device 1600 can be configured or adapted to provide various functionality characterized by a device associated with user or subscriber 102 (e.g., device 1110, etc.). For example, FIG. 11 describes device 1110, associated with user or subscriber 102, which can comprise an appropriately configured application, or app (e.g., appropriately configured for a specific device, communications service carrier, etc.), such as app 1108.

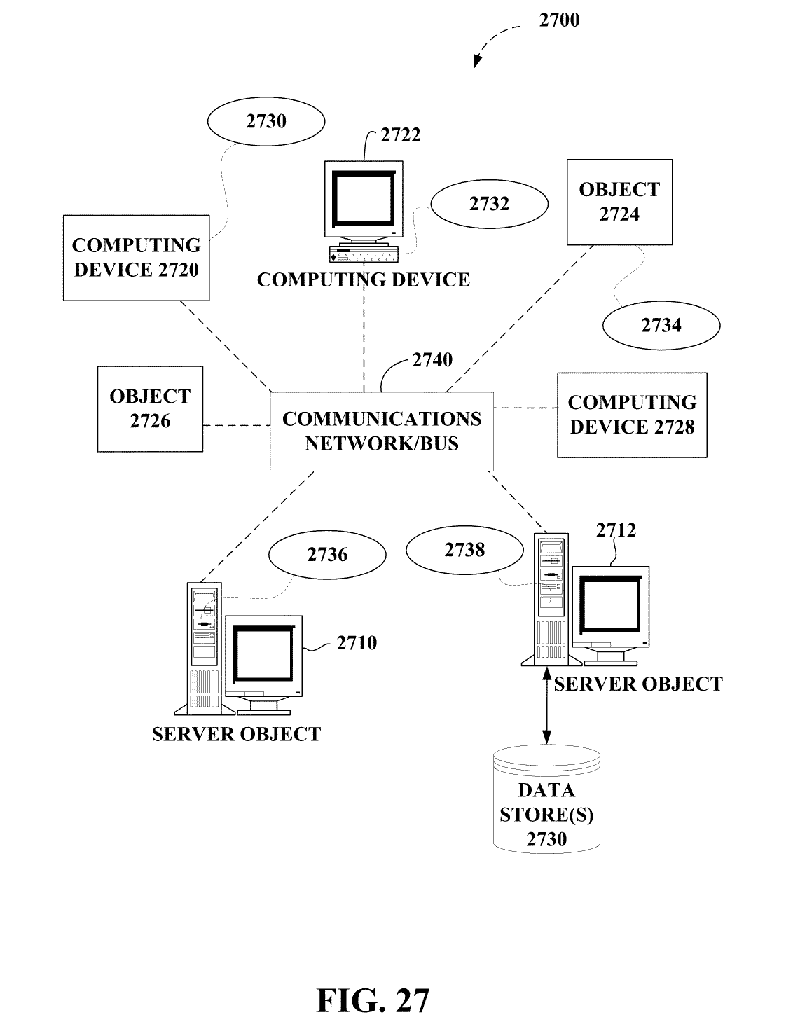

Referring again to FIG. 16, an exemplary device 1600 can comprise means for transmitting information to facilitate determining whether an attribute associated with a user (e.g., user or subscriber 102) of the device (e.g., device 1110, etc.) satisfies an attribute specified in a targeted poll by a poll sponsor (e.g., user or subscriber 102, third parties and/or networks 802, participating third parties and/or networks 902, and so on, etc.), as further described herein, for example, regarding FIGS. 11-12. For instance, as described above, a poll can be created and/or can be targeted by specifying an attribute that should be valid for a user or subscriber 102, and the exemplary device 1600 can be configured and/or adapted (e.g., via computer-executable instructions executed on processor 1604, etc.) to store (e.g., via storage component 1610, etc.) and/or transmit (e.g., via output component 1608, etc.) information that facilitates determining whether an attribute associated with a user (e.g., user or subscriber 102) of the device (e.g., device 1110, etc.) is satisfied, and as further described herein, regarding FIGS. 27-30, for instance.

In further non-limiting implementations, exemplary device 1600 can also comprise means for displaying and/or responding to the targeted poll, as further described herein, for example, regarding FIGS. 11-12, 17-30. For instance, as described herein, device 1110, associated with user or subscriber 102, which can comprise an appropriately configured application, or app (e.g., appropriately configured for a specific device, communications service carrier, etc.), such as app 1108 (e.g., via computer-executable instructions executed on processor 1604, etc.), can provide various UI functionality to allow entering text, choosing options, issuing voice commands, and so on, etc. Thus, exemplary device 1600 can be configured and/or adapted (e.g., via computer-executable instructions executed on processor 1604, etc.) to receive (e.g., via input component 1602, etc.) and/or to store (e.g., via storage component 1610, etc.) a targeted poll, to present, and/or display the targeted poll (e.g., via output component 1608, etc.), to facilitate input of poll responses (e.g., via input component 1602, etc.), and/or transmit (e.g., via output component 1608, etc.) such poll responses, and as further described herein, regarding FIGS. 17-30, for instance.

In yet another non-limiting implementation, exemplary device 1600 can comprise means for receiving a reward or other incentive (e.g., based in part on responding to the targeted poll, sharing the targeted poll, or other activities, whether within ISPP 104, or otherwise, and so on, etc.), wherein the reward is sponsored in part by the poll sponsor (e.g., user or subscriber 102, third parties and/or networks 802, participating third parties and/or networks 902, and so on, etc.), as further described herein, for example, regarding FIGS. 11-12. For instance, as described above, a reward or other incentive can be associated with activities within ISPP 104, such as responding to a poll, etc., or otherwise. Thus, exemplary device 1600 can be configured and/or adapted (e.g., via computer-executable instructions executed on processor 1604, etc.) to receive (e.g., via input component 1602, etc.) information and/or data associated with a reward or other incentive based in part on user or subscriber 102 activities within ISPP 104, including, but not limited to, responding to a targeted poll, sharing the targeted poll, to store (e.g., via storage component 1610, etc.) and/or transmit (e.g., via output component 1608, etc.) records of such activities and/or data or information related thereto that facilitates receiving the reward or other incentive, as further described herein, regarding FIGS. 10-11, 27-30, etc., for instance.

In still further non-limiting implementations, exemplary device 1600 can comprise means for authorizing transmitting, sharing, and/or otherwise promulgating information associated with the user or subscriber 102, the targeted poll, and so on, etc., based in part on a profile setting, a privacy setting, or otherwise, as further described herein, for example, regarding FIGS. 2-12. As a non-limiting example, such information can be authorized to be released to the poll sponsor (e.g., user or subscriber 102, third parties and/or networks 802, participating third parties and/or networks 902, and so on, etc.), other users or subscribers 102, and/or other computing systems, without limitation. For instance, as described above, ISPP 104 facilitates creating, setting, updating, deleting, and/or otherwise managing profile settings, privacy settings, and so on, etc. Thus, exemplary device 1600 can be configured and/or adapted (e.g., via computer-executable instructions executed on processor 1604, etc.) to receive (e.g., via input component 1602, etc.), to store (e.g., via storage component 1610, etc.), and/or transmit (e.g., via output component 1608, etc.) information and/or data associated with such settings, to facilitate the management of such settings and/or the data related thereto, as further described herein, regarding FIGS. 10-11, 27-30, etc., for instance.

It can be appreciated that exemplary device 1600 can be configured and/or adapted in a similar fashion to provide various other functionalities as described herein.

In a further illustration of a non-limiting implementation of the disclosed subject matter, an exemplary system 1600 can be configured or adapted to provide various functionality associated with a computing system (e.g., ISPP 104, etc.). Thus, as described above, FIG. 10 depicts ISPP 104 and various components and functionality therefor, associated with interactions of user or subscriber 102, and others such as third parties and/or networks 802, participating third parties and/or networks 902, and so on, etc.

Referring again to FIG. 16, an exemplary system 1600 can comprise means for receiving from a poll sponsor (e.g., user or subscriber 102, third parties and/or networks 802, participating third parties and/or networks 902, and so on, etc.), a request to create a targeted poll based in part on an attribute of a potential respondent (e.g., one or more users or subscribers 102, etc.), as further described herein, for example, regarding FIGS. 1-15. For instance, as described herein, a poll can be created (e.g., via a request received by one or more of front-end system 106, back-end system 112, and/or components or portions thereof, such as poll creation component 602, and so on, etc.) and/or can be targeted by specifying an attribute that can be determined to be valid for a user or subscriber 102 as a potential respondent. Thus, the exemplary system 1600 can be configured and/or adapted (e.g., via computer-executable instructions executed on one or more of host processors 1010, processor 1204, processor 1604, etc.) to receive (e.g., via one or more of input component 1602, front-end system 106, back-end system 112, and/or components or portions thereof, etc.), to store (e.g., via one or more of storage component 1610, back-end system 112, and/or components or portions thereof, such as storage component 606, and so on, etc.), and so on, information that facilitates receiving a request to create a targeted poll based on an attribute of a potential respondent (e.g., user or subscriber 102), and as further described herein, regarding FIGS. 10, 13, etc., for instance.

In further non-limiting implementations, exemplary system 1600 can also comprise means for determining whether the attribute of the potential respondent (e.g., one or more users or subscribers 102, etc.) is satisfied or fulfilled, for example, by querying with a computer (e.g., one or more of host processors 1010, processor 1204, processor 1604, etc.) a data store of potential respondents (e.g., via one or more of storage component 1610, back-end system 112, and/or components or portions thereof, such as storage component 606, and so on, etc.), as further described herein, for example, regarding FIGS. 2-13, etc. As a non-limiting example, the means for determining whether the attribute of the potential respondent is satisfied or fulfilled can include means for determining whether any of a number of attributes (e.g., age, income level, education level, sex, political partisan ID, registered voter status, likely voter status, a prior poll response date, a search query, location, technical competence, technical ability, referrer of the targeted poll, a number of followers, a number of shared polls, a number of completed polls, verification status of a subset of profile information, and/or device information for a device associated with the potential respondent) are satisfied or fulfilled. For instance, the exemplary system 1600 can be configured and/or adapted (e.g., via computer-executable instructions executed on one or more of host processors 1010, processor 1204, processor 1604, etc.) to receive (e.g., via one or more of input component 1602, front-end system 106, back-end system 112, and/or components or portions thereof, etc.), to store (e.g., via one or more of storage component 1610, back-end system 112, and/or components or portions thereof, such as storage component 606, and so on, etc.), and so on, information that facilitates determining whether an attribute associated with a user (e.g., user or subscriber 102) of the device (e.g., device 1110, etc.) is satisfied or fulfilled (e.g., via one or more of storage component 1610, back-end system 112, and/or components or portions thereof, such as profile management component 612, privacy and/or control component 1014, poll execution component 1018, monetization component 410, and so on, etc.), and as further described herein, regarding FIGS. 2-10,13, etc., for instance.

For other exemplary implementations, means for determining as described herein can include means for determining whether the attribute of the potential respondent (e.g., one or more users or subscribers 102, etc.) is satisfied or fulfilled, including, means for determining (e.g., via one or more of input component 1602, storage component 1610, front-end system 106, back-end system 112, and/or components or portions thereof, such as a other media communication component 1008, profile management component 612, privacy control component 1014, poll creation component 602, storage component 606, poll execution component 1018, monetization component 410, and so on, etc.), based on a predetermined interval between a poll targeting attribute concerning time or space and the attribute of the potential respondent concerning time or space, respectively (e.g., where a spatial interval can be determined between a receiver, for example, and a device associated with user or subscriber 102, by comparison of location information associated with user or subscriber 102, such as is available from a GPS receiver, from triangulation via multiple cellular base stations, NFC techniques, etc.; where a temporal interval can be determined based on a desirable time associated with targeted polling and a time associated with a user's or subscriber's 102 last activity of interest, for example, within ISPP 104; and so on; etc.).

In yet another non-limiting implementation, exemplary system 1600 can comprise means for providing an incentive or reward for responding to the targeted poll (e.g., based in part on responding to the targeted poll, sharing the targeted poll, or other activities, whether within ISPP 104, or otherwise, and so on, etc.), based in part on determining whether the attribute of the potential respondent (e.g., one or more users or subscribers 102, etc.) is satisfied or fulfilled, as further described herein, for example, regarding FIGS. 11-12. For instance, as described above, a reward or other incentive can be associated with activities within ISPP 104, such as responding to a poll, etc., or otherwise. In a further non-limiting example, the means for providing as described herein can include means for providing the incentive or reward based in part on sponsorship (e.g., via one or more of poll creation component 602, monetization component 410, marketing component 618, promotion and/or cross-promotion component 702, rewards component 904, and so on, etc.) of the targeted poll by the poll sponsor. Thus, exemplary system 1600 can be configured and/or adapted (e.g., via computer-executable instructions executed on one or more of host processors 1010, processor 1204, processor 1604, etc.) to determine and/or transmit (e.g., via one or more of output component 1608, front-end system 106, back-end system 112, and/or components or portions thereof, such as rewards component 904, and so on, etc.) such an incentive or reward and/or data or information related thereto that facilitates providing the incentive or reward, as further described herein, regarding FIGS. 4-13, etc., for instance.

In addition, other non-limiting implementations of exemplary system 1600 can comprise means for transmitting data and/or information associated with the targeted poll (e.g., poll responses, feedback, comments, ratings, results, analyses, reports, and so on, etc.) to the poll sponsor (e.g., one or more users or subscribers 102, third parties and/or networks 802, participating third parties and/or networks 902, and so on, etc.) based in part on the sponsorship (e.g., providing of rewards and/or incentives, and so on, etc.), for example, regarding FIGS. 4-12, etc., for example. As a non-limiting example, the targeted poll results and/or other information and/or data associated with the targeted poll (e.g., poll responses, feedback, comments, ratings, results, analyses, reports, and so on, etc.) can be collected (e.g., via one or more of poll execution component 1018, storage component 606, catalog component 616, and so on, etc.), formatted (e.g., via one or more of poll data format component 604, data organization component 1020, and so on, etc.), analyzed (e.g., via analysis component 408, and so on, etc.), published (e.g., via publication component 1022, and so on, etc.), socialized (e.g., via social component 620, and so on, etc.), monetized (e.g., via one or more of monetization component 410, rewards component 904, and so on, etc.), and/or provided and/or transmitted to one or more users or subscribers 102, third parties and/or networks 802, parties and/or networks 902 (e.g., via one or more of storage component 606, catalog component 616, search component 614, data organization on a 1020, monetization component 410, marketing component 618, promotion and/or cross-promotion component 702, connector component 704, rewards component 904, and so on, etc.), and so on, without limitation. Thus, exemplary system 1600 can be configured and/or adapted (e.g., via computer-executable instructions executed on processor 1604, etc.) to determine and/or transmit (e.g., via one or more of output component 1608, front-end system 106, back-end system 112, and/or components or portions thereof, as described, and so on, etc.) data and/or information associated with the targeted poll and/or data or information related thereto that facilitates, as further described herein, regarding FIGS. 4-11, 13, etc., for instance.

In still further non-limiting implementations, exemplary system 1600 can comprise means for presenting the targeted poll to the potential respondent (e.g., one or more users or subscribers 102, etc.), for example, regarding FIGS. 10-12, etc., for instance. As a non-limiting example, a targeted poll can be displayed and/or presented to one or more users or subscribers 102, as further described herein, based on any of a number of poll targeting data, information, and/or attributes, without limitation. In another non-limiting example, means for presenting as described herein can include means for presenting the incentive with the targeted poll to the potential correspondent (e.g., one or more users or subscribers 102, etc.), such as, a simultaneous inducement, an offer of points, and/or reward or incentive presented at the same time as the targeted poll is presented. Thus, exemplary system 1600 can be configured and/or adapted (e.g., via computer-executable instructions executed on processor 1604, etc.) to determine and/or transmit (e.g., via one or more of output component 1608, front-end system 106, back-end system 112, and/or components or portions thereof, such as profile management component 612, privacy and/or control component 1014, poll execution component 1018, monetization component 410, and so on, etc.) such as a targeted poll and/or data or information related thereto that facilitates presenting and/or displaying the targeted poll to a user or subscriber 102, such as via a device (e.g., device 1110, etc.) associated with user or subscriber 102, as further described herein, regarding FIGS. 4-11, 14, 17-30, etc., for instance.

Additionally, further non-limiting implementations of exemplary system 1600 can comprise means for publishing the targeted poll, and/or other data or information associated with the targeted poll, to one or more other potential respondents based in part on a profile setting, a privacy setting, and so on, etc., associated with a computing system (e.g., ISPP 104, a social networking computing system, a computing system associated with third parties and/or networks 802, such as computing system or device 1126, a computing system associated with participating third parties and/or networks 902, such as computing system or device 1128, etc.) as further described herein, for example, regarding FIGS. 10-12, etc., for instance. As a non-limiting example, a targeted poll can be published, shared, and/or otherwise socialized to ISPP 104, as further described herein, to one or more users or subscribers 102, and/or to other potential respondents associated with other computing systems (e.g., computing systems associated with one or more of news networks, research organizations, social networks, search providers, commercial and/or non-commercial entities, political organizations, and so on, etc.), without limitation. Thus, exemplary system 1600 can be configured and/or adapted (e.g., via computer-executable instructions executed on processor 1604, etc.) to publish, share, and/or otherwise socialize (e.g., via one or more of output component 1608, front-end system 106, back-end system 112, and/or components or portions thereof, such as a profile management component 612, privacy and/or control component 1014, monetization component 410, search component 614, publication component 1022, social component 620, marketing component 618, promotion and/or cross-promotion component 702, connector component 704, and so on, etc.) such a targeted poll and/or data or information related thereto that facilitates presenting and/publishing the targeted poll to one or more other potential respondents (e.g., one or more other users or subscribers 102, or otherwise, etc.), such as via a (e.g., device 1110, etc.) associated with user or subscriber 102, or otherwise, as further described herein, regarding FIGS. 2-11, 13, etc., for instance.

It can be appreciated that exemplary system 1600 can be configured and/or adapted in a similar fashion to provide various other functionalities as described herein.

It will be understood that storage component 1610, storage component 606, memory 1202, and/or any combination thereof as described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1202 is intended to comprise, without being limited to, these and/or any other suitable types of memory, including processor registers and the like. In addition, by way of illustration and not limitation, storage component 1610 and/or storage component 606, can include conventional storage media as in known in the art (e.g., hard disk drive, solid state disk (SSD), etc.).

It can be understood that various techniques described herein may be implemented in connection with hardware or software or, where appropriate, with a combination of both. As used herein, the terms “device,” “component,” “system” and the like are likewise intended to refer to a computer-related entity, either hardware, a combination of hardware and software, software, or software in execution. For example, a “device,” “component,” subcomponent, “system” portions thereof, and so on, may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

It can be further understood that while a brief overview of exemplary systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

As described above, regarding FIGS. 2-16, etc., for example, in exemplary implementations of the disclosed subject matter, a user interface such as a GUI can be provided, for example to facilitate interactions with ISPP 104 according to various aspects of the disclosed subject matter, among other related functions. In addition, additional embodiments of the disclosed subject matter can provide computer-executable components that can be stored on a tangible computer readable storage medium (e.g., storage component 606, storage component 1610, memory 1202, etc.), and that, in response to execution by a computing device (e.g., one or more of host processors 1010, processor 1204, processor 1604, etc.), can cause the computing device to display information (e.g., on the computing device, on a remote computing device over a network, etc), for example, such as via a GUI.

For example, FIG. 16 illustrates an exemplary non-limiting block diagram depicting tangible computer readable storage medium, such as storage component 1610 (e.g., storage component 606, memory 1202, etc.), that can comprise computer-executable components and that, in response to execution by a computing device (e.g., one or more of host processors 1010, processor 1204, etc.), can cause the computing device to display information (e.g., on the computing device, on a remote computing device over a network, etc). As a non-limiting example, the computer-executable components of the tangible computer readable storage medium can comprise an appropriately configured application, or app, (e.g., appropriately configured for a specific device, communications service carrier, etc.) such as described above for app 1108 in FIG. 11, for instance. In another non-limiting example, the computer-executable components of the tangible computer readable storage medium can comprise any of the components (e.g., communication components 108, user interface component 110, system management layer 114, system components 116, and/or portions thereof, and so on, etc.) described herein regarding FIGS. 1-10, for instance. In any event, the computer-executable components of the tangible computer readable storage medium can provide a user interface to facilitate interactions with ISPP 104, as described herein. Accordingly, FIGS. 17-26 depict various non-limiting examples of a GUI suitable for use with exemplary aspects of the disclosed subject matter.

For instance, FIG. 17 depicts a non-limiting example of a GUI home page 1700 that can facilitate registration and/or account creation (1702) (e.g., via a device 1110, 1600, etc., in communication with one or more of registration and/or authentication component 1012, profile management component 612, connector component 704, and so on, etc.) in an exemplary non-limiting implementation of ISPP 104, as described herein, in conjunction with user interface component 110 regarding FIGS. 1-12, 14, 16, etc., for example, for one or more users or subscribers 102. Exemplary GUI home page 1700 can also facilitate searching (1704) for poll data and/or information (e.g., one or more of polls, poll questions, responses, poll results, respondent attributes, analyses, reports, and so on, etc.) via a device 1110, 1600, etc., (e.g., in communication with one or more of search component 614, storage component 606, connector component 704, and so on, etc.). In still other non-limiting examples, exemplary GUI home page 1700 can facilitate listing, presenting, and/or otherwise displaying (1706) categories of poll topics to one or more users or subscribers 102, third parties and/or networks 802, participating third parties and/or networks 902, and so on, etc. (e.g., via a device 1110, 1600, etc., in communication with one or more of profile management component 612, catalog component 616, data organization component 1020, monetization component 410, marketing component 618, promotion and/or cross-promotion component 702, connector component 704, and so on, etc.).

FIG. 17 also depicts exemplary GUI home page 1700 that facilitates listing, presenting, and/or otherwise displaying (1708) any number of polls and/or poll data and/or information to one or more users or subscribers 102, third parties and/or networks 802, participating third parties and/or networks 902, and so on, etc. (e.g., via a device 1110, 1600, etc., in communication with one or more of profile management component 612, storage component 606, analysis component 408, publication component 1022, catalog component 616, data organization component 1020, monetization component 410, marketing component 618, promotion and/or cross-promotion component 702, connector component 704, and so on, etc.). For instance, FIG. 17 depicts a list of various polling topics based in part on one or more of a profile setting associated with a personal interest (e.g., such as regarding popular topics and/or sports topics such as, EURO 2012, etc.), poll sponsorship status (e.g., such as regarding the topic associated with a business concern (e.g., General Electric® (GE®), and so on, etc.), poll subscription status, poll response status (1710) concerning the user or subscriber 102, and/or other data and/or information associated with ISPP 104.

For example, exemplary GUI home page 1700 depicts poll popularity ranking (1712) as well as the poll creator and number of responses with each poll status (e.g., such as can be set via one or more of profile management component 612, privacy and/or control component 1014, and so on, etc.). In addition, exemplary GUI home page 1700 can facilitate listing, presenting, and/or otherwise displaying a number of regions that can be reserved for sponsored polls (1714), sponsored ads (1716), and so on, etc. (e.g., via one or more of profile management component 612, storage component 606, monetization component 410, marketing component 618, promotion and/or cross-promotion component 702, connector component 704, and so on, etc.), as further described herein.

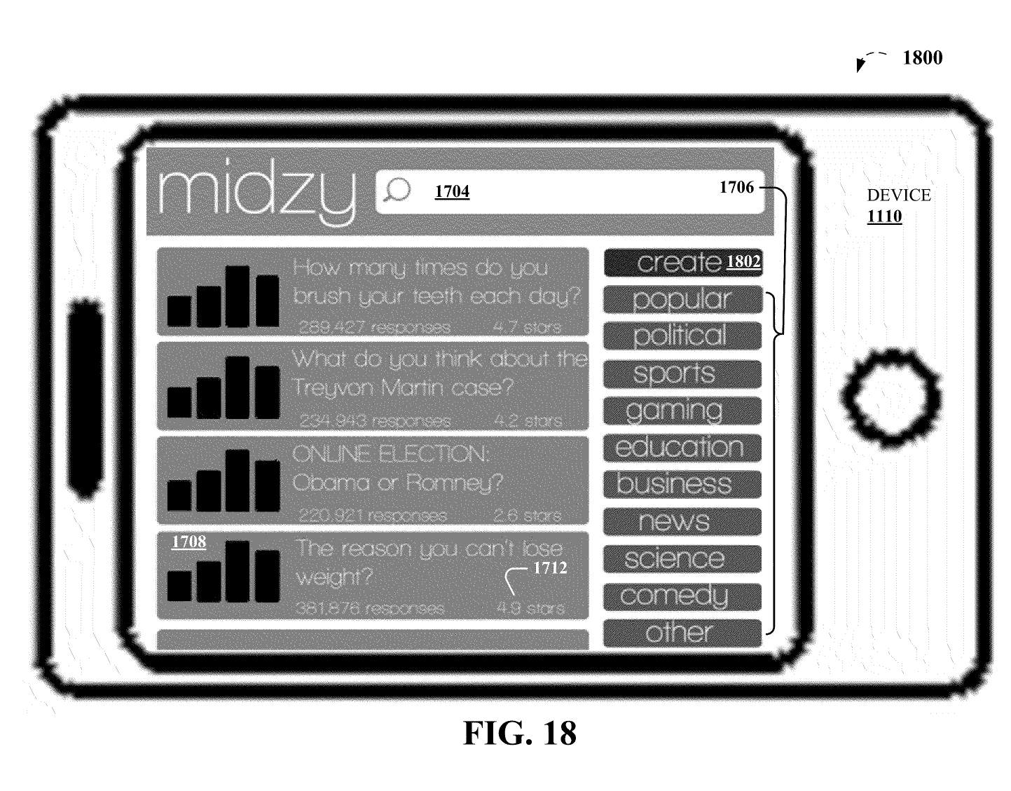

In FIG. 18, exemplary GUI home page 1800 depicts one or more similar features, data, information, and/or functionality as in FIG. 17, for example, such as for user or subscriber 102 that has one or more of authenticated to ISPP 104, modified the user or subscriber 102 profile, etc. For instance, the format depicted in FIG. 18 can be suitable for facilitating interactions with ISPP 104 via devices having restricted system resources, such as devices having a reduced display size, and so on. In addition, exemplary GUI home page 1800 can facilitate listing, presenting, and/or otherwise displaying any number options related to creating polls (1802), and so on, etc. (e.g., via one or more of registration and/or authentication component 1012, profile management component 612, storage component 606, monetization component 410, marketing component 618, promotion and/or cross-promotion component 702, connector component 704, and so on, etc.), as further described herein.

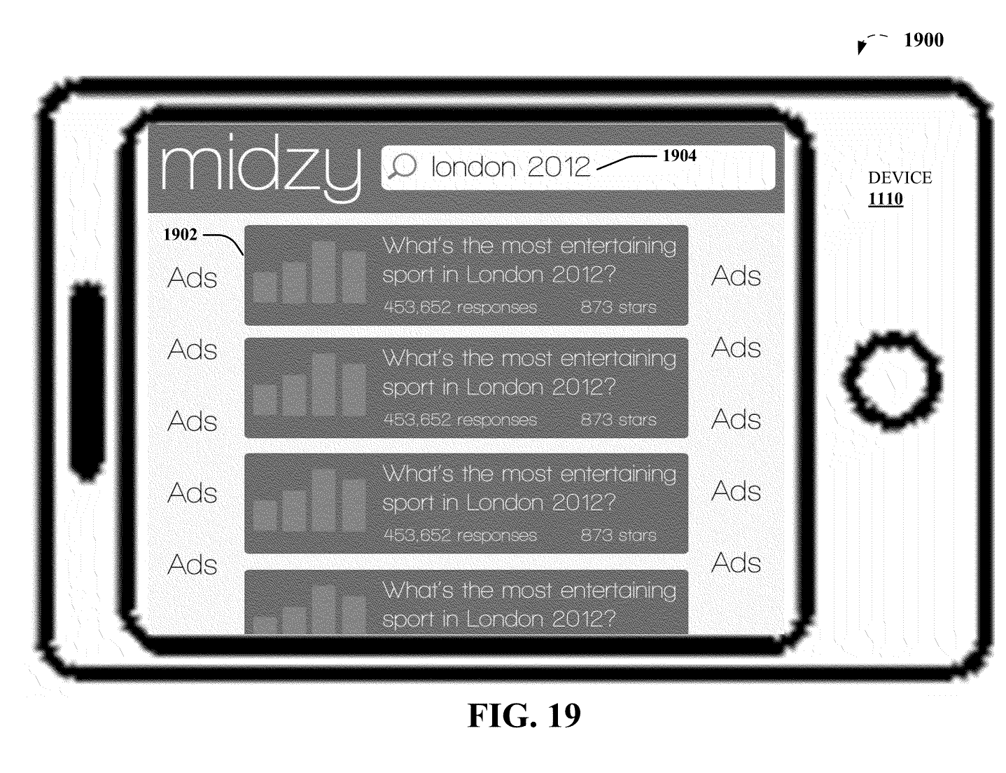

FIG. 19 depicts a non-limiting example of a GUI search results page 1900 that can facilitate various aspects related to searching for polls, for example, as further described above. Thus, in FIG. 19, GUI search results page 1900 can facilitate listing, presenting, and/or otherwise displaying a number of polls (1902) related to search criteria (1904), advertisements (1906), and so on, etc. (e.g., via a device 1110, 1600, etc., in communication with one or more of profile management component 612, privacy and/or control component 1014, storage component 606, analysis component 408, publication component 1022, social component 620, catalog component 616, data organization component 1020, monetization component 410, marketing component 618, promotion and/or cross-promotion component 702, connector component 704, and so on, etc.) in an exemplary non-limiting implementation of ISPP 104, as described herein, in conjunction with user interface component 110 regarding FIGS. 1-12, 14, 16, etc., for example, for one or more users or subscribers 102.

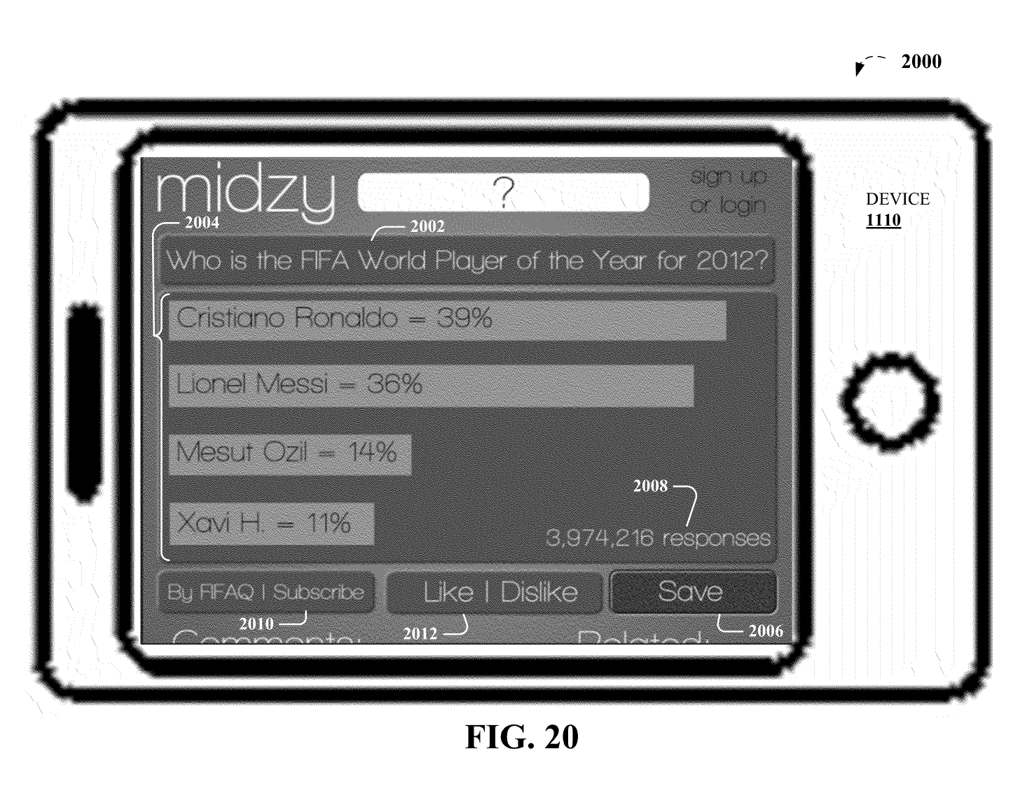

FIG. 20, depicts a non-limiting example of a GUI poll page 2000 that can facilitate listing, presenting, and/or otherwise displaying one or more of a poll (2002), one or more options for responding to the poll, poll response data and/or information, results, and so on (2004, 2006), poll popularity ranking (e.g., such as number of responses (2008), etc.) and/or status to one or more users or subscribers 102, third parties and/or networks 802, participating third parties and/or networks 902, and so on, etc. (e.g., via a device 1110, 1600, etc., in communication with one or more of profile management component 612, storage component 606, analysis component 408, publication component 1022, social component 620, catalog component 616, data organization component 1020, poll execution component 1018, monetization component 410, marketing component 618, promotion and/or cross-promotion component 702, connector component 704, and so on, etc.) in an exemplary non-limiting implementation of ISPP 104, as described herein, in conjunction with user interface component 110 regarding FIGS. 1-12, 14, 16, etc., for example, for one or more users or subscribers 102. Exemplary GUI poll page 2000 can also facilitate one or more of displaying the poll creator (e.g., one or more users or subscribers 102, third parties and/or networks 802, participating third parties and/or networks 902, and so on, etc.) on the GUI poll page 2000, providing the ability to subscribe to the poll and/or the creator (2010), providing the ability to comment and/or otherwise provide feedback on the poll (1812), and so on, etc. (e.g., via a device 1110, 1600, etc., in communication with one or more of profile management component 612, storage component 606, analysis component 408, catalog component 616, data organization component 1020, poll execution component 1018, monetization component 410, marketing component 618, promotion and/or cross-promotion component 702, connector component 704, and so on, etc.).

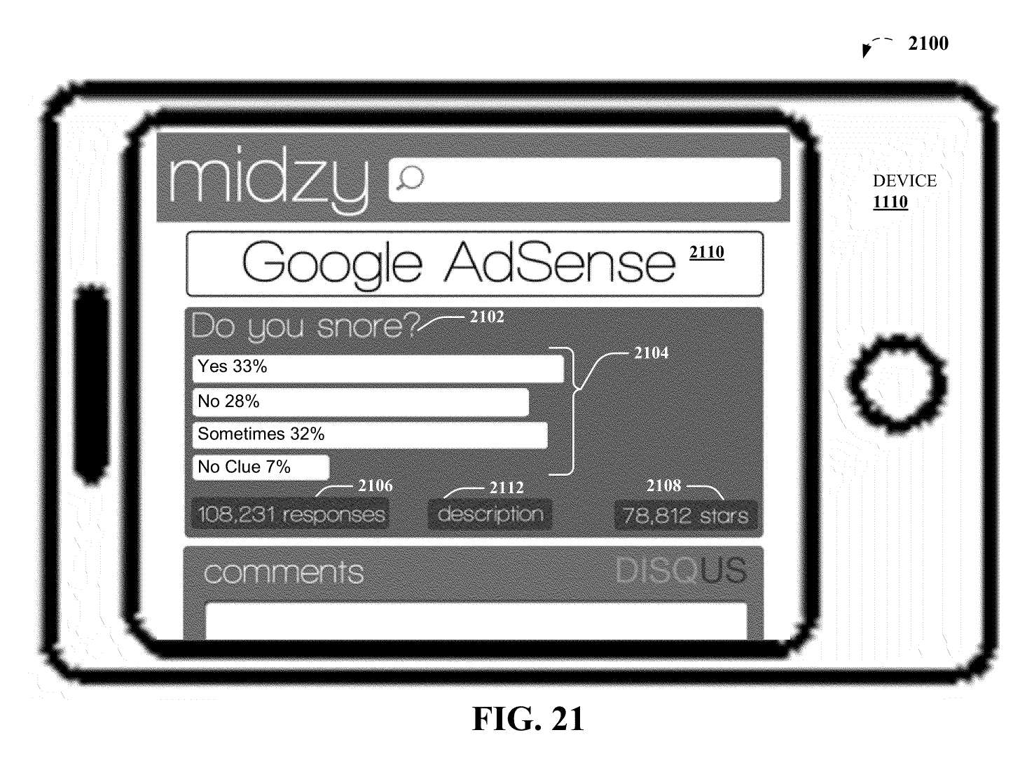

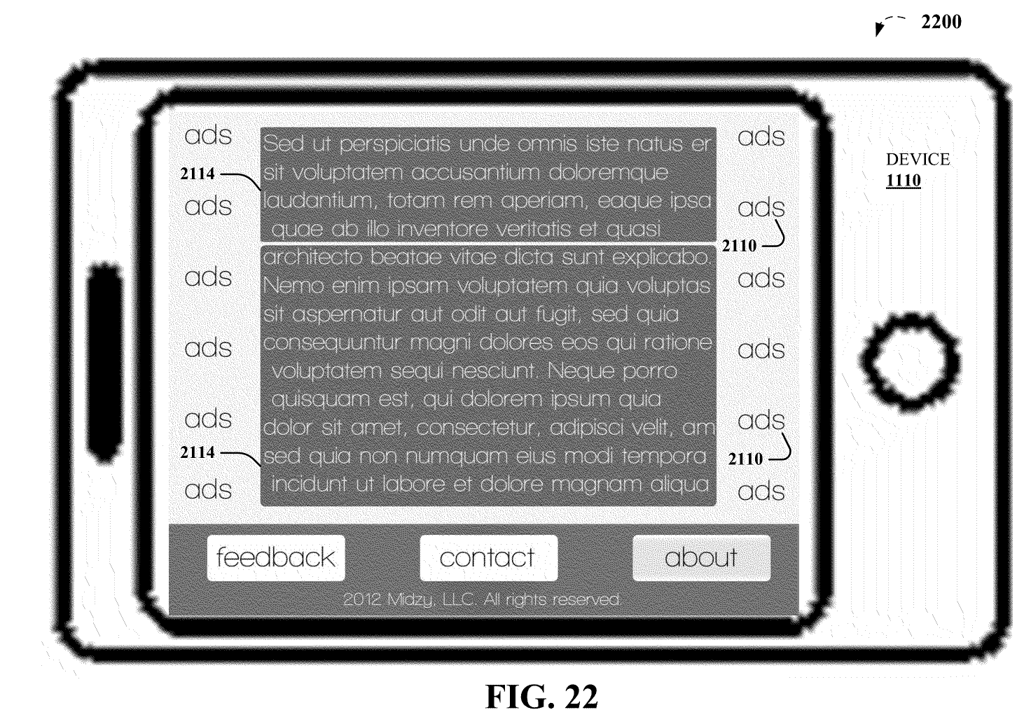

FIGS. 21-22, depict further non-limiting examples of a GUI poll pages 2100, 2200 that can facilitate various aspects related to one or more of incentivized polling, sponsored polling, and/or monetization of data and/or information associated with ISPP 104, for example, as further described above, where GUI poll page 2200 illustrates a version of GUI poll page 2100 that has been scrolled to view further content associated with an exemplary ISPP 104. Thus, GUI poll page 2100-2200 can facilitate listing, presenting, and/or otherwise displaying one or more of a poll (2102), poll response data and/or information, results, and so on (2104), poll popularity ranking (e.g., such as number of responses (2106, 2108), advertisements (2110), poll description (2112), and/or one or more options (2114) to provide feedback and/or comment on the poll data and/or information to one or more users or subscribers 102, third parties and/or networks 802, participating third parties and/or networks 902, and so on, etc. (e.g., via a device 1110, 1600, etc., in communication with one or more of profile management component 612, storage component 606, analysis component 408, publication component 1022, social component 620, catalog component 616, data organization component 1020, monetization component 410, marketing component 618, promotion and/or cross-promotion component 702, connector component 704, and so on, etc.) in an exemplary non-limiting implementation of ISPP 104, as described herein, in conjunction with user interface component 110 regarding FIGS. 1-12, 14, 16, etc., for example, for one or more users or subscribers 102.

Exemplary GUI poll page 2100 can also facilitate one or more of displaying the poll creator (e.g., one or more users or subscribers 102, third parties and/or networks 802, participating third parties and/or networks 902, and so on, etc.) on the GUI poll page 2100, providing the ability to subscribe to the poll and/or the creator, as previously described, and so on, etc. (e.g., via a device 1110, 1600, etc., in communication with one or more of profile management component 612, storage component 606, analysis component 408, catalog component 616, data organization component 1020, poll execution component 1018, monetization component 410, marketing component 618, promotion and/or cross-promotion component 702, connector component 704, and so on, etc.). Although not apparent in GUI poll pages 2100 of FIG. 21, it can be appreciated that GUI poll page 2100 can also facilitate providing the ability to respond to the poll, as previously described (e.g., via a device 1110, 1600, etc., in communication with one or more of profile management component 612, storage component 606, poll execution component 1018, and so on, etc.), such as by providing one or more user or subscriber 102 the ability to indicate a selection of one or more of the poll response options (e.g., by clicking a hyperlink associated with a poll response option, etc.), and so on, etc.

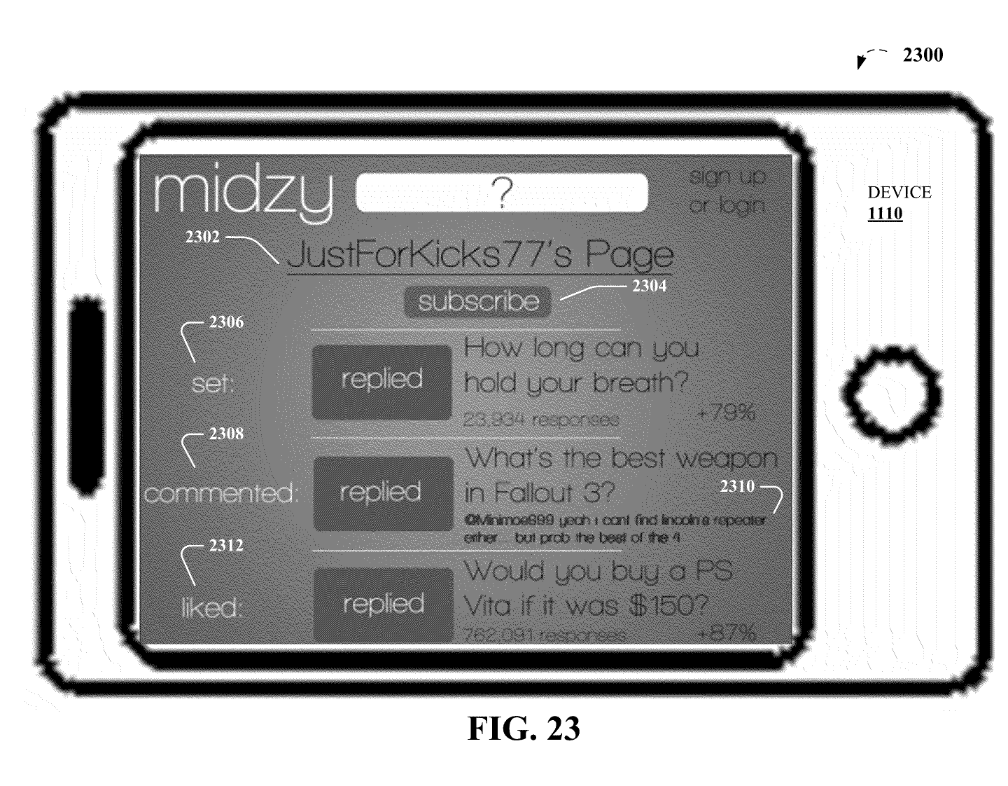

FIG. 23, depicts a non-limiting example of a GUI page 2300 that can facilitate various aspects related to social polling regarding viewing, listing, and/or subscribing, to one or more users or subscribers 102. For instance, GUI page 2300 can facilitate listing, presenting, and/or otherwise displaying one or more of a username or handle (2302) for a user or subscriber 102, one or more options for subscribing or following the user or subscriber 102 (2304), one or more activities (2306-2312) of the user or subscriber 102 within ISPP 104, or otherwise, poll popularity ranking (e.g., such as number of responses, and so on, etc., as described herein (e.g., via a device 1110, 1600, etc., in communication with one or more of profile management component 612, storage component 606, analysis component 408, publication component 1022, social component 620, catalog component 616, data organization component 1020, poll execution component 1018, monetization component 410, marketing component 618, promotion and/or cross-promotion component 702, connector component 704, and so on, etc.) in an exemplary non-limiting implementation of ISPP 104, in conjunction with user interface component 110 regarding FIGS. 1-12, 14, 16, etc., for example, for one or more users or subscribers 102. In a further example, GUI page 2300 depicts a number of activities for which the user or subscriber 102 has undertaken including, but not limited to, setting or creating a poll (2306), providing feedback on a poll, such as commenting on a poll (2308, 2310), and liking a poll (2312).

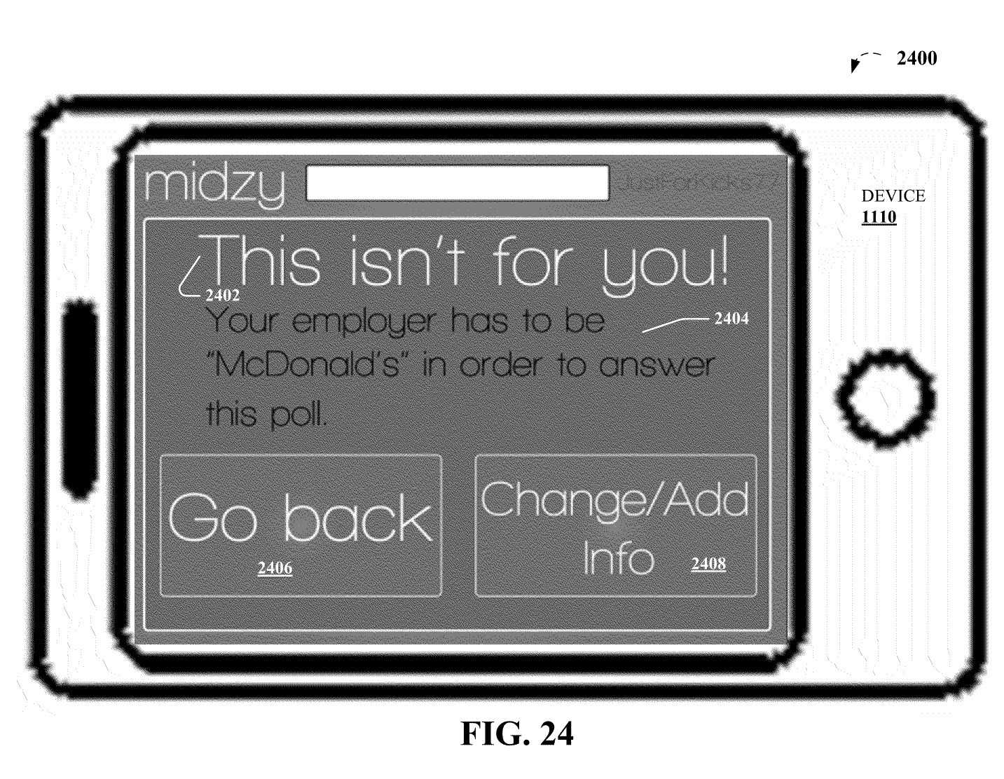

FIG. 24 depicts a non-limiting example of a GUI page 2400 that can facilitate various aspects related to targeted polling of one or more users or subscribers 102. For instance, GUI page 2400 can facilitate denying access (2402) to a targeted poll based in part on a targeting attribute (2404), and/or otherwise providing one or more options for user or subscriber 102, within ISPP 104, or otherwise, to resume activities within ISPP 104 (2406), or otherwise, such as, changing or updating profile information, for an otherwise valid attribute, and so on, etc. (e.g., via a device 1110, 1600, etc., in communication with one or more of profile management component 612, storage component 606, analysis component 408, publication component 1022, social component 620, catalog component 616, data organization component 1020, poll execution component 1018, monetization component 410, marketing component 618, promotion and/or cross-promotion component 702, connector component 704, and so on, etc.) in an exemplary non-limiting implementation of ISPP 104, as described herein, in conjunction with user interface component 110 regarding FIGS. 1-12, 14, 16, etc., for example, for one or more users or subscribers 102.

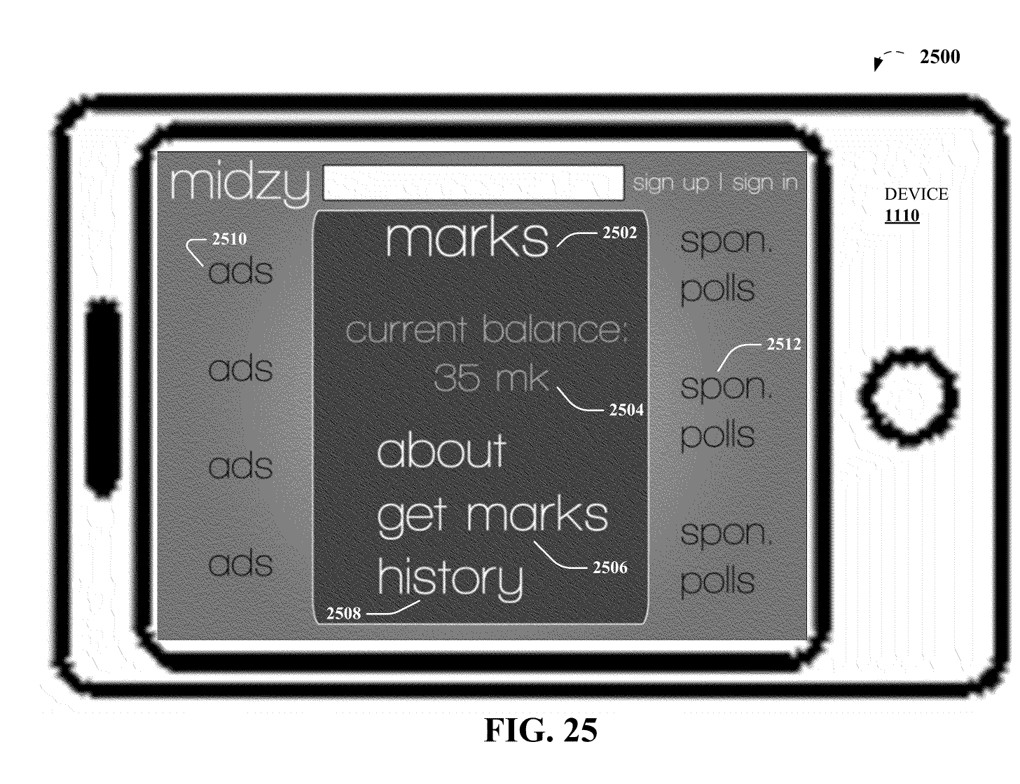

FIG. 25 depicts a non-limiting example of a GUI page 2500 that can facilitate various aspects related to incentivized polling of one or more users or subscribers 102, for example, directed to a points or rewards system, as further described above. For instance, in the exemplary GUI page 2500 depicting a points or marks system (2502), GUI page 2500 can facilitate, for one or more users or subscribers 102, third parties and/or networks 802, participating third parties and/or networks 902, listing, presenting, and/or otherwise displaying one or more of an account balance (2504), one or more options for acquiring points or marks (e.g., via purchase, or other exchange, etc.) (2506), viewing account history (2508), and/or one or more options for earning points or marks, such as by viewing paid ads (2510), responding to sponsored polls (2512), and so on, etc. (e.g., via a device 1110, 1600, etc., in communication with one or more of profile management component 612, privacy and/or control component 1014, storage component 606, analysis component 408, publication component 1022, social component 620, catalog component 616, data organization component 1020, poll execution component 1018, monetization component 410, marketing component 618, promotion and/or cross-promotion component 702, connector component 704, and so on, etc.) in an exemplary non-limiting implementation of ISPP 104, as described herein, in conjunction with user interface component 110 regarding FIGS. 1-12, 14, 16, etc., for example, for one or more users or subscribers 102.

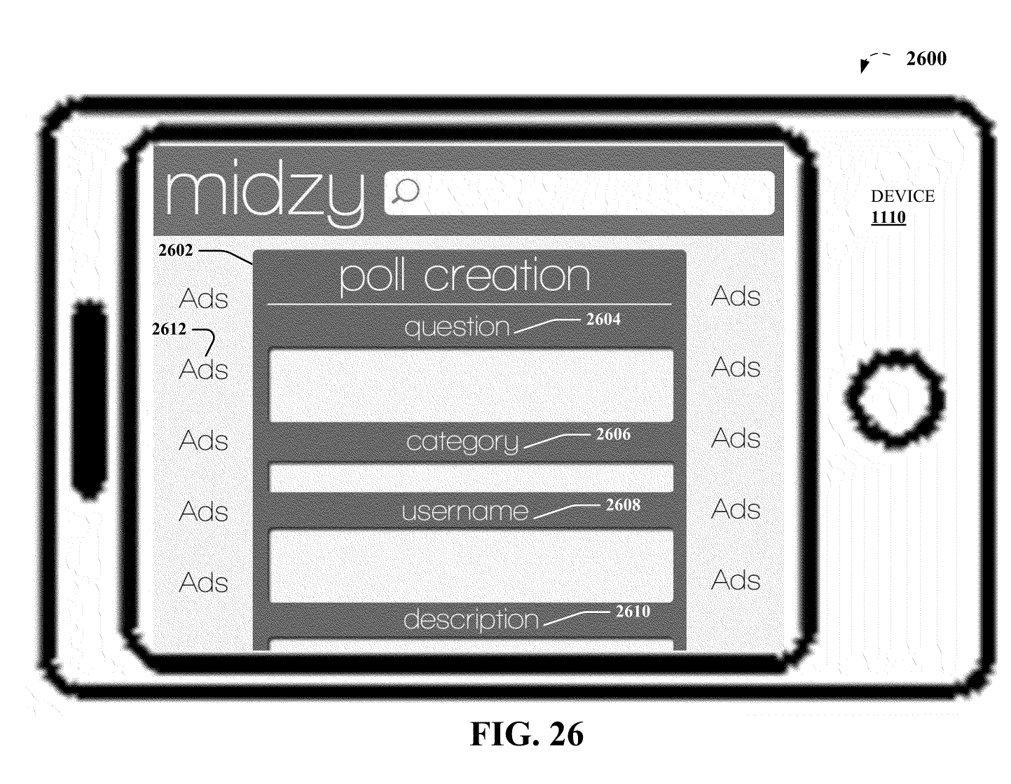

FIG. 26, depicts a non-limiting example of a GUI poll creation page 2600 that can facilitate various aspects related to incentivized polling of one or more users or subscribers 102, for example, as further described above. As described above regarding FIG. 18, for example, exemplary GUI home page 1800 exemplary GUI home page 1800 can facilitate listing, presenting, and/or otherwise displaying a number options related to creating polls (1802), and so on, etc. (e.g., via one or more of registration and/or authentication component 1012, profile management component 612, storage component 606, monetization component 410, marketing component 618, promotion and/or cross-promotion component 702, connector component 704, and so on, etc.), as further described herein. Thus, in FIG. 26, GUI poll creation page 2600 can facilitate listing, presenting, and/or otherwise displaying a number options related to creating polls (2602), creating one or more poll questions (2604), selecting one or more poll categories (2606), specifying one or more attributes (2608) associated with poll targeting, such as user names associated with one or more users or subscribers 102, and/or other poll targeting attributes (not shown), providing a description of poll (e.g., such as poll goals, objectives, rewards and/or other incentives, privacy policies, targeting attributes, poll results usage, or other data and/or information related to the poll, for which such data and/or information would be useful for the one or more users or subscribers 102 to have access, and so on, etc.) (2610), as well as advertisements (2612), and/or other data and/or information, associated with ISPP 104, or otherwise, and so on, etc. (e.g., via a device 1110, 1600, etc., in communication with one or more of profile management component 612, privacy and/or control component 1014, storage component 606, analysis component 408, publication component 1022, social component 620, catalog component 616, data organization component 1020, poll creation from 602, poll execution component 1018, monetization component 410, marketing component 618, promotion and/or cross-promotion component 702, connector component 704, and so on, etc.) in an exemplary non-limiting implementation of ISPP 104, as described herein, in conjunction with user interface component 110 regarding FIGS. 1-12, 14, 16, etc., for example, for one or more users or subscribers 102.

### Exemplary Networked and Distributed Environments

One of ordinary skill in the art can appreciate that the various embodiments of the disclosed subject matter and related systems, devices, and/or methods described herein can be implemented in connection with any computer or other client or server device, which can be deployed as part of a communications system, a computer network, and/or in a distributed computing environment, and can be connected to any kind of data store. In this regard, the various embodiments described herein can be implemented in any computer system or environment having any number of memory or storage units, and any number of applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

FIG. 27 provides a schematic diagram of an exemplary networked or distributed computing environment. The distributed computing environment comprises computing objects 2710, 2712, etc. and computing objects or devices 2720, 2722, 2724, 2726, 2728, etc., which may include programs, methods, data stores, programmable logic, etc., as represented by applications 2730, 2732, 2734, 2736, 2738. It can be understood that objects 2710, 2712, etc. and computing objects or devices 2720, 2722, 2724, 2726, 2728, etc. may comprise different devices, such as PDAs, audio/video devices, mobile phones, MP3 players, personal computers, laptops, etc.

Each object 2710, 2712, etc. and computing objects or devices 2720, 2722, 2724, 2726, 2728, etc. can communicate with one or more other objects 2710, 2712, etc. and computing objects or devices 2720, 2722, 2724, 2726, 2728, etc. by way of the communications network 2740, either directly or indirectly. Even though illustrated as a single element in FIG. 27, network 2740 may comprise other computing objects and computing devices that provide services to the system of FIG. 27, and/or may represent multiple interconnected networks, which are not shown. Each object 2710, 2712, etc. or 2720, 2722, 2724, 2726, 2728, etc. can also contain an application, such as applications 2730, 2732, 2734, 2736, 2738, that can make use of an API, or other object, software, firmware and/or hardware, suitable for communication with or implementation of disclosed and related systems, devices, methods, and/or functionality provided in accordance with various embodiments of the subject disclosure. Thus, although the physical environment depicted may show the connected devices as computers, such illustration is merely exemplary and the physical environment may alternatively be depicted or described comprising various digital devices, any of which can employ a variety of wired and/or wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many networks are coupled to the Internet, which can provide an infrastructure for widely distributed computing and can encompass many different networks, though any network infrastructure can be used for exemplary communications made incident to employing disclosed and related systems, devices, and/or methods as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 27, as a non-limiting example, computers 2720, 2722, 2724, 2726, 2728, etc. can be thought of as clients and computers 2710, 2712, etc. can be thought of as servers where servers 2710, 2712, etc. provide data services, such as receiving data from client computers 2720, 2722, 2724, 2726, 2728, etc., storing of data, processing of data, transmitting data to client computers 2720, 2722, 2724, 2726, 2728, etc., although any computer can be considered a client, a server, or both, depending on the circumstances. Any of these computing devices may be processing data, forming metadata, synchronizing data or requesting services or tasks that may implicate disclosed and related systems, devices, and/or methods as described herein for one or more embodiments.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to disclosed and related systems, devices, and/or methods can be provided standalone, or distributed across multiple computing devices or objects.

In a network environment in which the communications network/bus 2740 is the Internet, for example, the servers 2710, 2712, etc. can be Web servers with which the clients 2720, 2722, 2724, 2726, 2728, etc. communicate via any of a number of known protocols, such as the hypertext transfer protocol (HTTP). Servers 2710, 2712, etc. may also serve as clients 2720, 2722, 2724, 2726, 2728, etc., as may be characteristic of a distributed computing environment.

### Exemplary Computing Device

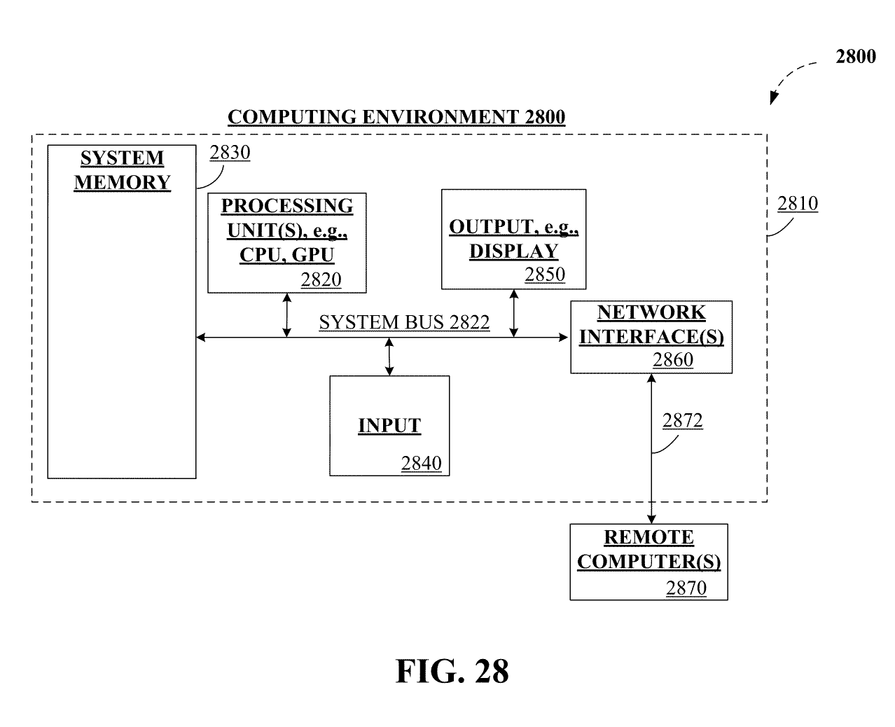

As mentioned, advantageously, the techniques described herein can be applied to devices or systems where it is desirable to employ disclosed and related systems, devices, and/or methods. It should be understood, therefore, that handheld, portable and other computing devices and computing objects of all kinds are contemplated for use in connection with the various disclosed embodiments. Accordingly, the below general purpose remote computer described below in FIG. 28 is but one example of a computing device. Additionally, disclosed and related systems, devices, and/or methods can include one or more aspects of the below general purpose computer, such as display, storage, analysis, control, etc.

Although not required, embodiments can partly be implemented via an operating system, for use by a developer of services for a device or object, and/or included within application software that operates to perform one or more functional aspects of the various embodiments described herein. Software can be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 28 thus illustrates an example of a suitable computing system environment 2800 in which one or aspects of the embodiments described herein can be implemented, although as made clear above, the computing system environment 2800 is only one example of a suitable computing environment and is not intended to suggest any limitation as to scope of use or functionality. Neither should the computing environment 2800 be interpreted as having any dependency or requirement relating to any one or combination of components illustrated in the exemplary operating environment 2800.

With reference to FIG. 28, an exemplary remote device for implementing one or more embodiments includes a general purpose computing device in the form of a computer 2810. Components of computer 2810 can include, but are not limited to, a processing unit 2820, a system memory 2830, and a system bus 2822 that couples various system components including the system memory to the processing unit 2820.

Computer 2810 typically includes a variety of computer readable media and can be any available media that can be accessed by computer 2810. The system memory 2830 can include computer storage media in the form of volatile and/or nonvolatile memory such as read only memory (ROM) and/or random access memory (RAM). By way of example, and not limitation, memory 2830 can also include an operating system, application programs, other program modules, and program data.

A user can enter commands and information into the computer 2810 through input devices 2840. A monitor or other type of display device is also connected to the system bus 2822 via an interface, such as output interface 2850. In addition to a monitor, computers can also include other peripheral output devices such as speakers and a printer, which can be connected through output interface 2850.

The computer 2810 can operate in a networked or distributed environment using logical connections to one or more other remote computers, such as remote computer 2870. The remote computer 2870 can be a personal computer, a server, a router, a network PC, a peer device or other common network node, or any other remote media consumption or transmission device, and can include any or all of the elements described above relative to the computer 2810. The logical connections depicted in FIG. 28 include a network 2872, such local area network (LAN) or a wide area network (WAN), but can also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts can be applied to any network system and any computing device or system in which it is desirable to employ disclosed and related systems, devices, and/or methods.

Also, there are multiple ways to implement the same or similar functionality, e.g., an appropriate API, tool kit, driver code, operating system, control, standalone or downloadable software object, etc. which enables applications and services to use disclosed and related systems, devices, methods, and/or functionality. Thus, embodiments herein are contemplated from the standpoint of an API (or other software object), as well as from a software or hardware object that implements one or more aspects of disclosed and related systems, devices, and/or methods as described herein. Thus, various embodiments described herein can have aspects that are wholly in hardware, partly in hardware and partly in software, as well as in software.

### Exemplary Mobile Device

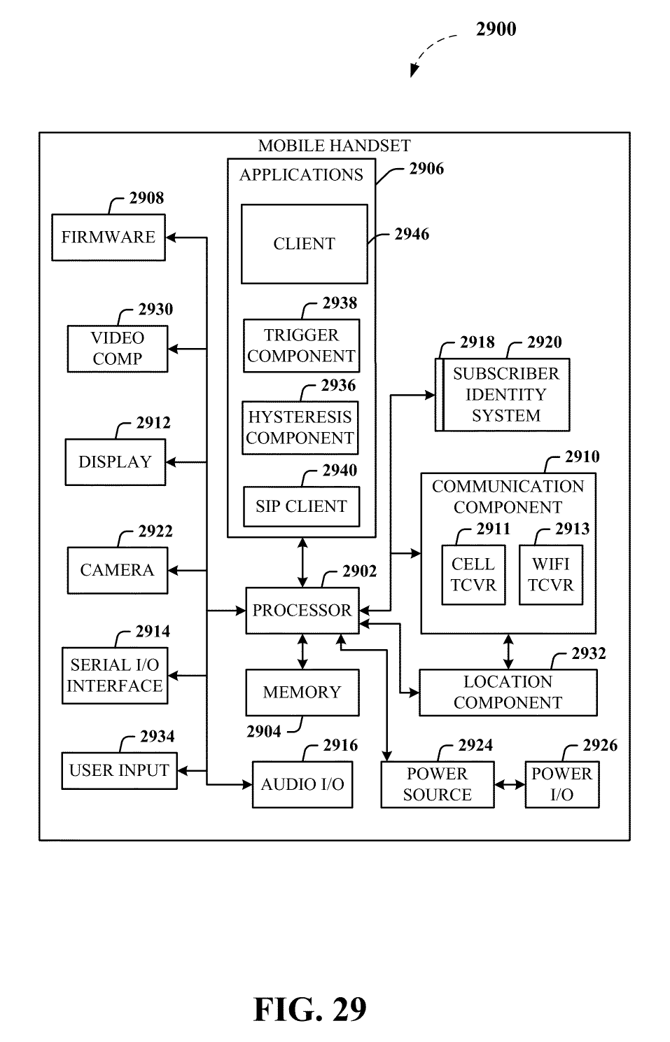

FIG. 29 depicts a schematic diagram of an exemplary mobile device 2900 (e.g., a mobile handset) that can facilitate various non-limiting aspects of the disclosed subject matter in accordance with the embodiments described herein. Although mobile handset 2900 is illustrated herein, it will be understood that other devices can be a mobile device, as described above regarding FIG. 3, for instance, and that the mobile handset 2900 is merely illustrated to provide context for the embodiments of the subject matter described herein. The following discussion is intended to provide a brief, general description of an example of a suitable environment 2900 in which the various embodiments can be implemented. While the description includes a general context of computer-executable instructions embodied on a tangible computer readable storage medium, those skilled in the art will recognize that the subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer readable media. Computer readable media can comprise any available media that can be accessed by the computer and includes both volatile and non-volatile media, removable and non-removable media. By way of example and not limitation, computer readable media can comprise tangible computer readable storage and/or communication media. Tangible computer readable storage can include volatile and/or non-volatile media, removable and/or non-removable media implemented in any method or technology for storage of information, such as computer readable instructions, data structures, program modules, or other data. Tangible computer readable storage can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media, as contrasted with tangible computer readable storage, typically embodies computer readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable communications media as distinguishable from computer-readable storage media.

The handset 2900 can include a processor 2902 for controlling and processing all onboard operations and functions. A memory 2904 interfaces to the processor 2902 for storage of data and one or more applications 2906 (e.g., communications applications such as browsers, apps, etc.). Other applications can support operation of communications and/or financial communications protocols. The applications 2906 can be stored in the memory 2904 and/or in a firmware 2908, and executed by the processor 2902 from either or both the memory 2904 or/and the firmware 2908. The firmware 2908 can also store startup code for execution in initializing the handset 2900. A communications component 2910 interfaces to the processor 2902 to facilitate wired/wireless communication with external systems, e.g., cellular networks, VoIP networks, and so on. Here, the communications component 2910 can also include a suitable cellular transceiver 2911 (e.g., a GSM transceiver) and/or an unlicensed transceiver 2913 (e.g., Wireless Fidelity (WiFi™), Worldwide Interoperability for Microwave Access (WiMax®)) for corresponding signal communications. The handset 2900 can be a device such as a cellular telephone, a PDA with mobile communications capabilities, and messaging-centric devices. The communications component 2910 also facilitates communications reception from terrestrial radio networks (e.g., broadcast), digital satellite radio networks, and Internet-based radio services networks.

The handset 2900 includes a display 2912 for displaying text, images, video, telephony functions (e.g., a Caller ID function), setup functions, and for user input. For example, the display 2912 can also be referred to as a “screen” that can accommodate the presentation of multimedia content (e.g., music metadata, messages, wallpaper, graphics, etc.). The display 2912 can also display videos and can facilitate the generation, editing and sharing of video quotes. A serial I/O interface 2914 is provided in communication with the processor 2902 to facilitate wired and/or wireless serial communications (e.g., Universal Serial Bus (USB), and/or Institute of Electrical and Electronics Engineers (IEEE) 2994) through a hardwire connection, and other serial input devices (e.g., a keyboard, keypad, and mouse). This supports updating and troubleshooting the handset 2900, for example. Audio capabilities are provided with an audio I/O component 2916, which can include a speaker for the output of audio signals related to, for example, indication that the user pressed the proper key or key combination to initiate the user feedback signal. The audio I/O component 2916 also facilitates the input of audio signals through a microphone to record data and/or telephony voice data, and for inputting voice signals for telephone conversations.

The handset 2900 can include a slot interface 2918 for accommodating a SIC (Subscriber Identity Component) in the form factor of a card Subscriber Identity Module (SIM) or universal SIM 2920, and interfacing the SIM card 2920 with the processor 2902. However, it is to be appreciated that the SIM card 2920 can be manufactured into the handset 2900, and updated by downloading data and software.

The handset 2900 can process Internet Protocol (IP) data traffic through the communication component 2910 to accommodate IP traffic from an IP network such as, for example, the Internet, a corporate intranet, a home network, a person area network, etc., through an ISP or broadband cable provider. Thus, VoIP traffic can be utilized by the handset 2900 and IP-based multimedia content can be received in either an encoded or a decoded format.

A video processing component 2922 (e.g., a camera and/or associated hardware, software, etc.) can be provided for decoding encoded multimedia content. The video processing component 2922 can aid in facilitating the generation and/or sharing of video. The handset 2900 also includes a power source 2924 in the form of batteries and/or an alternating current (AC) power subsystem, which power source 2924 can interface to an external power system or charging equipment (not shown) by a power input/output (I/O) component 2926.

The handset 2900 can also include a video component 2930 for processing video content received and, for recording and transmitting video content. For example, the video component 2930 can facilitate the generation, editing and sharing of video. A location-tracking component 2932 facilitates geographically locating the handset 2900. A user input component 2934 facilitates the user inputting data and/or making selections as previously described. The user input component 2934 can also facilitate selecting perspective recipients for fund transfer, entering amounts requested to be transferred, indicating account restrictions and/or limitations, as well as composing messages and other user input tasks as required by the context. The user input component 2934 can include such conventional input device technologies such as a keypad, keyboard, mouse, stylus pen, and/or touch screen, for example.

Referring again to the applications 2906, a hysteresis component 2936 facilitates the analysis and processing of hysteresis data, which is utilized to determine when to associate with an access point. A software trigger component 2938 can be provided that facilitates triggering of the hysteresis component 2938 when a WiFi™ transceiver 2913 detects the beacon of the access point. A SIP client 2940 enables the handset 2900 to support SIP protocols and register the subscriber with the SIP registrar server. The applications 2906 can also include a communications application or client 2946 that, among other possibilities, can be target for transfer money plugin or user interface component functionality as described above.

The handset 2900, as indicated above related to the communications component 2910, includes an indoor network radio transceiver 2913 (e.g., WiFi™ transceiver). This function supports the indoor radio link, such as IEEE 802.11, for the dual-mode Global System for Mobile Communications (GSM) handset 2900. The handset 2900 can accommodate at least satellite radio services through a handset that can combine wireless voice and digital radio chipsets into a single handheld device.

### Exemplary Communications Networks and Environments

The above-described communication systems using the scheduling techniques, systems, and methods may be applied to any network, however, the following description sets forth some exemplary telephony radio networks and non-limiting operating environments for communications made incident to the communication systems using the scheduling techniques, systems, and methods of the disclosed subject matter. The below-described operating environments should be considered non-exhaustive, however, and thus, the below-described network architecture merely shows one network architecture into which the disclosed subject matter may be incorporated. One can appreciate, however, that the disclosed subject matter may be incorporated into any now existing or future alternative architecture for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the scheduling techniques, systems, and methods of the disclosed subject matter may be applied independently of the method of data transport, and does not depend on any particular network architecture, or underlying protocols.

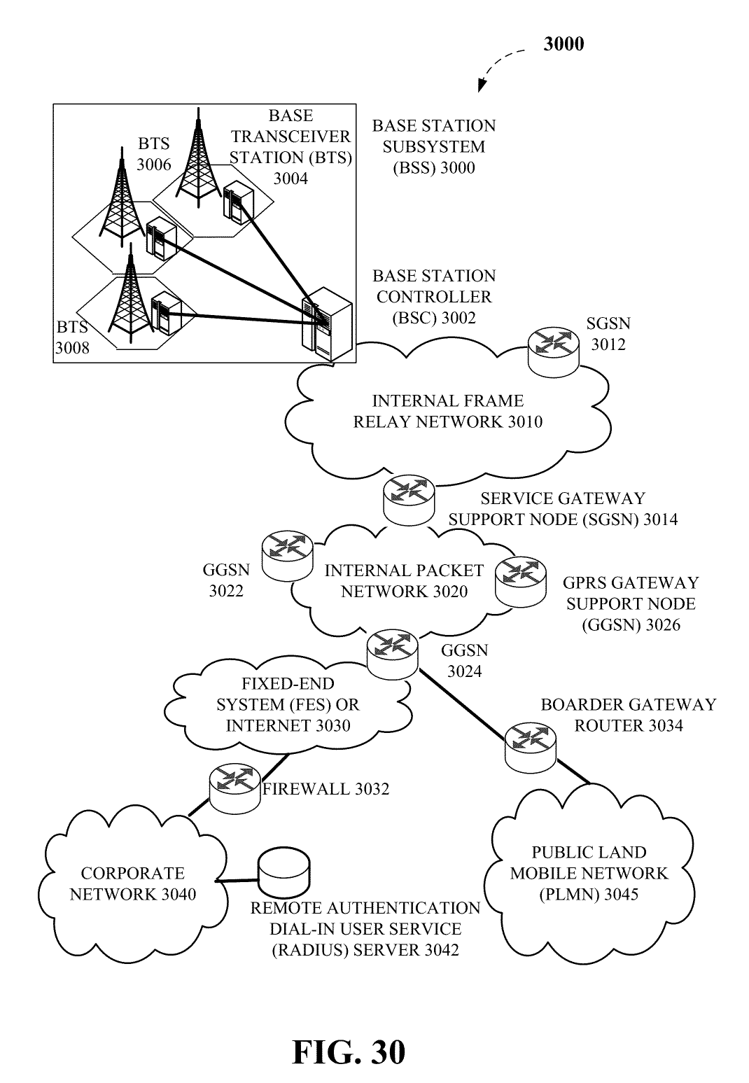

FIG. 30 depicts an overall block diagram of an exemplary packet-based mobile cellular network environment, such as a GPRS network, in which the disclosed subject matter may be practiced. In such an environment, there are one or more Base Station Subsystems (“BSS”) 3000 (only one is shown), each of which comprises a Base Station Controller (“BSC”) 3002 serving a plurality of Base Transceiver Stations (“BTS”) such as BTSs 3004, 3006, and 3008. BTSs 3004, 3006, 3008, etc. are the access points where users of packet-based mobile devices become connected to the wireless network. In exemplary fashion, the packet traffic originating from user devices is transported over the air interface to a BTS 3008, and from the BTS 3008 to the BSC 3002. Base station subsystems, such as BSS 3000, are a part of internal frame relay network 3010 that may include Service GPRS Support Nodes (“SGSN”) such as SGSN 3012 and 3014. Each SGSN is in turn connected to an internal packet network 3020 through which a SGSN 3012, 3014, etc. can route data packets to and from a plurality of gateway GPRS support nodes (GGSN) 3022, 3024, 3026, etc. As illustrated, SGSN 3014 and GGSNs 3022, 3024, and 3026 are part of internal packet network 3020. Gateway GPRS serving nodes 3022, 3024 and 3026 mainly provide an interface to external Internet Protocol (“IP”) networks such as Public Land Mobile Network (“PLMN”) 3045, corporate intranets 3040, or Fixed-End System (“FES”) or the public Internet 3030. As illustrated, subscriber corporate network 3040 may be connected to GGSN 3024 via firewall 3032; and PLMN 3045 is connected to GGSN 3024 via boarder gateway router 3034. The Remote Authentication Dial-In User Service (“RADIUS”) server 3042 may be used for caller authentication when a user of a mobile cellular device calls corporate network 3040.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into systems. That is, at least a portion of the devices and/or processes described herein can be integrated into a system via a reasonable amount of experimentation. Those having skill in the art will recognize that a typical system can include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control device (e.g., feedback for sensing position and/or velocity; control devices for moving and/or adjusting parameters). A typical system can be implemented utilizing any suitable commercially available components, such as those typically found in data computing/communication and/or network computing/communication systems.

Various embodiments of the disclosed subject matter sometimes illustrate different components contained within, or connected with, other components. It is to be understood that such depicted architectures are merely exemplary, and that, in fact, many other architectures can be implemented which achieve the same and/or equivalent functionality. In a conceptual sense, any arrangement of components to achieve the same and/or equivalent functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” “operably coupled,” “communicatively connected,” and/or “communicatively coupled,” to each other to achieve the desired functionality, and any two components capable of being so associated can also be viewed as being “operably couplable” or “communicatively couplable” to each other to achieve the desired functionality. Specific examples of operably couplable or communicatively couplable can include, but are not limited to, physically mateable and/or physically interacting components, wirelessly interactable and/or wirelessly interacting components, and/or logically interacting and/or logically interactable components.

With respect to substantially any plural and/or singular terms used herein, those having skill in the art can translate from the plural to the singular and/or from the singular to the plural as can be appropriate to the context and/or application. The various singular/plural permutations may be expressly set forth herein for the sake of clarity, without limitation.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those skilled in the art that, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limit any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those skilled in the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

In addition, the words “exemplary” and “non-limiting” are used herein to mean serving as an example, instance, or illustration. For the avoidance of doubt, the subject matter disclosed herein is not limited by such examples. Moreover, any aspect or design described herein as “an example,” “an illustration,” “exemplary” and/or “non-limiting” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements, as described above.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. In addition, one or more components can reside within a process and/or thread of execution and a component can be localized on one computer and/or distributed between two or more computers.

Systems described herein can be described with respect to interaction between several components. It can be understood that such systems and components can include those components or specified sub-components, some of the specified components or sub-components, or portions thereof, and/or additional components, and various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle component layers, such as a management layer, can be provided to communicatively couple to such sub-components in order to provide integrated functionality, as mentioned. Any components described herein can also interact with one or more other components not specifically described herein but generally known by those of skill in the art.

As mentioned, in view of the exemplary systems described herein, methods that can be implemented in accordance with the described subject matter can be better appreciated with reference to the flowcharts of the various figures and vice versa. While for purposes of simplicity of explanation, the methods can be shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks can be required to implement the methods described hereinafter.

While the disclosed subject matter has been described in connection with the disclosed embodiments and the various figures, it is to be understood that other similar embodiments may be used or modifications and additions may be made to the described embodiments for performing the same function of the disclosed subject matter without deviating therefrom. Still further, multiple processing chips or multiple devices can share the performance of one or more functions described herein, and similarly, storage can be effected across a plurality of devices. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methods, as shown and described herein. In any event, the systems, structures and/or devices, as well as the associated methods described herein have many applications in various aspects of the disclosed subject matter, and so on. Accordingly, the invention should not be limited to any single embodiment, but rather should be construed in breadth, spirit and scope in accordance with the appended claims.

What is claimed is:

1. A polling system, comprising:
a memory to store computer-executable components; and
a processor communicatively coupled to the memory that facilitates execution of the computer-executable components, the computer-executable components, comprising:
a poll creation component configured to create a targeted poll based at least in part on an attribute associated with poll targeting;
a rewards component configured to award, to a potential respondent, a reward for responding to the targeted poll based at least in part on sponsorship of the targeted poll by a poll sponsor; and
a poll execution component configured to present the targeted poll to the potential respondent based at least in part on the attribute associated with poll targeting.

2. The polling system of claim 1, wherein the poll execution component is further configured to allow the potential respondent to respond to the targeted poll based in part on a determination of whether the attribute associated with poll targeting is fulfilled for the potential respondent.

3. The polling system of claim 1, wherein the poll execution component is further configured to present the reward with the targeted poll to the potential respondent.

4. The polling system of claim 1, wherein the computer-executable components further comprise:
a monetization component configured to provide data associated with the targeted poll to the poll sponsor based at least in part on the sponsorship.

5. The polling system of claim 1, wherein the computer-executable components further comprise:
an analysis component configured to identify the attribute associated with poll targeting to facilitate creation of the targeted poll.

6. The polling system of claim 1, wherein the attribute associated with poll targeting comprises information concerning the potential respondent.

7. The polling system of claim 6, wherein the poll execution component is further configured to determine the information concerning the potential respondent based in part on a predetermined interval between an attribute associated with poll targeting concerning time or space and a characteristic associated with the potential respondent concerning time or space, respectively.

8. The polling system of claim 6, wherein the information concerning the potential respondent is related to at least one of age, income level, education level, sex, political partisan identification (ID), registered voter status, likely voter status, a prior poll response date, a search query, location, technical competence, technical ability, referrer of the targeted poll, a number of followers, a number of shared polls, a number of completed polls, verification status of a subset of profile information, and/or device information associated for a device with the potential respondent.

9. The polling system of claim 8, wherein the device information comprises at least one of device type, device manufacturer, operating system, application, browser, length of device use, length of service use, length of application use, or version information.

10. The polling system of claim 6, wherein the information concerning the potential respondent is related to at least one of a profile setting or a privacy setting associated with at least one of the polling system or another computing system.

11. The polling system of claim 10, wherein the computer-executable components further comprise:
a connector component configured to allow communications between the polling system and the other computing system.

12. The polling system of claim 11, wherein the other computing system comprises at least one of an advertising computer system, a market research computing system, an electronic commerce computing system, a computing system associates with a management information system, a search provider computer system, or a social networking computer system.

13. The polling system of claim 12, wherein the computer-executable components further comprise:
a social component configured to allow the potential respondent to share the targeted poll with at least one other potential respondent associated with at least one of the polling system or the social networking computer system.

14. A polling method, comprising:
receiving, by a system including a processor, a request from a poll sponsor to create a targeted poll based at least in part on an attribute of a potential respondent;
determining, by the system, whether the attribute of the potential respondent is satisfied by querying with a computer a data store of potential respondents;
providing, by the system, an incentive for responding to the targeted poll, based at least in part on the determining; and
presenting, by the system, the targeted poll to the potential respondent.

15. The polling method of claim 14, wherein the providing includes providing the incentive based at least in part on sponsorship of the targeted poll by the poll sponsor.

16. The polling method of claim 14, wherein the presenting includes presenting the incentive with the targeted poll to the potential respondent.

17. The polling method of claim 14, further comprising:
transmitting, by the system, data associated with the targeted poll to the poll sponsor based at least in part on the sponsorship.

18. The polling method of claim 14, wherein the determining whether the attribute of the potential respondent is satisfied includes determining based in part on a predetermined interval between a poll targeting attribute concerning time or space and the attribute of the potential respondent concerning time or space, respectively.

19. The polling method of claim 14, wherein the determining whether the attribute of the potential respondent is satisfied includes determining whether at least one of age, income level, education level, sex, political partisan identification (ID), registered voter status, likely voter status, a prior poll response date, a search query, location, technical competence, technical ability, referrer of the targeted poll, a number of followers, a number of shared polls, a number of completed polls, verification status of a subset of profile information, and/or device information for a device associated with the potential respondent satisfies the attribute of the potential respondent.

20. The polling method of claim 14, further comprising:
publishing the targeted poll to at least one other potential respondent of the potential respondents based at least in part on at least one of a profile setting or a privacy setting associated with a social networking computing system.

21. A tangible computer readable storage medium comprising computer-executable instructions that, in response to execution, cause a computing device including a processor to perform operations, comprising:
receiving a targeted poll based at least in part on a determination whether an attribute associated with a user of the computing device is fulfilled, wherein the attribute is specified for the targeted poll by a poll sponsor;
responding to the targeted poll; and
receiving an incentive based at least in part on at least one of responding to the targeted poll, sponsorship of the targeted poll by the poll sponsor, or sharing the targeted poll.

22. The tangible computer readable storage medium of claim 21, the operations further comprising:
transmitting at least one of age, income level, education level, sex, political partisan identification (ID), registered voter status, likely voter status, a prior poll response date, a search query, location, technical competence, technical ability, referrer of the targeted poll, a number of followers, a number of shared polls, a number of completed polls, verification status of a subset of profile information, or computing device information associated with the user to facilitate determining whether the attribute is fulfilled.

23. The tangible computer readable storage medium of claim 22, wherein the determining whether the attribute is fulfilled includes determining based in part on a predetermined interval between the attribute associated with the user concerning time or space and the information associated with the user concerning time or space, respectively.

24. The tangible computer readable storage medium of claim 22, the operations further comprising:
authorizing at least one of the transmitting or sharing of information associated with at least one of the user or the targeted poll based at least in part on at least one of a profile setting or a privacy setting associated with a social networking computing system.

25. A device, comprising:
means for transmitting information to facilitate determining whether an attribute associated with a user of the device satisfies an attribute specified in a targeted poll by a poll sponsor;
means for displaying the targeted poll;
means for responding to the targeted poll; and
means for receiving a reward based at least in part on at least one of responding to the targeted poll or sharing the targeted poll, wherein the reward is sponsored at least in part by the poll sponsor.

26. The device of claim 25, further comprising:
means for authorizing at least one of the transmitting or sharing of the information associated with at least one of the user or the targeted poll based at least in part on at least one of a profile setting or a privacy setting.
